(19) United States
(12) Patent Application Publication
(10) Pub. No.: US 2021/0403155 A1
(43) Pub. Date: Dec. 30, 2021

(54) VTOL AIRCRAFT

(71) Applicant: Paul Neiser, Mountain View, CA (US)

(72) Inventor: Paul Neiser, Mountain View, CA (US)

(21) Appl. No.: 17/164,827

(22) Filed: Feb. 1, 2021

Related U.S. Application Data
(63) Continuation-in-part of application No. 16/101,391, filed on Aug. 10, 2018.
(60) Provisional application No. 62/971,958, filed on Feb. 8, 2020.
(60) Provisional application No. 62/543,371, filed on Aug. 10, 2017.
(60) Provisional application No. 62/685,295, filed on Jun. 15, 2018.
(60) Provisional application No. 62/703,898, filed on Jul. 27, 2018.
(60) Provisional application No. 62/714,778, filed on Aug. 6, 2018.

(51) Int. Cl. B64C 29/00; B64D 27/02; B64D 27/24; B60L 50/60; B64C 3/38

(52) U.S. Cl. CPC B64C 29/0033; B64D 27/02; B60L 2200/10; B60L 50/60; B64C 3/38; B64D 27/24

(57) ABSTRACT

Disclosed is a VTOL aircraft, and a method of operating the same. The VTOL aircraft employs a propulsion system comprising at least one propulsion unit, which can be rotated to generate lift during VTOL operations and thrust during cruise. A folding wing is employed to provide lift during cruise, and to meet external size constraints during storage and VTOL operations.

### CLAIM OF PRIORITY

This application claims the benefit of U.S. Provisional Applications No. 62/968,914, filed Jan. 31, 2020, and No. 62/971,958, filed Feb. 8, 2020, and is a continuation in part of U.S. application Ser. No. 16/101,391, filed, Aug. 10, 2018, which claims the benefit of U.S. Provisional Applications No. 62/543,371, filed Aug. 10, 2017, No. 62/685,295, filed Jun. 15, 2018, No. 62/703,898, filed Jul. 27, 2018, and No. 62/714,778, filed Aug. 6, 2018. Each of the applications listed above is incorporated by reference herein.

### FIELD

The invention relates to aircraft, and vertical takeoff and landing (VTOL) aircraft in particular.

### BACKGROUND

A conventional fixed wing aircraft is unable to hover, as well as take-off or land vertically. The minimum speed of such an aircraft in horizontal flight is the stall speed. A large stall speed typically requires a long runway for take-off and landing, which significantly limits the number of reachable destinations of an aircraft. A greater than zero stall speed is also a safety concern, since it adds an additional failure mode to the operation of an aircraft.

A conventional fixed wing aircraft also typically has an empennage (e.g. a separate tail assembly comprising a vertical stabilizer and rudder, and a horizontal stabilizer and elevator) at the rear of the fuselage, where in some cases the empennage is also supported by an extension of the fuselage. These features add weight and increase the wetted area. For stability reasons a horizontal stabilizer produces a downwards force, which must be counteracted by the main wing, which increases drag further.

The helicopter is currently a popular aircraft capable of vertical take-off and landing (VTOL). Advancing blade compressibility effects and retreating blade stall limit the maximum cruising speed of a conventional helicopter. During cruise, the magnitude of the free stream flow velocity of a rotor blade varies periodically. This increases the average profile drag relative to a comparable fixed wing. Since limited cruising speed also limits the minimum induced drag, the range of a helicopter relative to a comparable fixed wing aircraft of the same weight is reduced. The large tip velocities of the large, unshrouded rotor blades also cause noise pollution. The tail rotor of conventional helicopter is an exposed single point of failure which consumes power without contributing to thrust or lift. The large amount of kinetic energy contained in the blades is also a safety concern. To avoid resonance effects, the main rotors of conventional helicopters typically operate at constant rotational speed throughout the flight envelope. This can reduce the size of the flight envelope and impose additional performance penalties on a portion of the flight envelope.

To address the problems with helicopters and conventional fixed wing aircraft, hybrid aircraft have been proposed. These typically feature a fixed wing, a propulsion unit for cruising, and a separate propulsion unit for lifting, which enables VTOL operations. The propulsion unit for lifting is stowed or throttled back during cruise, when less thrust is required. Such hybrid aircraft are heavier and have a higher profile drag compared to purely cruise-optimized fixed wing aircraft. The weight and storage of the propulsion unit for lifting furthermore reduces the payload weight and volume, which includes fuel or passengers. Due to such weight, drag, and storage constraints, the actuator disc area and associated hover performance of the propulsion unit for lifting of some hybrid aircraft is often limited, resulting in a reduced hover endurance and thrust margin.

Other VTOL aircraft employ the same propulsion unit for cruising and for lifting. The propulsion unit is rotated, or the exhaust of the propulsion unit is deflected, during the transition from hover to cruise. The propulsion units of such aircraft are in some cases preferentially optimized for cruise, resulting in poor hover performance. In other cases, the propulsion units are preferentially optimized for hover, resulting in a reduced cruise performance, which includes speed and range.

In order to reduce the noise, and increase the performance and safety of a propulsion unit, ducted or shrouded rotors have been used. Due to weight and drag penalties of the shroud, the benefits of ducted rotors are limited to propulsion units with a small cross-sectional area, which can reduce the hover performance of VTOL aircraft.

In order to meet external size constraints on an aircraft on the ground, during transport, and during flight operations, some aircraft are able to morph or modify their shape. The morphing can involve the folding of the wings or rotor blades, for example. Aircraft without the ability to modify their shape benefit from a reduced mechanical complexity and cost, but must meet external size constraints at all times, which can adversely affect cruise performance, hover performance, and payload size.

It would be desirable to for a VTOL aircraft to achieve an acceptable cruise performance without an excessive reduction in hover performance, while meeting constraints on safety, cost, complexity, and size.

### SUMMARY

Disclosed is a VTOL aircraft capable of efficient VTOL operations, and a method of operating the same. The VTOL aircraft comprises an advanced propulsion system, which provides an extended hover endurance, thrust margin, and maneuverability without undue sacrifices in cruise performance. In some embodiments, the VTOL aircraft can match or exceed the hover performance of a comparable VTOL aircraft. In embodiments of the invention, constraints on the propulsion system and the aircraft can be met without the need for excessive or complex morphing of the propulsion system and the associated mechanical complexity.

Some embodiments of the invention employ the same propulsion system for cruising and for lifting (i.e. for VTOL operations), which avoids some of the weight, drag, and payload penalties of hybrid aircraft with separate propulsion units for lifting and cruising. In the disclosed invention, the propulsion system comprises at least one propulsion unit. In some embodiments, at least one propulsion unit can be rotated about a pitch axis relative to the aircraft fuselage to generate lift during VTOL operations and thrust during cruise. In some embodiments, at least one propulsion unit can be rotated about a roll axis for increased maneuverability during VTOL operations and increased performance and maneuverability during cruise.

In embodiments of the invention in which the propulsion units comprise a rotor configured to produce a net thrust in a gas such as air, a duct or a shroud around the rotor can be employed to reduce the noise of the aircraft during nominal operations. The duct can furthermore be specially configured to allow the aircraft to operate at large subsonic speeds, transonic speeds, and supersonic speeds.

The propulsion system can be employed to perform at least a portion of the stability and control functions in some embodiments. For example, the propulsion systems can be used for pitch control, roll control, and yaw control. In some embodiments, the control authority of the propulsion system is sufficiently high in a powered and unpowered mode, obviating the need for a separate vertical stabilizer and rudder, or a separate horizontal stabilizer and elevator. In some embodiments of the invention, the stability and control function of the empennage is delegated to the other, essential features of an aircraft, such as the main wing or the main propulsion system. The weight and drag force of the VTOL aircraft can be reduced, and the maneuverability can be increased, compared to a comparable conventional fixed wing aircraft.

A folding wing is employed to meet external size constraints on the ground, during transport, and during VTOL operations. The wing provides increased performance during cruise, and increased safety at low speed flight. For example, in the event of an engine failure, the wing can provide lift and allow the aircraft to glide. The wing also allows the aircraft to perform conventional takeoffs and landings.

In some embodiments the wing shape can be optimized for a high speed, nominal, level cruise, which can significantly improve the cruise performance compared to a conventional fixed wing aircraft. For example, the wing can be configured to operate at a high lift coefficient during cruise, which can reduce the wetted area and the associated drag of the aircraft, albeit at the cost of an increased stall speed. At lower cruise speeds, such as speeds below the theoretical stall speed of a fully loaded wing, the lift force of the wing can be reduced to a force which is less than the weight of the aircraft. To maintain level flight, the net thrust force of the propulsion unit can provide the remaining lift force required to cancel the weight of the aircraft, while also providing the required forward thrust force on the aircraft. In some embodiments, the cruise performance of the VTOL aircraft can exceed the cruise performance of a comparable conventional fixed wing aircraft.

### BRIEF DESCRIPTION OF THE DRAWINGS

FIG. 1 is a side view of a VTOL aircraft in a hover configuration or in a storage configuration sitting on the ground.

FIG. 2 is a front view of a VTOL aircraft in a hover configuration or in a storage configuration sitting on the ground.

FIG. 3 is a top view of a VTOL aircraft in a hover configuration or in a storage configuration sitting on the ground.

FIG. 4 is a side view of a VTOL aircraft in a cruise configuration in flight.

FIG. 5 is a front view of a VTOL aircraft in a cruise configuration in flight.

FIG. 6 is a top view of a VTOL aircraft in a cruise configuration in flight.

### DETAILED DESCRIPTION OF THE INVENTION

The term “fluid” used herein encompasses all types of materials that exhibit the properties of a fluid. One such property is the ability of constituent particles to move relative to each other. It can refer to a liquid such as water, or a gas such as air, for example. Note that a fluid can comprise several different types and species of fluid simultaneously, such as air, which consists of several types of gas. Unless specified, the assembly of different fluids will still be referred to as “the fluid” for simplicity.

The term “free stream flow” is defined as the theoretical flow relative to a specified point that would occur if a body, such as an assembly of apparatuses, did not interact with the fluid. It can thus also be referred to as a global free stream flow. An assembly of apparatuses can be a vehicle, such as an aircraft or a ship, or a different type of fluid manipulation apparatus, such as a wind turbine, for example, or any portion of such an assembly. The free stream flow can comprise contributions from the motion of a specified point in inertial space, such as the motion of a vehicle in inertial space. It can also comprise contributions from the motion of the fluid in inertial space, such as wind or currents. Different specified points can experience different free stream flows. For example, an apparatus could rotate, such that different points on the apparatus move at different velocities in inertial space and experience different free stream flow velocities in a fluid that is theoretically stationary in inertial space.

The term “local free stream flow” is defined as the theoretical flow relative to a specified apparatus that would occur if only the specified apparatus did not interact with the fluid. The local free stream flow comprises a contribution of the free stream flow as well as a contribution due to other apparatuses, such as those of the remainder of an assembly, interacting with the fluid. For example, the downwash created by a horizontal fixed wing could affect the local free stream flow velocity magnitude and direction relative to a horizontal stabilizer mounted downstream of the wing.

A “fluid manipulation apparatus”, or FMA, is defined as an apparatus that manipulates the properties of a fluid. For example, an FMA could change the magnitude of the flow velocity of a fluid element relative to the magnitude of a free stream flow velocity for a specified scenario or boundary condition. In another example, an FMA could change the direction of the fluid flow velocity of a fluid element relative to a free stream flow velocity direction for a specified scenario. This effect on the fluid flow can be intentional or unintentional. When at least some of the effect on the fluid is intentional, the FMA can be further classified as an “intentional fluid manipulation apparatus”, or IFMA. The intentional effect on the fluid flow can only be localized for some IFMAs, as in the case of an “intentional momentum carrying apparatus”, or IMCA, defined below. For other IFMAs, the intentional effect on the fluid flow can also occur in the far wake, as can be the case for an “intentional momentum shedding apparatus”, or IMSA. These definitions will be clarified in the following paragraphs.

Due to the intentional nature of the momentum shedding, and IMSA can also be referred to as a “thrust apparatus”, or TA, which is defined as any apparatus configured to impart an intentional rate of change of momentum to a fluid during nominal operation. An example of a TA is a conventional propeller or a helicopter main rotor. The wing of a fixed wing aircraft that provides lift during nominal constant speed cruise can also be regarded a thrust apparatus. There are many other possible types of TAs available. For example, the rate of change of momentum could be applied to the fluid by a TA via electromagnetic forces. For example, the TA can be a Hall-effect thruster, or a magnetohydrodynamic (MHD) drive. A Voith Schneider thruster, a cyclogyro, or a similar device are also examples of a TA.

In the aforementioned definition of a thrust apparatus, the requirement of imparting an intentional rate of change of momentum to a fluid can be described in several ways. For example, consider a thrust apparatus in isolation from other fluid manipulation apparatuses in an assembly of apparatuses. For instance, consider a wing in isolation from the remainder of a fixed wing aircraft. Or consider a helicopter main rotor in isolation from the remainder of a conventional helicopter. In a theoretical scenario, denoted the “isolated scenario”, a thrust apparatus is considered in isolation and defined or characterized by the fact that there is an intentional, non-zero induced flow in the far wake relative to the thrust apparatus during a nominal operating condition.

The nominal operating condition can, in some instances, involve a free stream flow velocity magnitude and direction which is uniform in space and time. In some examples, the operating conditions during constant velocity cruise can be described as a nominal operating condition. The far wake is located an infinite distance from the thrust apparatus in this nominal operating condition. In other words, the thrust apparatus has an intentional, non-negligible effect on the flow field an infinite distance from the thrust apparatus compared to the free stream flow field.

The term “intentional” as defined and used herein, refers to the requirement that the rate of change of momentum be useful or deliberate. For example, a useful rate of change of momentum can contribute to an average induced velocity of a fluid element in the far wake in the aforementioned isolated scenario, where the velocity has a non-zero component in a direction opposite to the direction of the intended thrust or lift. For some thrust apparatuses, the average induced velocity of a fluid element in the far wake has a substantial component in a direction opposite to the direction of the intended thrust or lift. The far wake induced flow of a fixed wing or a helicopter main rotor which is associated with the production of lift or thrust is considered intentional. The associated rate of change of momentum of the fluid in the proximity of the thrust apparatus is also considered intentional. An intentional effect of a thrust apparatus on the far wake is distinguished from unintentional, not useful, or counter-productive effects on the fluid flow field in the far wake, which can be associated with profile drag, pressure drag acting on some elements of the thrust apparatus, for instance. These unintentional effects increase the power consumption unnecessarily, i.e. compared to a theoretical situation in which these effects are mathematically removed, ceteris paribus.

The requirement of imparting an intentional rate of change of momentum to a fluid can also be described in another way. For example, a thrust apparatus can also be defined as any apparatus which can be considered to intentionally shed vortices in the simplified framework of Prandtl lifting-line theory. A thrust apparatus, or TA, or IMSA, can therefore also be described as an “intentional vortex shedding apparatus”, or IVSA. Note that the framework of lifting-line theory should only be considered as a reference or a guide, since it relies on simplified assumptions, such as inviscid and incompressible flow. The vortices which are intentionally or deliberately shed by a thrust apparatus contribute to the lift or thrust force acting on the thrust apparatus by imparting a rate of change of momentum to a fluid. When a thrust apparatus is considered in the aforementioned isolated scenario during nominal operating conditions, the intentionally shed vortices are also present an infinite distance from the thrust apparatus, where they generate an intentional induced flow. In other words, there is a non-zero, intentional, far wake induced flow velocity on account of, or produced by, the thrust apparatus. Note that a thrust apparatus can also be considered to shed vortices unintentionally in some models, such as mathematical models taking into account viscous drag or boundary layer effects in the form of theoretical shed vortices. Unintentional vortex shedding refers to any vortices which are not shed deliberately, i.e. any vortices which do not perform, or contribute to, a useful function such as the generation of lift or thrust.

An intentional momentum carrying apparatus, or IMCA, is a fluid manipulation apparatus which, when considered in an isolated scenario, does not intentionally shed momentum into the far wake. An example of an IMCA is a duct or a conventional tubular, or cigar shaped, axially symmetric fuselage. A fuselage modifies the free stream flow by intentionally deflecting the flow around the fuselage, which also increases the magnitude of the velocity of the flow in the proximity of the fuselage for the isolated scenario in which the fuselage is considered in isolation of any other fluid manipulation apparatuses, such as wings, for a nominal operating condition, such as constant velocity cruise. The aforementioned intentional deflection of the flow is localized to the vicinity of the fuselage. Thus, a fluid element in the proximity of a fuselage experiences an intentional, localized rate of change of momentum. In the ideal case, there is no effect on the fluid flow at an infinite distance from the fuselage. In other words, there is no intentional far wake effect on the fluid flow due to the fuselage. There can be an unintentional rate of change of momentum of the fluid in the proximity of the fuselage, which can also be associated with an unintentional change of momentum of a fluid element an infinite distance from the fuselage in the isolated scenario compared to the free stream flow. Such an unintentional change in the fluid flow in the far wake can arise from profile drag effects, for example.

Similarly, a duct modifies the free stream flow by intentionally modifying the magnitude of the flow velocity in the proximity of the duct. For example, a duct can be configured to reduce the magnitude of the flow velocity of a fluid element at the center of the circular duct relative to the free stream flow for an isolated scenario during nominal operating conditions. In this case the nominal operating conditions can refer to a constant and uniform free stream flow velocity parallel to the central axis of symmetry of the duct. This intentional modification is only localized in the proximity of the duct, and converges to a negligible value an infinite distance from the center of the duct. Thus, there is no intentional far wake effect on the fluid flow due to the duct, i.e. there is no far wake intentional induced flow velocity of a fluid element due to the interaction of the duct with the fluid. As before, there can be an unintentional modification of the fluid flow in the far wake, and associated unintentional rate of change of momentum of the fluid in the proximity of the duct, due to drag forces or transient effects.

An IMCA can also be described in the simplified framework of lifting-line theory. An IMCA can be considered to carry an enclosed or bound vorticity. As such, an IMCA can also be considered to be an “intentional vortex carrying apparatus”, or IVCA. For example, the intentional effect of a circular, axially symmetric duct on the fluid can be modelled as a circular vortex ring, or a two- or three-dimensional continuous distribution of vorticity, or incrementally small, discrete vortex rings. Note that no intentional vorticity is shed into the fluid during a nominal operating condition, in which the magnitude of the vorticity is constant in time and uniform along the circumference of the vortex ring. Similarly, the intentional effect of a fuselage on the fluid flow can also be modelled as a three-dimensional continuous distribution of vorticity contained within the fuselage or located on the surface of the fuselage, i.e. the interface between the fuselage and the fluid.

The “induced power” of an IMSA is the rate of change of energy of the fluid that is associated with the intentional rate of change of momentum of the fluid. Any other power consumption is accounted for in “zero-lift power”, or “profile power”. Note that the term “lift” also encompasses thrust in this context. Note that an IMCA does not consume any induced power. Any power losses associated with a pure IMCA are considered profile power losses. An IMSA is able to consume induced power, in which case intentional work is done by the fluid manipulation apparatus on the fluid. For example, a propeller of an aircraft or a ship, or the fixed wing of a conventional fixed wing aircraft, results in, or is associated with, an induced power consumption. An IMSA is also able to recover induced power, in which case work is done by the fluid on the fluid manipulation apparatus intentionally. For example, the power generated by a wind turbine can be considered to be induced power.

In the process of applying a rate of change of momentum to a fluid, a fluid manipulation apparatus can change the flow velocity relative to the local free stream velocity. This change in velocity is the “downwash”, or “induced velocity”. Note that the induced velocity can be directed downstream or upstream, or perpendicularly to the stream, for example. An induced velocity can be generated by an IMSA or an IMCA. In the latter case, the induced velocity is localized, i.e. confined to the vicinity of the IMCA. In these terms, an IMSA can also be characterized as an apparatus, which contributes an intentional induced velocity to the far wake in an isolated scenario. Note that an induced velocity contribution by one IMSA can be cancelled by another IMSA when both are IMSAs are considered together.

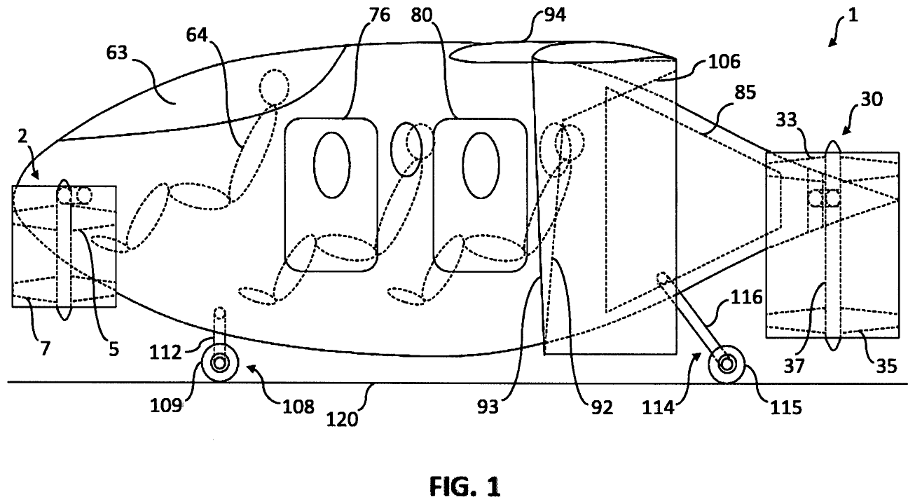

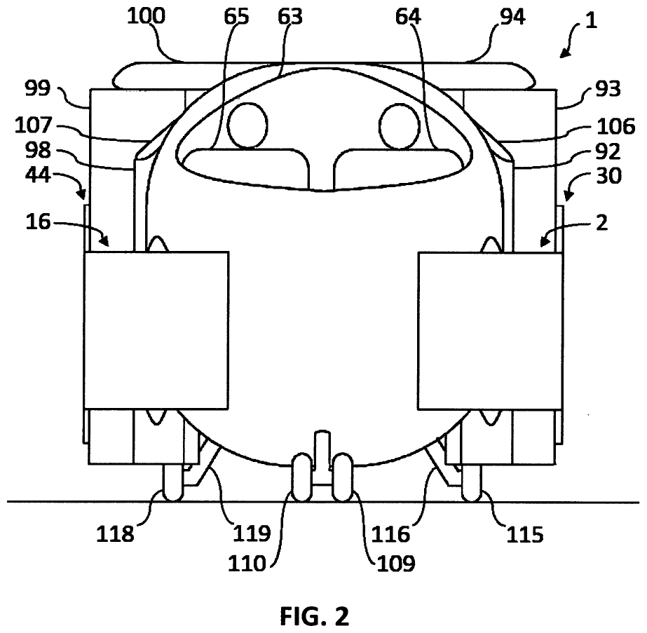

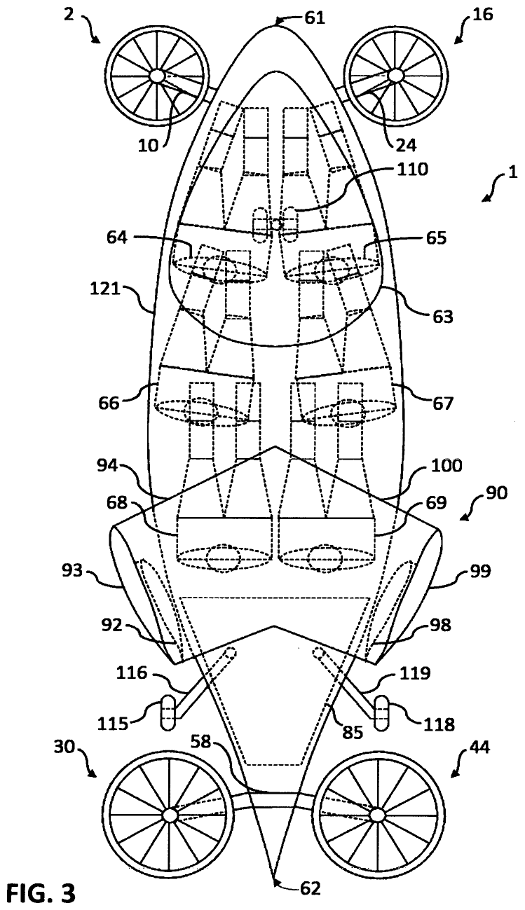

FIG. 1 is a side view of a VTOL aircraft 1 in a hover configuration or in a storage configuration sitting on the ground 120. FIG. 2 is a front view of a VTOL aircraft in the same configuration. FIG. 3 is a top view of a VTOL aircraft in the same configuration.

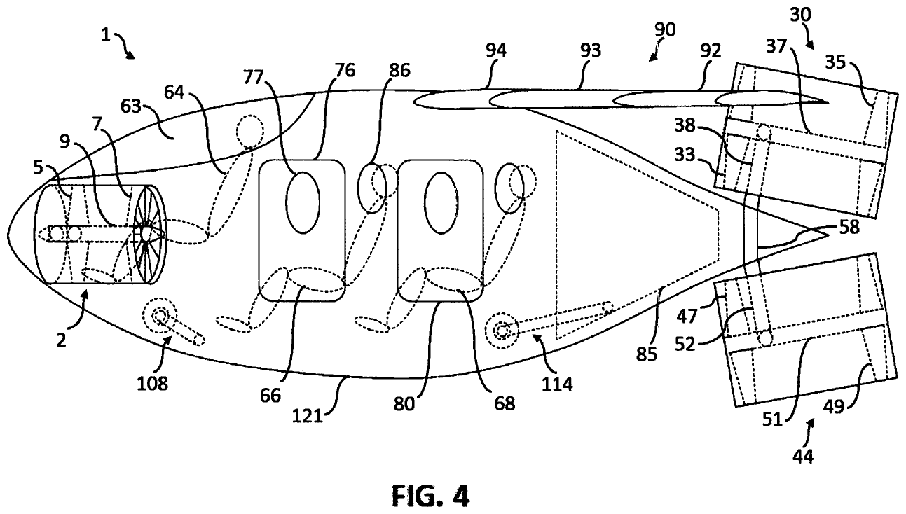

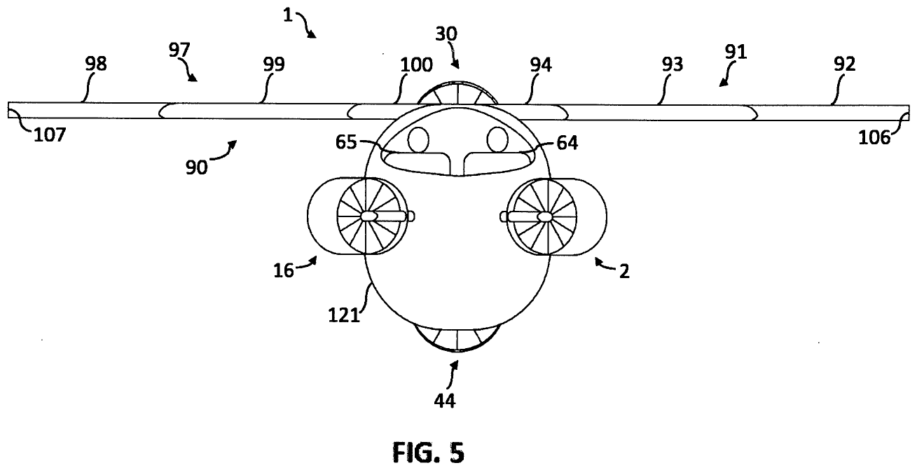

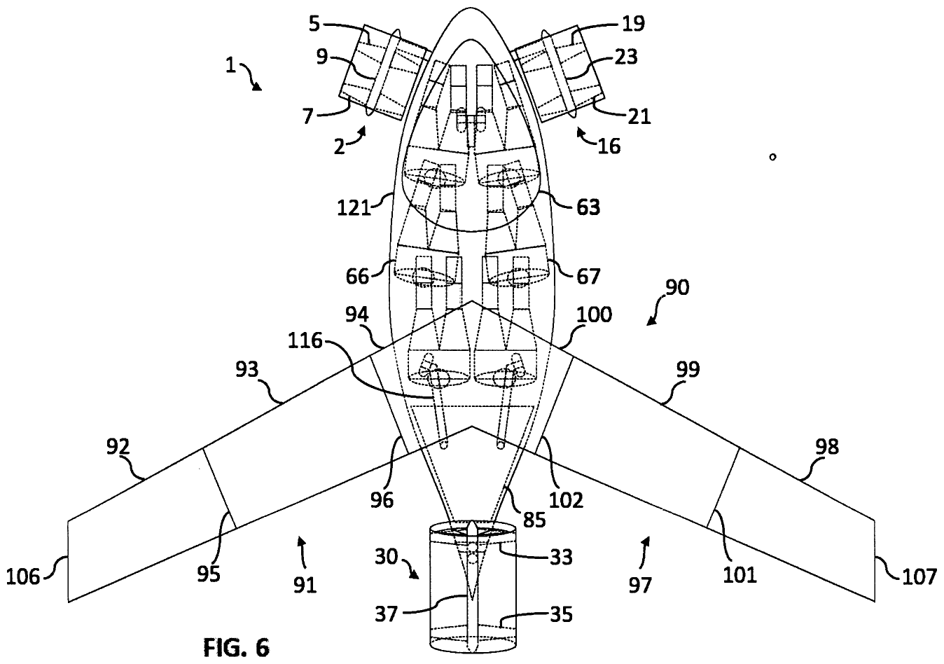

FIG. 4 is a side view of a VTOL aircraft in a cruise configuration in flight. FIG. 5 is a front view of a VTOL aircraft in a cruise configuration in flight. FIG. 6 is a top view of a VTOL aircraft in a cruise configuration in flight.

The vehicle comprises four propulsion units, or PUs, which can also be described as thrust apparatuses, or TAs, or fluid interaction apparatuses, or FIAs. A first PU 2 and a second PU 16 are mounted at the front of the aircraft, while a third PU 30 and a fourth PU 44 are mounted on the rear of the aircraft.

In this particular embodiment each PU consists of a single duct enclosing a thrust apparatus such as a rotor disc. In other embodiments, each PU can comprise two or more ducts, with each duct enclosing a thrust apparatus such as a rotor disc. In this embodiment, each duct comprises an upstream thrust apparatus and a downstream thrust apparatus. In this embodiment, each upstream thrust apparatus consists of a single upstream rotor disc, such as rotor disc 5 or rotor disc 33, and each downstream thrust apparatus consists of a single downstream rotor disc, such as rotor disc 7 or rotor disc 35. In other embodiments, an upstream thrust apparatus or downstream thrust apparatus can comprise several rotor discs. In some such embodiments, and upstream thrust apparatus or downstream thrust apparatus can comprise a plurality of stages, where each stage comprises a rotor disc and a stator disc, as is common in the compressor or turbine of conventional turbofan jet engines. A rotor disc can comprise a single rotor blade and a counterweight in some embodiments. In other embodiments a rotor disc can comprise two rotor blades. In yet other embodiments a rotor disc can comprise a plurality of rotor blades. A rotor disc can comprise 5 rotor blades. A rotor disc can also comprise 12 or 52 rotor blades. The upstream and downstream thrust apparatuses are configured in accordance with U.S. Provisional patent application 62/543,371 filed on Aug. 10 2017. In a scenario in which the free stream velocity of the PU is low, such as during hover, climbing flight, or cruising flight below around Mach 0.5, the upstream thrust apparatus is configured to generate thrust in an upstream direction, while the downstream thrust apparatus is configured to generate thrust in a downstream direction. In other words, the thrust of the upstream thrust apparatus is larger than the net thrust of the PU, since the downstream thrust apparatus cancels a portion of the thrust generated by the upstream thrust apparatus. The thrust of the upstream thrust apparatus can be 3 times as large as the net thrust of the PU in some embodiments or some modes of operation. The thrust of the upstream thrust apparatus can be 7 times as large as the net thrust of the PU in some embodiments or some modes of operation. The thrust of the upstream thrust apparatus can be 10 times as large as the net thrust of the PU in some embodiments or some modes of operation. The thrust of the upstream thrust apparatus can be 15 times as large as the net thrust of the PU in some embodiments or some modes of operation. The thrust of the upstream thrust apparatus can be 20 times as large as the net thrust of the PU in some embodiments or some modes of operation. The downstream thrust apparatus is configured to be operated as a turbine which recovers a portion of the energy imparted to the fluid by the upstream thrust apparatus. The larger thrust of the upstream thrust apparatus increases the mass flow rate of air flowing through the PU compared to the scenario in which the PU consists of just a single thrust apparatus generating the same net thrust. The increase in the mass flow rate manifests itself as an increase in the local free stream flow velocity magnitude at the upstream thrust apparatus due to an increase in the induced flow velocity at the upstream thrust apparatus. The downstream thrust apparatus is located in the streamtube of the upstream thrust apparatus at a location sufficiently far downstream of the upstream thrust apparatus such that the downstream thrust apparatus does not significantly reduce the local free stream flow at the upstream thrust apparatus. In other words, the induced velocity of the downstream thrust apparatus at the upstream thrust apparatus in the upstream direction should be sufficiently small or negligible such that the net induced velocity of the upstream thrust apparatus and the downstream thrust apparatus at the upstream thrust apparatus in the downstream direction is as large as possible, or as large as desired. This ensures that the local free stream flow speed at the upstream thrust apparatus, and the mass flow rate through the upstream thrust apparatus, is as large as possible, or as large as desired. To that end, the downstream thrust apparatus can be located in the far wake of the upstream thrust apparatus, such that the induced flow velocity magnitude at the upstream thrust apparatus due to the downstream thrust apparatus is negligible, for example. The duct enclosing the upstream and downstream thrust apparatus can be employed to further increase the mass flow rate of air through the duct. In some embodiments, the duct can also be configured with sufficient structural strength to contain components of the thrust apparatus, such as rotor blades or rotor discs, in the event of a structural failure of a thrust apparatus or other component within the duct. The duct can be constructed of sufficiently strong materials, such that the probability of components of the PU entering or damaging the fuselage 121 in the event of a structural failure of a thrust apparatus or other component within the duct of a PU can be reduced.

In some embodiments, a PU can comprise a thrust apparatus. In some embodiments, a PU can comprise a single, conventional propeller without a duct, i.e. an unducted rotor, or an unshrouded rotor, or an open rotor. In some embodiments, a PU can comprise a single, ducted propeller. The duct geometry can be configured to increase the local free stream flow at the rotor disc. The duct geometry can also be configured to decrease the local free stream flow at the rotor disc. For example, the duct geometry can be configured to decelerate the free stream flow during cruise above about Mach 0.5, such that the local free stream flow at the rotor disc is sufficiently small, such that the local free stream flow at the tips of the rotor blades is less than about Mach 1. In some embodiments, a PU can comprise an exoskeletal engine or a drum-rotor driving and structurally supporting the rotor blades from a radially outside position, as opposed to a central drive shaft 9, 23, 37, or 51 driving and structurally supporting the rotor blades from a radially inward position. In some embodiments, the duct of a PU need not be a straight duct. In some embodiments, the inlet cross-sectional area or shape need not be the same size or geometry as the outlet cross-sectional area or shape. In some embodiments, the outlet cross-sectional area can be smaller or larger than the inlet cross-sectional area, where the inlet is located in the upstream direction of the outlet, and where the cross-sectional area is measured substantially perpendicularly to the flow. In some embodiments, the shape of the duct can follow the contour of the local free stream flow. This can result in a curved duct which more closely follows the geometry of the fuselage in a cruise configuration, for example. In some embodiments, a PU can comprise a Voith-Schneider thruster, a cyclogyro, or a Hall-effect thruster, or a magnetohydrodynamic (MHD) drive. In some embodiments, a PU can comprise two or more thrust apparatuses, where each thrust apparatus is configured to generate thrust in an upstream direction. In some embodiments, a PU can comprise multiple ducts. For example, PU 2 and/or PU 16 can comprise two ducts instead of one, where the two ducts are arranged in parallel fashion. Each duct can be configured in a similar manner as duct 2 in the figures, i.e. with an upstream thrust apparatus, such as upstream thrust apparatus 5, and a downstream thrust apparatus, such as downstream thrust apparatus 7. Similarly, PU 30 and/or PU 44 can comprise two or three ducts arranged in parallel fashion. The use of multiple ducts for each PU, where each duct comprises multiple thrust apparatuses, can increase the redundancy and safety of the aircraft.

In a scenario in which the free stream velocity of the PU is high, such as during cruising flight above around Mach 0.5, the downstream thrust apparatus can be feathered, i.e. produce a negligible amount of thrust or drag. In some embodiments, at such speeds the mass flow rate through the duct is limited by the constraint that the local free stream flow speed at the tips of the blades of the upstream thrust apparatus remain subsonic. In some embodiments, the flow at the tips of the blades can be transonic, or even in the low supersonic regime. This constraint can be met by feathering the downstream thrust apparatus and a suitably configured duct geometry. In this configuration, the duct performs a similar function as the duct of a conventional turbofan engine, where the fan in the turbofan engine is equivalent to the upstream thrust apparatus. The duct geometry in this case is configured to decelerate the free stream flow during cruising flight above around Mach 0.5, resulting in a reduced local free stream flow velocity at the upstream thrust apparatus, such that the local free stream flow velocity at the tip of the blades of the upstream thrust apparatus remains sufficiently small to avoid excessive drag due to shock waves forming at the tips of the blades. In some such embodiments, the duct geometry can be modified or morphed from a configuration which increases the local free stream flow speed at the upstream thrust apparatus during hover or cruising flight below around Mach 0.5 to a configuration which reduces the local free stream flow speed at the upstream thrust apparatus during cruise above around Mach 0.5. A wide variety of methods are available to modify or morph the duct geometry. This morphing can be facilitated by translating spikes, folding ramps or flaps, or variable area nozzles, such as those located at the rear of conventional jet engines for fighter aircraft, for example.

In other embodiments the local free stream flow speed constraint at the upstream thrust apparatus during cruising flight above about Mach 0.5 can also be satisfied by configuring the upstream thrust apparatus to generate thrust in the downstream direction and configuring the downstream thrust apparatus to generate thrust in the upstream direction, such that a desired net thrust is directed in the upstream direction. The upstream thrust apparatus is thus configured to reduce the local free stream flow speed at the upstream thrust apparatus to ensure that the local free stream flow velocity at the tip of the blades of the upstream thrust apparatus remains sufficiently small to avoid excessive drag due to shock waves forming at the tips of the blades. The upstream thrust apparatus is thus being operated as a turbine which recovers energy from the fluid. The downstream thrust apparatus is configured to accelerate the fluid flow and contribute to the net thrust of the PU. As before, the downstream thrust apparatus is located sufficiently far downstream of the upstream thrust apparatus such that the interference between the upstream thrust apparatus and the downstream thrust apparatus is minimized. In other words, the induced velocity of the downstream thrust apparatus at the upstream thrust apparatus in the downstream direction should be sufficiently small or negligible such that the net induced velocity of the upstream thrust apparatus and the downstream thrust apparatus at the upstream thrust apparatus is still in an upstream direction. This ensures that the local free stream flow speed at the upstream thrust apparatus is smaller than the free stream flow speed. Note that in a configuration in which the thrust of the upstream thrust apparatus is directed in the downstream direction and the thrust of the downstream thrust apparatus is directed in the upstream direction during cruising flight above about Mach 0.5 the geometry of the duct can be configured to increase or maximize the mass flow rate of air through the duct during a hover scenario, or during a scenario in which the free stream flow is less than about Mach 0.5. Such a duct geometry can further increase the thrust margin and further reduce the induced power during hover, or low speed cruise or climbing flight, compared to the aforementioned configuration in which the duct geometry is only configured to reduce the local free stream flow speed at the upstream thrust apparatus during cruising flight above about Mach 0.5 (and the downstream thrust apparatus is feathered) in order to satisfy the blade tip speed constraint of the upstream thrust apparatus.

In the embodiment 1 shown in FIG. 1, the rotor disc of a PU, such as rotor disc 5, 7, 33, or 35 comprises rotor blades with a variable pitch. The pitch of the rotor blades can be modified in a similar manner as the collective pitch of a helicopter tail rotor, or the variable pitch of the propeller of a conventional propeller aircraft, for example. In other embodiments, the rotor blades of a rotor disc can also be manipulated by a cyclic pitch control in a similar manner as a helicopter main rotor. This can impart additional maneuverability onto the aircraft, albeit at the cost of added mechanical complexity. In the case in which the upstream thrust apparatus or the downstream thrust apparatus comprise stator blades, the pitch of the stator blades can be modified in the preferred embodiment. The pitch can be controlled in a similar manner as the pitch of stator blades in a conventional jet engine. In other embodiments, the rotor blades of a rotor disc can be configured in a fixed pitch configuration, in a similar manner as the pitch of compressor blades in a conventional jet engine. This can reduce the mechanical complexity of the PU. The variable pitch of the rotor discs can be employed to control the magnitude of the thrust of the upstream and downstream thrust apparatuses. The variable pitch of both the upstream and downstream thrust apparatuses can be specially configured and modified during nominal operations to continuously and instantaneously optimize the performance and minimize the power consumption of a PU for a given amount of net thrust. The magnitude of the thrust of the downstream thrust apparatus can be configured relative to the magnitude of the thrust of the upstream thrust apparatus in that case. The variable pitch can also be employed to generate a desired amount of net thrust for a given free stream flow speed, or for a given local free stream flow speed for a PU, as is the case for variable pitch propellers on conventional propeller aircraft. Note that in some embodiments the range of the possible pitch angles of the rotor blades of the upstream and downstream thrust apparatus must be large enough in some embodiments, such that the direction of thrust of the thrust apparatuses can be reversed. In such embodiments, the thrust of the upstream thrust apparatus can be directed in the downstream direction as well as in the upstream direction, and the thrust of the downstream thrust apparatus can be directed in the upstream direction as well as the downstream direction.

In the embodiment 1 shown in the figures the rotor disc of the upstream thrust apparatus is connected via a drive shaft, such as drive shaft 9, 23, 37, or 51, to the rotor disc of the downstream thrust apparatus. The rate of rotation of the rotor disc of the upstream thrust apparatus is therefore the same as the rate of rotation of the rotor disc of the downstream thrust apparatus. In other embodiments, the rotor discs of the upstream and downstream thrust apparatus can be mechanically coupled via a drive train, where the drive train can comprise gears. For instance, the drive train can comprise a planetary gear. The drive train can be configured to ensure that the rate of rotation of the rotor discs of the upstream and downstream thrust apparatuses are not identical. The purpose of the drive train can be to ensure that the rate of rotation of the downstream thrust apparatus is optimal, or close to optimal, for a given rate of rotation of the upstream thrust apparatus and for a given nominal operating condition, such as hover or cruise. In some embodiments the drive train also comprises a gear box. In some embodiments the gear box can couple the rotor discs of the upstream and downstream thrust apparatuses of a PU via one of two gear ratios, for instance. A first gear ratio can be configured to maximize the performance of the PU during a first operating condition, such as hover, while a second gear ratio can be configured to maximize the performance of the PU during a second operating condition, such as nominal level cruise. In some embodiments, the gear box can also operate at a third gear ratio to maximize the performance of the PU during a third operating condition, such as climbing flight or level accelerating flight. The gear box can be configured in a similar manner as the gear boxes in the automotive industry, for example. In some embodiments the drive train can also comprise a clutch which can be configured to mechanically uncouple the rotor discs of the upstream and downstream thrust apparatuses. The rotor discs of the upstream and downstream thrust apparatuses can be uncoupled in the case in which the downstream thrust apparatus is feathered, for example. Embodiments in which the direction of rotation of the rotor discs of the upstream and downstream thrust apparatuses is not identical, i.e. not in the same direction, are also within the scope of the invention.

In some embodiments the rotor discs of the upstream thrust apparatus and the downstream thrust apparatus are mechanically uncoupled. A first electric motor can be configured to drive the upstream thrust apparatus, and a second electric motor can be configured to be driven by the downstream thrust apparatus in a scenario in which the thrust of the downstream thrust apparatus is in a downstream direction, and the thrust of the upstream thrust apparatus is in a upstream direction. In a scenario in which the thrust of the downstream thrust apparatus is in a upstream direction, and the thrust of the upstream thrust apparatus is in a downstream direction the first electric motor can be operated as an electric generator to generate electrical power, and the second electric motor can be operated to consume electrical power. At least a portion of the electrical power recovered by an electric motor being operated as an electric generator can be employed to power the electric motor being operated as a conventional electric motor which consumes power. The electrical motors can be mounted within the duct. The motors can be located at the center of the duct or circumferentially around the duct. The use of electric motors allows each rotor disc of the upstream and downstream thrust apparatuses to operate at an individual rotational speed, which can be optimized to maximize the performance, e.g. minimize the power consumption for a given amount of net thrust. In this configuration, a mechanical drive train comprising gears, gear boxes, or clutches is not necessary, which can reduce cost, weight, mechanical complexity, and material attrition.

One can define a “body frame” of the aircraft as follows. The x-axis of the body frame is parallel to and coincident with a line between the nose tip 61 and rear end 62 or trailing point 62 of the fuselage 121 and directed towards the front of the aircraft. The line between the nose tip 61 and rear end 62 or trailing point 62 of the fuselage 121 is denoted the “long axis” of the aircraft. The y-axis of the body frame is parallel to a line between the two wing tips of the aircraft and directed to the right of the aircraft when viewed from the rear of the aircraft in a cruise configuration with both wings extended. By definition, the origin of the body frame is located at the center of mass of the vehicle. In this particular embodiment, for simplicity, the center of mass can be considered to be located on the long axis of the aircraft. The long axis of the aircraft and the x-axis of the body frame are used interchangeably herein for simplicity.

Each PU, such as PU 2, 16, 30, or 44 is rotably coupled to the airframe 121 or fuselage 121 by support shafts, such as support shafts 10, 24, 38, or 52. The axis of rotation of any of the four PUs about their respective support shafts is substantially parallel to the long axis of the support shaft in this embodiment. In FIGS. 1-3 the axis of rotation of PUs 2 and 16 lies in a plane parallel to the plane of the ground 120. The axis of rotation of PUs 2 and 16 also lies within the xy-plane of the body frame of the aircraft in this embodiment. The axis of rotation of PUs 2 and 16 also has a component in the positive x-direction of the body frame, as illustrated in FIG. 3 by the arrangement of support shafts 10 and 24. In other embodiments, the axis of rotation need not be parallel to the long axis of the support shaft. The front PUs, such as PU 2 and PU 16, can be rotated by 360 degrees about their axes of rotation, i.e. about support shafts 10 and 24 in this embodiment. The rotation can be continuous, i.e. without limitation or up to an infinite rotational angle compared to a reference position, such as the position shown in FIGS. 4-6. In other embodiments, the rotation of the front PUs about their support shafts can be limited within a positive or negative 180 degrees relative to a reference position. In other embodiments, the rotation of the front PUs about their support shafts can be limited within a positive or negative 360 degrees relative to a reference position. In other embodiments, the rotation of the front PUs about their support shafts can be limited within a positive or negative 720 degrees relative to a reference position.

In the embodiment shown in the figures, the rear PUs, PU 30 and PU 44, can be rotated about their support shafts 38 and 52, respectively. The rotation of the rear PUs about their support shafts can be limited within approximately a positive or negative 135 degrees relative to a reference position, such as the position shown in FIGS. 4-6. The rotation can be limited by interference or a collision between the duct of a PU and the fuselage, for instance. In other embodiments, the rotation of the rear PUs about their support shafts can be limited within approximately a positive or negative 150 degrees relative to a reference position. In other embodiments, the rotation of the rear PUs about their support shafts can be limited within approximately a positive or negative 180 degrees relative to a reference position. In other embodiments, the rotation of the rear PUs about their support shafts can be limited within approximately a positive or negative 360 degrees relative to a reference position. In other embodiments, the rotation of the rear PUs about their support shafts can be limited within approximately a positive or negative 720 degrees relative to a reference position. In other embodiments, the rotation of the rear PUs about their support shafts can be continuous, i.e. without limitation or up to an infinite rotational angle compared to a reference position.

The “rear PU assembly” comprises PU 30, PU 44, support strut 38, support strut 52, and the support strut mounting 58. Each support strut, such as support strut 38 or support strut 52, is coupled to the support strut mounting 58. In this particular embodiment, each rear PU, such as PU 30 or 44, is rigidly coupled to a support strut, such as support strut 38 or support strut 52, and each support strut is rotably coupled to the support strut mounting 58. In other embodiments, each rear PU, such as PU 30 or 44, is rotably coupled to a support strut, such as support strut 38 or support strut 52, and each support strut is rigidly coupled to the support strut mounting 58. The support strut mounting 58 is annular in shape in this particular embodiment, as indicated in FIG. 2. Note that the cross-section of the fuselage when viewed along the x-direction is circular at the location of the support strut mounting 58 in this embodiment. The support strut mounting 58 is rotably coupled to the fuselage 121, where the axis of rotation is coincident with, and parallel to, the long axis of the aircraft, which in this case, is also coincident with the x-axis of the body frame. The rotating coupling can comprise ball bearings, for example. The rotation of the rear PU assembly can be performed by at least one actuator coupled to the interior of the support strut mounting 58. The actuator can be an electric motor, for example. The rotation can also be performed by actuating a mechanical linkage. The actuator can be a hydraulic actuator in some embodiments. As shown in FIGS. 4-6, in a cruise configuration, the thrust vectors of the rear PUs 40 and 44 lie in the xz-plane of the body frame. The support struts 38 and 52, as well as the drive shafts 37 and 51 also lie in the xz-plane of the body frame. The rotation of the rear PU assembly about the x-axis of the body frame can be limited within approximately a positive or negative 100 degrees relative to a reference position, such as the position shown in FIGS. 4-6. The rotation of the rear PU assembly about the x-axis of the body frame can be limited within approximately a positive or negative 180 degrees relative to a reference position, such as the position shown in FIGS. 4-6. The rotation of the rear PU assembly about the x-axis of the body frame can be limited within approximately a positive or negative 360 degrees relative to a reference position. The rotation of the rear PU assembly about the x-axis of the body frame can be limited within approximately a positive or negative 720 degrees relative to a reference position. In other embodiments, the rotation of the rear PU assembly about the x-axis of the body frame can be continuous, i.e. without limitation or up to an infinite rotational angle compared to a reference position.

In a storage configuration, or in a nominal hover configuration, or in a climbing configuration, the PUs of the vehicle are arranged in a vertical direction as shown in FIGS. 1-3. The long axis of a drive shaft, such as drive shaft 23, 9, 37, or 51, is aligned substantially perpendicularly to the ground plane when sitting on the ground, or the z-axis of the body frame of the aircraft, in this configuration. During hover the net thrust is directed in the upwards direction, with the upstream thrust apparatuses comprising rotor discs 5, 33, 47, and 19, and the downstream thrust apparatuses comprising rotor discs 7, 21, 35, and 49. In the hover or storage configuration shown in FIGS. 1-3 the support shafts 38 and 52 of PUs 30 and 44, respectively, also lie within the xy-plane of the body frame, as shown in FIG. 3. The axis of rotation of PUs 30 and 44 also has a component in the negative x-direction of the body frame, as illustrated in FIG. 3 by the arrangement of support shafts 38 and 52.

During nominal operations the aircraft 1 can land and takeoff in a hover configuration, as shown in FIGS. 1-3. During takeoff, or during the climb following a takeoff, the aircraft can extend its wings outwards into their cruise configuration shown in FIGS. 4-6 as soon as a suitable altitude has been reached. A suitable altitude can be an altitude at which there is a much reduced risk of the wings colliding with obstacles when in their extended configuration. Following a takeoff, the aircraft can climb to an altitude suitable for fixed wing flight, such as horizontal fixed wing flight, or climbing fixed wing flight. A suitable altitude can be an altitude at which there is a much reduced risk of the aircraft colliding with obstacles during fixed wing flight. During a nominal transition to fixed wing flight, the thrust of each individual PU can be increased, and the thrust vector of each individual PU can be oriented in an upstream direction. This reorientation can be facilitated by rotating the aircraft in the negative direction about its pitch axis, i.e. the y-axis of its body frame. This type of acceleration is similar in nature to the acceleration of a conventional helicopter, which also pitches downwards in order to accelerate into horizontal flight. The reorientation can also be facilitated by rotating the PUs relative to the fuselage 121. For example, the front PUs, namely PU 2 and PU 16 can be rotated in a manner in which their net thrust vector is directed in a forward direction, in the positive x-direction of the body frame. The front PUs can be rotated about their support struts, such as support strut 24 and support strut 10. PU 16 can be rotated about a direction vector, which is parallel to the axis of rotation associated with the support strut of PU 16 and directed in the positive y-direction of the body frame, in a negative direction according to the right hand rule. PU 2 can be rotated about the axis of rotation associated with its support strut in a manner which mirrors the rotation of PU 16 in the xz-plane of the body frame. Similarly, the rear PUs, namely PU 30 and PU 44 can also be rotated about their support struts, such as support struts 38 and 52, such that their net thrust vector is directed in a forward direction, in the positive x-direction of the body frame. By increasing the thrust magnitude and rotating the PUs forward, the altitude of the aircraft 1 can be maintained or increased while the aircraft 1 is being accelerated during the transition to wing borne flight. In other embodiments only the front PUs are rotated forwards during the acceleration and transition into wing borne flight. In other embodiments only the rear PUs are rotated forwards during the acceleration and transition into wing borne flight. Note that the wing borne flight can be horizontal flight, descending flight, or climbing flight. The flight mode in which at least a portion of the thrust of a PU is employed to cancel the weight of the aircraft is referred to as “PU assisted flight”, which encompasses hover, or low speed forward flight, for example.

Once the aircraft has gained sufficient amount of speed, the aircraft can transition into its cruising flight configuration. A sufficient amount of speed is a speed at which the nominal combined net thrust of the rear PUs, PUs 30 and 44, no longer needs to have a substantial component in the negative z-direction of the body frame, i.e. in an upwards direction of the body frame. This condition occurs when the required net force on the aircraft in the negative z-direction of the body frame is substantially provided by the remainder of the aircraft, i.e. the wing, fuselage, and PUs 2 and 16. For example, at a sufficient amount of speed during horizontal flight, the large majority of the lift force required to maintain level flight can be provided by the wing 90, the fuselage, and PUs 2 and 16. In general, a sufficient amount of speed has been reached when a transition of the rear PUs into their cruise configuration can be carried out without the aircraft departing from a desired trajectory. In some embodiments, at a sufficient amount of speed prior to the transition into the cruising flight configuration, the rear PUs 30 and 44 are in a “pre-cruise” configuration. In this case, the rear PUs are rotated in a fully forward position, such that both their thrust vectors lie substantially within the xy-plane of the body frame of the aircraft in a nominal scenario. In other words, relative to the hover configuration shown in FIGS. 1-3, PU 30 has been rotated by positive 90 degrees about a direction vector parallel to the axis of rotation associated with its support shaft 38 and directed in the negative y-direction of the body frame according to the right hand rule. In this configuration upstream thrust apparatus 33 is located upstream of downstream thrust apparatus 35, and drive shaft 37 is located in the xy-plane of the aircraft body frame. PU 44 is in a configuration which mirrors the configuration of PU 33 in the xz-plane of the body frame in a nominal scenario prior to the transition into the cruise configuration. Note that, prior to the transition into the cruise configuration, the rear PUs 30 and 44 are located in the wake of the front PUs 2 and 16, since the thrust vectors and drive shafts, such as drive shafts 9, 23, 37, or 51, all lie in the xy-plane of the body frame in a nominal pre-cruise configuration. Therefore, at least a portion of the streamlines in the streamtubes which enclose the air moving through the ducts of PUs 30 or 44 also pass through the ducts of PUs 2 or 16, respectively. In other words, there is an overlap between the streamtubes which enclose the air moving through the ducts of PUs 2 or 16 and the streamtubes which enclose the air moving through the ducts of PUs 30 or 44, respectively. The overlap in the streamtubes limits the total mass flow rate of air which passes through all PUs combined. This can lead to an unnecessarily large induced drag of the aircraft for a given amount of net thrust compared to the cruise configuration shown in FIGS. 4-6. Since in the pre-cruise configuration some streamlines pass through a rear PU, such as PU 30 or 44, after having been accelerated by a front PU, such as PU 2 or 16, the viscous drag of the aircraft can also be unnecessarily large in such a configuration.

The transition from the pre-cruise configuration into the cruise configuration shown in FIGS. 4-6 comprises a rotation of the rear PU assembly by 90 degrees in the positive direction about the x-axis of the body frame according to the right hand rule. In other embodiments the PU assembly can be rotated by 90 degrees in the negative direction about the x-axis of the body frame according to the right hand rule.

As mentioned, the benefit of the cruise configuration shown in FIGS. 4-6 compared to the pre-cruise configuration discussed above, is the reduction of the overlap of the streamtubes of the front PUs 2 and 16 and the rear PUs 30 and 44. The ratio of the mass flow rate of air which passes through a thrust apparatus of the rear PUs after having passed through a thrust apparatus of a front PU to the mass flow rate of air which passes through a thrust apparatus of the rear PUs without having passed through a thrust apparatus of a front PU is referred to as the “overlap ratio”, or “overlap fraction”. By rotating the rear PU assembly by 90 degrees relative to the front PUs 2 and 16 the overlap ratio can be reduced compared to the pre-cruise configuration in some embodiments. In some embodiments the overlap ratio can be smaller than unity in a cruise configuration. Note that, in a cruise scenario, the free stream cross-sectional area of a streamtube which encompasses the air which passes through a duct of a PU is typically smaller than the cross-sectional area of the duct of a PU at the upstream rotor disc of a PU, where the cross-sectional area is measured perpendicularly to the free stream flow or the local free stream flow. This is due to the constraint, or desirable condition, that the local free stream flow speed at the tips of the upstream rotor disc of a PU remain below Mach 1, or remain in the low supersonic speed range, during cruise, in order to prevent shock waves from forming, or reduce drag losses due to shock waves, or reduce the noise signature of the aircraft. Due to the aforementioned comparatively low free stream cross-sectional area of the streamtube, the overlap fraction during cruise can be very small or zero in the nominal cruise configuration shown in FIGS. 4-6 when the cruise speed is above about Mach 0.5. Embodiments in which the overlap ratio is equal to unity in a cruise configuration are also within the scope of the invention. It is desirable to reduce the overlap ratio in order to increase the total mass flow rate of air which passes through at least one thrust apparatus of a PU. The increase in the mass flow rate can arise from the increase in the total disc area of all PUs combined, as well as an increase in the total capture area of the PUs, i.e. the cross-sectional area in the free stream of the streamtube which encompasses all streamlines which pass through at least one thrust apparatus of a PU, where the cross-sectional area is measured far upstream of the PUs, i.e. in the free stream, and perpendicular to the free stream flow direction. The increase in the mass flow rate can reduce the induced power consumed by all PUs combined for a given amount of desired net thrust. This can increase the top speed of the aircraft and increase the thrust margin during takeoff, landing, or hover operations, and increase the maximum rate of climb.

Note that in typical embodiments the cruise configuration shown in FIGS. 4-6 is not only assumed during nominal level cruise, but also assumed during other modes of operation, such as during climbing flight, descending flight, accelerating or decelerating horizontal flight, or maneuvering flight, for example.

In some embodiments, the front PUs can be retracted into the fuselage 121 during cruise. This can reduce the total drag acting on the aircraft in a cruising configuration, where the drag can comprise viscous drag, wave drag, or induced drag, for example. The retraction can be performed in similar fashion as the retraction of landing gear, for example. The front PUs can be retracted into a bay or a storage volume inside the fuselage, where the bay can be covered by bay doors which follow the contour of the fuselage, as is the case for conventional landing gear bay doors. The front PUs can be retracted into the fuselage in telescoping fashion, i.e. via the telescopic reduction in length of support shafts 10 or 24, for instance. The front PUs can also be retracted by rotating the support shafts 10 or 24 substantially downwards and backwards, such that the front PUs are moved in the positive z-direction, in the negative x-direction, and into the fuselage. In some embodiments the front PUs can also be located further aft, i.e. further in the negative x-direction of the body frame compared to the embodiment shown in the figures. The front PUs can be stored below the seat of passengers 64 and 65, for instance. The front PUs can alternatively be stored in front of passengers 64 and 65. The front PUs can alternatively be stored in the volume of the fuselage occupied by passengers 64 and 65 in the figures.

In a nominal pre-cruise configuration embodiment, and in a nominal cruise configuration embodiment, each of the front PUs and each of the rear PUs is configured to generate a net thrust in the positive x-direction of the body frame. The free stream flow velocity relative to the aircraft comprises a non-zero component in the negative x-direction of the body frame. As described in the context of a nominal hover or climbing configuration, the upstream thrust apparatus within an individual PU, such as rotor disc 5, 19, 33, or 47, is configured to generate thrust in an upstream direction, and the downstream thrust apparatus within an individual PU, such as rotor disc 7, 21, 35, or 49, is configured to generate thrust in a downstream direction within the streamtube of the upstream thrust apparatus of the PU in order to generate a sufficiently large or desired mass flow rate through the upstream and downstream thrust apparatuses of the PU. The optimum magnitude of the thrust of each individual PU for a given pre-cruise or cruise free stream flow velocity magnitude and direction relative to the aircraft can be calculated or determined experimentally subject to the constraint that the sum of the thrusts of each individual PU is equal to the desired net thrust. For example, the net thrust of a rear PU can be slightly larger than the net thrust of a front PU during nominal pre-cruise or cruise. The optimal thrust of each individual PU during other operating conditions, such as during hover, climbing, or descending flight, can be determined in similar fashion using tools and methods known in the art.

In other pre-cruise configuration embodiments the front PUs 2 and 16 can be throttled back and even feathered, i.e. produce a negligible amount of thrust, while the rear PUs 30 and 44 produce a large portion or all of the desired net thrust. This can be done to reduce the net viscous drag on the aircraft and ensure that the flow entering the rear PUs 30 and 44 is substantially uniform. Reducing the thrust or feathering the front PUs is preferred since the disc area of the rear PUs is larger than the disc area of the front PUs, resulting in a larger achievable maximum mass flow rate through the rear PUs compared to the front PUs. Reducing the thrust or feathering the rear PUs instead of the front PUs, and increasing the thrust of the front PUs such that a desired net thrust is produced is also within the scope of the invention. The reduction of thrust or the feathering of the front PUs, or alternatively the rear PUs, can also improve the performance of an aircraft in the cruise configuration shown in FIGS. 4-6. This can be the case in particular in a scenario in which the aforementioned overlap fraction is not significantly reduced by the rotation of the rear PU assembly from a pre-cruise configuration into a cruise configuration, ceteris paribus.

In other pre-cruise configuration embodiments each front PU, i.e. PU 2 or 16, can produce a net thrust which is larger than the desired net thrust of the entire aircraft in this configuration, and each rear PU, i.e. PU 30 or 44, can produce a net thrust which is directed in the downstream direction. In effect, the front PUs 2 and 16 can be operated as an upstream thrust apparatus with a net thrust directed in the upstream direction, and the rear PUs 30 and 44 can be operated as a downstream thrust apparatus within at least a portion of the streamtube of the upstream thrust apparatus with a net thrust in the downstream direction, in accordance with U.S. Provisional patent application 62/543,371 filed on Aug. 10 2017. In some such embodiments, the upstream thrust apparatus within a front PU, such as rotor disc 5 within PU 2 or rotor disc 19 within PU 16, can be configured to generate thrust in the upstream direction. The downstream thrust apparatus within a front PU, such as rotor disc 7 within PU 2 or rotor disc 21 within PU 16, can be configured to generate thrust in a downstream direction, where the magnitude of the thrust is configured in a manner in which the streamtube of the front PUs 2 and 16 is substantially identical to the streamtube of the rear PUs 30 and 44. Since the diameter of the rear PUs 30 and 44 is larger than the diameter of the front PUs 2 and 16, the streamtube of the front PUs 2 and 16 needs to be increased in diameter before reaching the rear PUs 30 and 44. This can be accomplished by the aforementioned configuration in which the downstream thrust apparatuses within the front PUs are generating a thrust in a downstream direction. In this manner there are no portions within the rear PUs 30 and 44 which inconveniently lie outside of the streamtube of the front PUs and therefore decelerate normal free stream flow to a final speed which is smaller than the free stream flow speed and thus generate an unnecessary amount of drag, but rather decelerate flow within the streamtube of the front PUs which has already been accelerated by the front PUs 2 and 16 to a final speed which is still larger than the free stream flow speed. Embodiments in which the streamtube of the front PUs 2 and 16 is larger than the streamtube of the rear PUs 30 and 44 are also within the scope of the invention. In some embodiments the streamtube of the front PUs 2 and 16 can also be smaller than the streamtube of the rear PUs 30 and 44 in a pre-cruise configuration. In such embodiments, however, it is preferred that the portion of the upstream and downstream thrust apparatuses within the rear PUs 30 and 44 which lie outside of the streamtube of the upstream PUs 2 and 16 are configured to operate in conventional fashion, with the upstream thrust apparatuses generating a thrust in an upstream direction and the downstream thrust apparatuses generating thrust in the downstream direction such that there is still a net thrust in the upstream direction outside of the streamtube of the front PUs. This can be accomplished by configuring the portions of the rotor blades of the rotor discs of the rear PUs which lie outside of the streamtubes of the front PUs with a different pitch angle and angle of attack than the portions of the rotor blades of the rotor discs of the rear PUs which lie inside the streamtube of the front PUs, for example. In some such embodiments, both the upstream thrust apparatus within a front PU and the downstream thrust apparatus within a front PU can be configured to generate thrust in an upstream direction. In some such embodiments, the downstream thrust apparatus of a front PU can be feathered, or the thrust in the upstream direction of the downstream thrust apparatus of a front PU can be lower than the thrust in the upstream direction of the upstream thrust apparatus of a front PU. In some such embodiments, the upstream thrust apparatus of a front PU can be feathered, or the thrust in the upstream direction of the upstream thrust apparatus of a front PU can be lower than the thrust in the upstream direction of the downstream thrust apparatus of a front PU. The portion of the upstream and downstream thrust apparatuses within a rear PUs which lie within the streamtube of the front PUs in this pre-cruise configuration can both be configured to generate a thrust in the downstream direction in some embodiments. In other embodiments, the upstream thrust apparatus of the rear PUs, such as rotor disc 33 or 47, can be feathered and the downstream thrust apparatus of the rear PUs, such as rotor disc 35 or 49, can be configured to generate the required thrust in the downstream direction. In other embodiments, the downstream thrust apparatus of the rear PUs, such as rotor disc 35 or 49, can be feathered and the upstream thrust apparatus of the rear PUs, such as rotor disc 33 or 47, can be configured to generate the required thrust in the downstream direction.

Note that the pre-cruise configuration for the embodiment shown in the figures can also correspond to the cruise configuration for other embodiments, such as embodiments in which the rear PU assembly comprising PUs 30 and 44 cannot be rotated about the x-axis of the body frame. Such embodiments can have a reduced mechanical complexity and cost.

The transition from wing borne flight back into PU assisted flight can be similar to the aforementioned transition from PU assisted flight into wing borne flight, but carried out in reverse order. The rear PU assembly can be rotated by 90 degrees in the negative direction about the x-axis of the body frame from the cruise configuration into the aforementioned pre-cruise configuration. Note that the nominal pre-cruise configuration and the nominal post-cruise configuration are identical.

The transition from a post-cruise configuration back to PU assisted flight and ultimately hovering flight, can be similar to the aforementioned transition from hovering or climbing flight into PU assisted flight and pre-cruise flight. Recall that in a post-cruise configuration the thrust vectors of the PUs are substantially in the xy-plane of the body frame and directed in the positive x-direction. In some embodiments of this transition, the front PUs and/or rear PUs can be rotated about their support struts such that their thrust vectors have components in the negative z-direction of the body frame. The aircraft attitude can remain nominal during this rotation of the PUs. In a nominal attitude the xy-plane of the body frame is substantially parallel to the XY-plane of an inertial frame. In an inertial frame the Z-axis is parallel to, and directed in the opposite direction of, the local acceleration due to gravity. As a result of the rotation of the PUs, therefore, the net thrust vector of the PUs can have a component directed in the positive Z-direction of the inertial frame. The component of the combined net thrust of the PUs which is directed in the positive Z-direction of the inertial frame can be employed to cancel a portion of the weight of the aircraft, thus allowing PU assisted flight.

In other embodiments of this transition from post-cruise flight into a PU assisted flight, the entire aircraft can instead be rotated in a positive direction about the y-axis of the body frame while the thrust vectors of the PUs remain substantially in the xy-plane of the body frame and directed in the positive x-direction. The pitching up of the aircraft can result in the net thrust of the PUs having a non-zero component in the positive Z-direction of an inertial frame. The component of the combined net thrust of the PUs which is directed in the positive Z-direction of the inertial frame can be employed to cancel a portion of the weight of the aircraft, thus allowing PU assisted flight.

In some modes of operation the aircraft can also fly backwards. For example, the front and/or rear PUs can be rotated about their support struts such that their thrust vectors have components in the negative x-direction of the body frame. When the aircraft attitude remains nominally horizontal, this can result in a force in the backwards direction of the aircraft and facilitate backwards flight. In other such modes of operation, the thrust vectors of the front and/or rear PUs can be substantially parallel to, and in the negative direction of, the z-axis of the body frame. The thrust vectors of the front and/or rear PUs can also have a component in the positive x-direction of the body frame. In such a configuration, the aircraft can fly backwards by increasing its pitch attitude, i.e. rotating backwards about the y-axis of the body frame in a positive direction. Since the orientation of the PUs relative to the fuselage remains unchanged during the pitching up of the fuselage, the net thrust vector of the PUs also rotates in a backwards direction, such that the net thrust vector has a component in the backwards direction, allowing the aircraft to fly backwards. Note that this mode of operation is similar to the mode of operation of a helicopter, which also pitches upwards in order to fly backwards. Note that the rotation of the PUs about their support struts into a configuration in which the net thrust of the PUs has a non-zero component in the negative x-direction of the body frame, or the pitching up of the aircraft to rotate the net thrust vector of the PUs backwards and lead to a non-zero component of the net thrust vector in a backwards direction, can also be employed to decelerate the aircraft in forward flight, i.e. in flight in the positive x-direction or in a scenario in which the free stream flow direction relative to the body frame of the aircraft has a non-zero component in the negative x-direction of the body frame.

Some embodiments are also configured to be able to perform autorotation. In a nominal autorotation scenario, the aircraft is descending vertically, such that the z-axis of the body frame is parallel to the acceleration due to gravity and the free stream flow velocity relative to the aircraft is directed in the negative z-direction. In one autorotation embodiment, the front PUs 2 and 16, as well as the rear PUs 30 and 44 are rotated by 180 degrees about their support struts 10, 24, 38, and 52 compared to the hover configuration shown in FIGS. 1-3. In this configuration, the drive shafts of the PUs, namely drive shafts 9, 23, 37, and 51 are nominally parallel to the z-axis of the body frame, as is the case for the hover configuration shown in FIGS. 1-3. Because the PUs have been rotated by 180 degrees about their support struts, the upstream thrust apparatuses of the PUs, i.e. the rotor discs 5, 19, 33, and 47, are located in the positive z-direction, i.e. in a downwards direction, relative to the downstream thrust apparatuses of the PUs, i.e. the rotor discs 7, 21, 35, and 49. Since the free stream flow relative to the aircraft in a nominal autorotation scenario is in the negative z-direction of the body frame, the upstream thrust apparatuses are actually located upstream of the downstream thrust apparatuses of the PUs. In this autorotation configuration, the upstream thrust apparatuses of the PUs, i.e. the rotor discs 5, 19, 33, and 47, are configured to generate thrust in the upstream direction, i.e. in the positive z-direction of the body frame. The downstream thrust apparatuses of the PUs, i.e. the rotor discs 7, 21, 35, and 49, are configured to generate thrust in the downstream direction, i.e. in the negative z-direction of the body frame. The magnitude of the thrust of the downstream thrust apparatus of any one PU is larger than the magnitude of the thrust of the upstream thrust apparatus of the same PU, such that there is a net force in the downstream direction, i.e. in the negative z-direction of the body frame, on each PU. The combined net thrust force of the PUs can be employed to at least partially cancel the weight force on the aircraft. At least a portion of the power extracted from the fluid flow by the downstream thrust apparatus is employed to power the upstream thrust apparatus. In the nominal autorotation scenario, the drive shafts of the PUs, i.e. drive shafts 9, 23, 37, and 51 are not powered by an external actuator, such as an engine or an electric motor, but are completely powered by the air passing through the downstream thrust apparatus, thus allowing the PU to autorotate. As in the aforementioned hover scenario, or the cruise scenario, the upstream thrust apparatus is configured to generate thrust in the upstream direction in order to increase the mass flow rate of air through the PU, and in order to increase the local free stream flow speed at the downstream thrust apparatus. The increase in the mass flow rate can increase the magnitude of the net thrust of the PU in the upwards direction, i.e. in the negative z-direction of the body frame, and reduce the magnitude of the terminal velocity during autorotation. The increase in the local free stream flow speed at the downstream thrust apparatus can avoid or delay a vortex ring state, or VRS, forming at the downstream thrust apparatus. The duct around the PU and the upstream and downstream thrust apparatus of a PU also helps to increase the mass flow rate and can serve to avoid or delay a VRS forming at the downstream thrust apparatus. The delay of VRS allows the vehicle to descend at a slower speed during autorotation compared to PUs which comprise only a single thrust apparatus instead of an upstream and downstream thrust apparatus, ceteris paribus. This increases the safety of the passengers, cargo, and aircraft.

In another autorotation embodiment, the PUs can be in the same orientation as in the hover scenario shown in FIGS. 1-3. In this configuration, the drive shafts of the PUs, namely drive shafts 9, 23, 37, and 51 are nominally parallel to the z-axis of the body frame, as is the case for the hover configuration shown in FIGS. 1-3. The upstream thrust apparatuses of the PUs, i.e. the rotor discs 5, 19, 33, and 47, are located in the negative z-direction, i.e. in an upwards direction, relative to the downstream thrust apparatuses of the PUs, i.e. the rotor discs 7, 21, 35, and 49. Since the free stream flow relative to the aircraft in a nominal autorotation scenario is in the negative z-direction of the body frame, i.e. in an upwards direction, the so-called upstream thrust apparatuses are actually located downstream of the so-called downstream thrust apparatuses of the PUs. For this reason, the so-called upstream thrust apparatuses, i.e. the rotor discs 5, 19, 33, and 47, are referred to as the new downstream thrust apparatuses in the context of this autorotation configuration. Similarly, the so-called downstream thrust apparatuses of the PUs, i.e. the rotor discs 7, 21, 35, and 49, are referred to as the new upstream thrust apparatuses in the context of this autorotation configuration. This autorotation embodiment is otherwise similar to the aforementioned autorotation embodiment. As before, the new upstream thrust apparatuses of the PUs, i.e. the rotor discs 7, 21, 35, and 49, are configured to generate thrust in the upstream direction, i.e. in the positive z-direction of the body frame. The new downstream thrust apparatuses of the PUs, i.e. the rotor discs 5, 19, 33, and 47, are configured to generate thrust in the downstream direction, i.e. in the negative z-direction of the body frame. The magnitude of the thrust of the new downstream thrust apparatus of any one PU is larger than the magnitude of the thrust of the new upstream thrust apparatus of the same PU, such that there is a net force in the downstream direction, i.e. in the negative z-direction of the body frame, on each PU. The combined net thrust force of the PUs can be employed to at least partially cancel the weight force on the aircraft. At least a portion of the power extracted from the fluid flow by the new downstream thrust apparatus is employed to power the new upstream thrust apparatus. In the nominal autorotation scenario, the drive shafts of the PUs, i.e. drive shafts 9, 23, 37, and 51 are not powered by an external actuator, such as an engine or an electric motor, but are completely powered by the air passing through the new downstream thrust apparatus, thus allowing the PU to autorotate. Note that the pitch angle of the rotor blades of the rotor discs of the PU is adjustable in a preferred embodiment. The variable pitch allows the rotor discs 5, 19, 33, and 47 to generate thrust in an upstream direction when the flow enters the PU from the side of these rotor discs in a hover, climb, or cruise scenario, and to generate thrust in a downstream direction when the flow enters the PU from the side of rotor discs 7, 21, 35, and 49 in an autorotation scenario, and, in some embodiments, to generate thrust in the downstream direction when the flow enters the PU from the side of the rotor discs 5, 19, 33, and 47 in a high speed cruise configuration, for example. Similarly, the variable pitch allows the rotor discs 7, 21, 35, and 49 to generate thrust in a downstream direction when the flow enters the PU from the side of the rotor discs 5, 19, 33, and 47 in a hover, climb, or cruise scenario, and to generate thrust in an upstream direction when the flow enters the PU from the side of rotor discs 7, 21, 35, and 49 in an autorotation scenario, and, in some embodiments, to generate thrust in the upstream direction when the flow enters the PU from the side of the rotor discs 5, 19, 33, and 47 in a high speed cruise configuration, for example. As mentioned, the pitch of the rotor blades can be modified in a similar manner as the collective pitch of a helicopter tail rotor, or the variable pitch of the propeller of a conventional propeller aircraft, for example.

In a decelerating mode of operation, such as a deceleration during cruising flight, the PUs can assume one of several configurations. Some configurations for decelerating the aircraft have already been discussed in the context of flying backwards. In a nominal decelerating scenario, the aircraft is in forward flight, i.e. in flight in the positive x-direction or in a scenario in which the free stream flow direction relative to the body frame of the aircraft has a non-zero component in the negative x-direction of the body frame. For example, the aircraft can be in a pre-cruise configuration, or in the cruise configuration shown in FIGS. 4-6. In some embodiments, the aircraft can also be in a PU assisted flight configuration, provided that the free stream flow through a thrust apparatus of a PU is sufficiently large. In one decelerating mode of operation, the direction of thrust of at least one PU can be reversed compared to the thrust of a PU during a cruise configuration. The upstream thrust apparatus of a PU, such as rotor discs 5, 19, 33, and 47, are configured to generate thrust in an upstream direction. The corresponding downstream thrust apparatus of a PU, such as rotor discs 7, 21, 35, and 49 are configured to generate thrust in a downstream direction. Note that the free stream flow passes through a PU from the upstream thrust apparatus towards the downstream thrust apparatus. In this decelerating mode of operation the magnitude of the thrust of the downstream thrust apparatus is configured to be larger than the magnitude of the thrust of the upstream thrust apparatus. This results in a net thrust magnitude in the downstream direction, which can serve to decelerate the aircraft. As before, the upstream thrust apparatus can be employed to increase the mass flow rate of air through the PUs, or through the rotor discs of the downstream thrust apparatuses. As discussed in the context of autorotation, the increased mass flow rate and increased local free stream flow at the downstream thrust apparatus can increase the magnitude of the net thrust of the PUs and can avoid or delay VRS from forming. The combined net thrust of all PUs can have a component in the negative x-direction of the body frame. The combined net thrust of all PUs can have a component in the same direction as the free stream flow velocity direction relative to the aircraft, which can serve to decelerate the aircraft. Note that this type of active deceleration using the reverse thrust of the PUs can increase the magnitude of the acceleration associated with the deceleration, and can allow the vehicle to decelerate faster and reach a desired speed sooner. This type of deceleration can be used in a conventional fixed wing landing during deceleration on the ground, for example. This type of deceleration can also be used to decelerate the aircraft from a cruise or post-cruise mode of operation to a PU assisted flight configuration, or a hover configuration, or a descending flight configuration.

In one climbing mode of operation, the vehicle can climb while in a substantially horizontal attitude, i.e. with the z-axis of the body frame being substantially parallel to the local acceleration due to gravity. As mentioned, in this mode of operation the vehicle can be in the configuration shown in FIGS. 1-3, for example. In a different a climbing configuration the fuselage can be inclined at an angle to the vertical. In other words, the pitch angle of the fuselage 121 can be greater than zero in some climbing modes of operation, i.e. the vehicle can be in a position in which it has been rotated in a positive sense about the y-axis of the body frame relative to the hover configuration shown in FIGS. 1-3. In some embodiments the pitch angle of the fuselage 121 in a climbing configuration can be 15 degrees. In some embodiments the pitch angle of the fuselage 121 in a climbing configuration can be 30 degrees. In some embodiments the pitch angle of the fuselage 121 in a climbing configuration can be 45 degrees. In some embodiments the pitch angle of the fuselage 121 in a climbing configuration can be 60 degrees. In some embodiments the pitch angle of the fuselage 121 in a climbing configuration can be 90 degrees. In the latter case, the PUs of the aircraft can be in a pre-cruise configuration, or in a cruise configuration, for example. In other such modes of operation, the PUs can be rotated at an angle about their support struts relative to a hover configuration, relative to a cruise configuration, or relative to a pre-cruise configuration. In other such modes of operation, the rear PU assembly can be rotated at an angle about the x-axis of the body frame relative to a pre-cruise configuration or a cruise configuration. In other words, in a nominal vertical climb configuration, the x-axis of the body frame can be directed in the opposite direction of the acceleration due to gravity, and the net thrust vector of all PUs combined can have a component in the positive x-direction of the body frame. The net thrust of the PUs can be employed to cancel the weight of the aircraft during vertical climbing flight.

In order to change the roll attitude during a nominal hover, the net thrust of individual PUs on one side, such as PUs 2 and 30, can be increased, while the net thrust of individual PUs on another side, such as PUs 16 and 44, can be decreased, or vice versa. The thrust differential can be employed to roll the aircraft about the x-axis of the body frame. Note that this mode of operation is similar to the operation of a quadrotor helicopter. Roll control can be employed to enter a sideways flight mode, or to counteract an external disturbance, for example. The thrust of an individual PU can be modified in several ways. For example, the rate of rotation of an upstream rotor disc of a PU, such as upstream rotor discs 5, 19, 33, and 47, can be increased or decreased. For example, the rate of rotation of a downstream rotor disc of the same PU, such as downstream rotor discs 7, 21, 35, and 49, can be increased or decreased. Recall that in some embodiments the rate of rotation of an upstream rotor disc can be uncoupled from the rate of rotation of a downstream rotor disc. For instance, an upstream rotor disc can be powered by an electric motor, or power a separate electric generator, and a downstream rotor disc can be powered by a separate electric motor, or power a separate electric generator. The rates of rotation of an upstream and downstream rotor disc of a PU can also be uncoupled by a gear box with at least two different gear ratios, for example. The thrust of a PU can also be modified by changing the collective pitch of the rotor blades of an upstream rotor disc, or a downstream rotor disc. This can change the angle of attack of a rotor blade and change the amount of lift acting on a rotor blade, which can change the thrust acting on a rotor disc.

The roll angle of an aircraft can also be modified by using thrust vectoring. A PU can be rotated in a positive or negative sense about the axis of rotation associated with its support shaft, such as support shaft 10, 24, 38, or 52. This can modify the magnitude of a component of thrust perpendicular to the x-axis of the body frame, and thus contribute to the generation of a roll moment about the x-axis. For example, the thrust vector of a front PU, such as PU 2, can be rotated forward relative to the hover configuration, such that the thrust vector now has a component in the positive x-direction of the body frame. The thrust vector of a rear PU, such as PU 30, can be rotated backwards, such that the thrust vector now has a component in the negative x-direction. In other embodiments, the thrust vectors of PU 2 and PU 30 can also be rotated towards each other. The rotation of the thrust vector of the front PU 2 and the rear PU 30 can be coordinated and configured such that the thrust component in the positive x-direction cancels the thrust component in the negative x-direction in some such modes of operation. This can avoid yaw coupling during roll control. In other embodiments, the thrust vectors of PU 2 and PU 30 can both be rotated backwards. In other embodiments, the thrust vectors of PU 2 and PU 30 can both be rotated forwards. The thrust magnitude of the front PU 2 and the rear PU 30 can remain unchanged compared to the hover configuration in some such modes of operation. Due to the rotation of the thrust vectors of the front PU 2 and the rear PU 30, the component of the combined thrust of the front PU 2 and the rear PU 30 in the negative z-direction, or perpendicular to the x-axis of the body frame, is reduced. When the thrust of the front PU 16 and the rear PU 44 is unchanged in magnitude and direction, or increased in magnitude and unchanged in direction, a net rolling moment can be generated in a negative direction about the x-axis of the body frame, for example.

Other modes of operation for changing the roll angle of the aircraft in a hover configuration are known to those with ordinary skill in the art and can also be employed. For example, the left wing 91 can be extended further than the right wing 97, resulting in a change in the location of the center of mass relative to the center of pressure or lift of the PUs. This can generate a roll moment. In some embodiments a flywheel or an otherwise available rotational inertia, such as the rotational inertia of an engine, or the rotational inertia of the rear PU assembly, can be employed to change the roll angle of an aircraft. Gyroscopic effects, such as those associated with the angular momentum of the PUs or an engine or a flywheel, can also be employed for roll control. A wide variety of such methods are known in the art. These and other methods for roll control, can also be applied to other modes of operation, such as PU assisted flight, or cruising flight.

The pitch angle of an aircraft in a hover configuration can be modified in a similar manner. The thrust of a front PU 2 or 16, or the thrust of a rear PU 30 or 44 can be increased or decreased. This can generate a pitching moment about the center of gravity of the aircraft, and change the pitch attitude of the aircraft. Note that this mode of operation is similar to the operation of a quadrotor helicopter. As mentioned previously, a wide variety of methods for modifying the thrust of a PU can be employed.

The pitch angle of an aircraft can also be modified using thrust vectoring. For example, the front PUs, such as PUs 2 and 16, can be rotated forwards or backwards relative to their hover configuration. In some such modes of operation, the net thrust of the individual front PUs can remain unchanged compared to the hover configuration. Due to the rotation of the thrust vectors of the front PUs, the component of the thrust vectors in the negative z-direction, or in a direction perpendicular to the y-axis, can be reduced. In this example, the thrust magnitude and direction of the rear PUs 30 and 44 can remain unchanged, or the thrust direction of the rear PUs 30 and 44 can remain unchanged while the thrust magnitude is increased. As a result there can be a negative pitching moment about an axis parallel to the y-axis of the body frame, which can lead to a change in the pitch attitude in a negative direction. A change in the pitch attitude in a positive direction can employ similar principles. In some such modes of operation, the thrust vectors of the rear PUs 30 and 44 can be rotated relative to the hover configuration by changing the orientation of the PUs, resulting in a decrease in the component of the net thrust of the rear PU assembly in a direction perpendicular to an axis parallel to the y-axis of the body frame. Note that the net thrust vector of the rear PU assembly can be rotated both in a positive or negative x-direction by rotating the rear PUs 44 and 30 about their support shafts 38 and 52, as well as in a positive or negative y-direction by rotating the rear PU assembly about the x-axis.

Other modes of operation for changing the pitch angle of the aircraft in a hover configuration are known to those with ordinary skill in the art and can also be employed. For example, the left wing 91 and the right wing 97 can be extended from a configuration shown in FIGS. 1-3 to a configuration shown in FIGS. 4-6, or any configuration in between, resulting in a change in the location of the center of mass relative to the center of pressure or lift of the PUs. This can generate a pitching moment. In some embodiments a flywheel or an otherwise available rotational inertia, such as the rotational inertia of an engine, or the rotational inertia of an individual PU, can be employed to change the pitch angle of an aircraft. Gyroscopic effects, such as those associated with the angular momentum of the PUs or an engine or a flywheel, can also be employed for pitch control. A wide variety of such methods are known in the art. These and other methods for pitch control can also be applied to other modes of operation, such as PU assisted flight, or cruising flight.

The yaw angle of an aircraft in a hover configuration can be modified in a similar manner. In the embodiment shown in the figures, the direction of rotation of front PU 2 and rear PU 44 is in the same direction, while their direction of rotation is in a different direction as the direction of rotation of front PU 16 and rear PU 30 in a nominal hover configuration. Note that each PU experiences a torque which acts about an axis substantially parallel to the drive shaft of a PU, i.e. drive shaft 9, 23, 37, or 51. The torque arises from the drag force on the rotating rotor discs, where the drag can comprise induced drag or viscous drag, for example. Since PUs 2 and 44 are rotating in a different direction compared to PUs 16 and 30, the torque on PUs 2 and 44 is in a different direction than the torque on PUs 16 and 30. In general, the torque increases with an increasing thrust magnitude of a PU. By increasing the thrust magnitude of PUs 2 and 44, and decreasing the thrust magnitude of PUs 16 and 30, a net torque can be generated in a hover configuration. By decreasing the thrust magnitude of PUs 2 and 44, and increasing the thrust magnitude of PUs 16 and 30, a net torque can be generated in a different direction in a hover configuration. Note that this mode of operation is similar to the yaw control of a quadrotor helicopter. As mentioned previously, a wide variety of methods for modifying the thrust of a PU can be employed.

The yaw angle of an aircraft in a hover configuration can also be modified via thrust vectoring. For example, the thrust vector of PUs 30 and/or 2 can be rotated forwards relative to a hover configuration, such that the thrust vectors now have a component in the positive x-direction of the body frame. Alternatively, or concurrently, the thrust vectors of PUs 16 and/or 44 can be rotated backwards relative to a hover configuration, such that the thrust vectors now have a component in the negative x-direction of the body frame. The thrust vectors can be rotated by rotating the PUs about their support shafts, such as support shafts 10, 24, 38, or 52. In both scenarios, there can be a net moment about the center of mass of the aircraft, where the moment vector has a component in the positive z-direction. This moment can lead to an increase in the yaw angle of the aircraft. A decrease in the yaw angle can be accomplished by rotating the PUs and their associated thrust vectors in the other direction about the support shafts, for example. In some such modes of operation, the thrust of the PUs that have been rotated can be increased such that the net thrust of the PUs in the negative z-direction remains unchanged. Thus the vehicle can perform yaw control without increasing or decreasing the net thrust of the vehicle in the negative z-direction, i.e. without changing altitude, if desired. In other modes of operation employing thrust vectoring, the rear PU assembly comprising PUs 30 and 44 can be rotated with the support strut mounting 58 about the x-axis of the body frame relative to the hover configuration. In this manner the net thrust of the rear PU assembly can be redirected to have a component in the positive or negative y-direction of the body frame, i.e. in a direction which is perpendicular to an axis parallel to the z-axis of the body frame. Since this component of the thrust force is also associated with a moment arm about the center of mass of the aircraft, this component of the thrust force can be employed to contribute to a positive or negative net yawing moment about the center of mass of the aircraft. This yawing moment can be employed to change the yaw angle or attitude of the aircraft. In some such modes of operation, the thrust of the PUs that have been rotated can be increased such that the net thrust of the PUs in the negative z-direction remains unchanged. Thus the vehicle can perform yaw control without increasing or decreasing the net thrust of the vehicle in the negative z-direction, i.e. without changing altitude, if desired.

Other modes of operation for changing the yaw angle of the aircraft in a hover configuration are known to those with ordinary skill in the art and can also be employed. In some embodiments a flywheel or an otherwise available rotational inertia, such as the rotational inertia of an engine, or the rotational inertia of an individual PU, can be employed to change the yaw angle of an aircraft. Gyroscopic effects, such as those associated with the angular momentum of the PUs or an engine or a flywheel, can also be employed for yaw control. A wide variety of such methods are known in the art. These and other methods for yaw control can also be applied to other modes of operation, such as PU assisted flight, or cruising flight.

During PU assisted flight, pre-cruise, or cruise, the roll attitude of the aircraft can be changed by a variety of methods. For example, the roll attitude can be changed by deflecting the ailerons or other control surfaces on the wings, such as elevons, flaps, slats, or spoilers or speed brakes. For example, the ailerons on the left wing 91 can be deflected by a different amount compared to the ailerons on the right wing 97, resulting in a different net aerodynamic force on the left wing 91 in a direction perpendicular to the x-axis of the body frame compared to the right wing 97. This can result in a net rolling moment about the x-axis of the body frame.

The roll attitude can also be changed by changing the orientation of the PUs relative to the fuselage, such that the thrust of the PUs can be employed for roll control using thrust vectoring, and such that the aerodynamic loads on the ducts of the PUs can be employed for roll control. For instance, consider a scenario in which the PUs can be in a PU assisted flight configuration, in a pre-cruise configuration, a cruise configuration, or any configuration in between. The front PU 2 can be rotated in a negative sense about a direction vector parallel to the axis of rotation about support shaft 10 and directed in the negative y-direction. Concurrently, or alternatively, front PU 16 can be rotated in a negative sense about a direction vector parallel to the axis of rotation about support shaft 24 and directed in the positive y-direction. The thrust vector of PU 2 can thus comprise a stronger or larger component in the negative z-direction, or perpendicular to the x-axis of the body frame compared to the previous configuration. Similarly, the thrust vector of PU 16 can comprise a smaller component in the negative z-direction, or a larger component in the positive z-direction, or perpendicular to the x-axis of the body frame. This can lead to an imbalance in the moment generated by the thrust vectors of all PUs, as well as the aerodynamic loads on the wing and fuselage, about the x-axis of the body frame and about the center of mass of the aircraft, which can generate a net positive roll moment about the x-axis of the body frame. A negative roll moment can be generated by rotating the PUs in the opposite directions, for instance. In this simplified example, the magnitudes of the thrust vectors of the PUs remain substantially unchanged during the change in the orientation of the PUs. In other modes of operation, the magnitudes of the thrust vectors of the PUs can be increased or decreased. The rear PUs, which can be in a PU assisted flight configuration, in a pre-cruise configuration, a cruise configuration, or any configuration in between, can be employed in a similar manner as the front PUs in order to generate a positive or negative rolling moment about the x-axis of the body frame. In a nominal PU assisted flight mode, the magnitude of the thrust of the PUs on one side, such as PUs 2 and/or 30 can be changed relative to the magnitude of the thrust of the PUs on another side, such as PUs 16 and/or 44, as discussed in the context of roll control during hover. As mentioned, other methods for roll control discussed in the context of hovering flight can also be employed during PU assisted flight.

The aerodynamic loads on the ducts of the PUs can also be employed to contribute to the roll control of the aircraft during PU assisted flight, pre-cruise, or cruise, for example. The ducts of the front PUs 2 and 16 can be employed in a similar manner as the canard control surfaces on the Eurofighter Typhoon jet aircraft, i.e. used for both roll control and pitch control, for example. Thus, even in the case in which the front PUs are in a feathered configuration, i.e. producing a negligible amount of thrust, the front PUs can be employed to contribute to roll and/or pitch control of the aircraft. For example, the ducts of the front PUs 2 and 16 can be deflected relative to the free stream. A non-zero angle of attack of the ducts relative to the local free stream flow can thus be established. For example, in a nominal configuration the ducts of the front PUs 2 and 16 can be in a cruise configuration shown in FIGS. 4-6. When the PUs are rotated about their support shafts 10 or 24, a non-zero angle of attack can be formed by the ducts of the PUs relative to the local free stream flow. This can generate an aerodynamic lifting force which can be perpendicular to the local free stream flow and a function of the angle of attack. Combined with a drag force acting on the PU, a net aerodynamic force can be generated to act on the PUs, where the force can be directed in the positive or negative z-direction depending on the angle of attack of the PUs, for example. This force can be employed to generate a rolling moment about the x-axis of the body frame. In effect, the ducts can be employed as annular wings, circular wings, or closed wings, and their lift and drag force can be modified by changing their angle of attack relative to the local free stream flow. The ducts of the rear PUs 30 and 44 in a pre-cruise configuration can be employed in a similar manner as the ducts of front PUs 2 and 16 described above. For instance, the ducts of the rear PUs 30 and 44 in a pre-cruise configuration or PU assisted flight configuration can be operated in a similar manner as tailerons on the Lockheed F-35, i.e. used for both roll control and pitch control. Similarly, the ducts of the rear PUs 30 and 44 in a cruise configuration can be employed in a similar manner as the rudderons on an aircraft, i.e. used for yaw control and roll control. In other words, the ducts of the rear PUs 30 and 44 in a cruise configuration can be used for yaw control by being deflected or rotated in the same direction, and for roll control by being deflected or rotated in opposing directions, or different directions. Recall that the ducts of the rear PUs 30 and 44 in a cruise configuration shown in FIGS. 4-6 are equivalent to the ducts of the rear PUs 30 and 44 in a nominal pre-cruise configuration where the rear PU assembly has been rotated by positive or negative 90 degrees about the x-axis of the body frame.

Roll control can also be facilitated by changing the torque acting on each PU during PU assisted flight, pre-cruise, or cruise. As described in the context of yaw control in a hover or PU assisted flight configuration, the torque acting on PUs 2 and 44 is in a different direction to the torque acting on PUs 16 and 30 in some embodiments. The torque is also a function of the thrust of a PU. Note that the torque vectors are typically substantially parallel to the drive shafts of the PUs, such as drive shafts 9, 23, 37, or 51. In a nominal PU assisted flight, pre-cruise, or cruise configuration, the drive shafts and the associated individual torque vectors comprise a non-zero component in the positive or negative direction along the x-axis of the body frame. Note that in a nominal scenario, these components cancel each other, resulting in a zero or negligible net torque about the x-axis of the body frame due to the aerodynamic torque on the PUs. By increasing the thrust of PUs 2 and 44 and/or decreasing the thrust of PUs 16 and 30 relative to the thrust of these PUs in a nominal PU assisted flight, pre-cruise, or cruise configuration, a net torque component can be generated about the x-axis of the aircraft. The component of the net torque along the x-axis can be positive or negative, and can be employed in the roll control of the aircraft, or modifying or regulating the roll angle of the aircraft. Note the similarity between this type of roll control during cruise, pre-cruise, or PU assisted flight and the aforementioned yaw control during hovering flight using the torque of the thrust apparatuses within the PUs.

Other modes of operation for changing the roll angle of the aircraft in a cruise configuration, in a PU assisted flight configuration, or in a pre-cruise configuration, are known to those with ordinary skill in the art and can also be employed. For example, the left wing 91 can be extended further than the right wing 97, resulting in a change in the location of the center of lift or the center of aerodynamic pressure of the PUs and the wings relative to the center of mass of the aircraft. When the center of pressure is offset relative to the center of mass and when the net aerodynamic force is directed in a direction which is perpendicular to the x-axis of the body frame, a roll moment can be generated. In some embodiments a flywheel or an otherwise available rotational inertia, such as the rotational inertia of an engine, or the rotational inertia of the rear PU assembly, can be employed to change the roll angle of an aircraft. Gyroscopic effects, such as those associated with the angular momentum of the PUs or an engine or a flywheel, can also be employed for roll control. A wide variety of such methods are known in the art. These and other methods for roll control can also be applied to other modes of operation, such as climbing flight.

During PU assisted flight, pre-cruise, or cruise, the pitch attitude of the aircraft can be changed by a variety of methods. For example, the pitch attitude can be changed by deflecting the elevons or other control surfaces on the wings, such as flaps, slats, or spoilers or speed brakes. For example, elevons mounted at the trailing edges on the outer segment 92 of the left wing 91 can be deflected downwards together with the elevons mounted at the trailing edges on the outer segment 98 of the right wing 97. The deflection of the elevons increases the lift force magnitude on the rear segments 92 and 98 of the wing. Due to the sweep of the wings, the increase in the lift force at the rear segments 92 and 98 of the wing can also generate a negative pitching moment about the center of mass of the aircraft. A positive pitching moment can be generated by an upwards deflection of the elevons relative to a nominal or reference scenario, such as nominal PU assisted flight, nominal cruise, or nominal pre-cruise, or nominal climb. In some embodiments, split flaps at the trailing edges of the wings, or spoilers on the wings, can be employed to increase the drag of the wings. This increased drag force can contribute to a positive pitching moment about the center of mass of the wing. A deliberate increase or decrease in the wing drag force can thus be employed for pitch control of the aircraft.

The pitch attitude can also be changed by changing the orientation of the PUs relative to the fuselage, such that the thrust of the PUs can be employed for pitch control using thrust vectoring, and such that the aerodynamic loads on the ducts of the PUs can be employed for pitch control. For instance, consider a scenario in which the PUs can be in a PU assisted flight configuration, in a pre-cruise configuration, a cruise configuration, or any configuration in between. The front PU 2 can be rotated in a negative sense about a direction vector parallel to the axis of rotation about support shaft 10 and directed in the negative y-direction. Concurrently, or alternatively, front PU 16 can be rotated in a positive sense about a direction vector parallel to the axis of rotation about support shaft 24 and directed in the positive y-direction. The thrust vector of PU 2 can thus comprise a stronger or larger component in the negative z-direction, or perpendicular to the y-axis of the body frame compared to the previous configuration. Similarly, the thrust vector of PU 16 can comprise a stronger or larger component in the negative z-direction, or perpendicular to the y-axis of the body frame. This can lead to an imbalance in the moments generated by the thrust vectors of all PUs, as well as the aerodynamic loads on the wing and fuselage, about the y-axis of the body frame and about the center of mass of the aircraft, which can lead to a net positive pitching moment about the y-axis of the body frame. A negative pitching moment can be generated by rotating the front PUs in the opposite directions, for instance. In this simplified example, the magnitudes of the thrust vectors of the PUs remain substantially unchanged during the change in the orientation of the PUs. In other modes of operation, the magnitudes of the thrust vectors of the PUs can be increased or decreased. The rear PUs, which can be in a PU assisted flight configuration, or a pre-cruise configuration, or a hover configuration, can be employed in a similar manner as the front PUs in order to generate a positive or negative pitching moment about the y-axis of the body frame. In a nominal PU assisted flight mode, the magnitude of the thrust of the PUs on one side, such as front PUs 2 and/or 16 can be changed relative to the magnitude of the thrust of the PUs on another side, such as rear PUs 30 and/or 44, as discussed in the context of pitch control during hover. As mentioned, other methods for pitch control discussed in the context of hovering flight can also be employed during PU assisted flight.

The aerodynamic loads on the ducts of the PUs can also be employed to contribute to the pitch control of the aircraft during PU assisted flight, pre-cruise, or cruise, for example. As mentioned, the ducts of the front PUs 2 and 16 can be employed in a similar manner as the canard control surfaces on the Eurofighter Typhoon jet aircraft, i.e. used for both pitch control and roll control, for example. Thus, even in the case in which the front PUs are in a feathered configuration, i.e. producing a negligible amount of thrust, the front PUs can be employed to contribute to roll and/or pitch control of the aircraft. For example, the ducts of the front PUs 2 and 16 can be deflected relative to the free stream. A non-zero angle of attack of the ducts relative to the local free stream flow can thus be established. For example, in a nominal configuration the ducts of the front PUs 2 and 16 can be in a cruise configuration shown in FIGS. 4-6. When the PUs are rotated about their support shafts 10 or 24, a non-zero angle of attack can be formed by the ducts of the PUs relative to the local free stream flow. This can generate an aerodynamic lifting force which can be perpendicular to the local free stream flow and a function of the angle of attack. Combined with a drag force acting on the PU, a net aerodynamic force can be generated to act on the PUs, where the force can be directed in the positive or negative z-direction depending on the angle of attack of the PUs, for example. This force can be employed to generate a pitching moment about the y-axis of the body frame. In effect, the ducts can be employed as annular wings, circular wings, or closed wings, and their lift and drag force can be modified by changing their angle of attack relative to the local free stream flow. The ducts of the rear PUs 30 and 44 in a pre-cruise configuration can be employed in a similar manner as the ducts of front PUs 2 and 16 described above. As mentioned, the ducts of the rear PUs 30 and 44 in a pre-cruise configuration or PU assisted flight configuration can be operated in a similar manner as tailerons on the Lockheed F-35, i.e. used for both pitch control and roll control.

Pitch control can also be facilitated by changing the thrust magnitude acting on each PU during PU assisted flight, or cruising flight. As described in the context of pitch or roll control in a hover or PU assisted flight configuration, the thrust magnitude of PUs on opposite sides can be modified in order to generate a pitching moment. For example, in a nominal cruise configuration shown in FIGS. 4-6, the thrust magnitude of PU 30 can be reduced and/or the thrust magnitude of PU 44 can be increased. This can contribute to a net positive pitching moment about the y-axis of the body frame. A negative pitching moment can be generated by reducing the thrust magnitude of PU 44 and/or increasing the thrust magnitude of PU 30, for example. In other embodiments the center of mass of the aircraft is not in the same plane as the thrust vectors of the front PUs 2 and 16 in a cruise configuration. In such embodiments, an increase or decrease of the thrust of the front PUs can be employed to contribute to a net positive or negative pitching moment about the center of mass of the aircraft, and thus be used to facilitate pitch control, i.e. achieve a desired pitch angle. This type of pitch control can be employed in a cruise, or pre-cruise configuration, for example.

Other modes of operation for changing the pitch angle of the aircraft in a cruise configuration, in a PU assisted flight configuration, or in a pre-cruise configuration, are known to those with ordinary skill in the art and can also be employed. For example, the left wing 91 and/or the right wing 97 can be extended to a cruise configuration shown in FIGS. 4-6, or extended to a configuration in between a hover or storage configuration shown in FIGS. 1-3 and a cruise configuration, or retracted to a hover configuration, or retracted to a configuration in between a hover or storage configuration and a cruise configuration. During forward flight, i.e. during a mode of operation in which the wing is can generate lift, this extension or retraction of the wings can result in a change in the location of the center of lift or the center of aerodynamic pressure of the PUs and the wings relative to the center of mass of the aircraft. When the center of pressure is offset relative to the center of mass and when the net aerodynamic force is directed in a direction which is perpendicular to the y-axis of the body frame, a pitch moment can be generated. In some embodiments a flywheel or an otherwise available rotational inertia, such as the rotational inertia of an engine, or the rotational inertia of an individual PU and its associated rotating components, can be employed to change the pitch angle of an aircraft. Gyroscopic effects, such as those associated with the angular momentum of the PUs or an engine or a flywheel, can also be employed for pitch control. A wide variety of such methods are known in the art. These and other methods for pitch control can also be applied to other modes of operation, such as climbing flight.

During PU assisted flight, pre-cruise, or cruise, the yaw attitude of the aircraft can be changed by a variety of methods. For example, the yaw attitude can be changed by a larger or smaller drag force acting on one wing, such as the left wing 91, compared to the other wing, such as the right wing 97. The drag force acting on a wing can be modified by a split flap configured and operated in a similar manner as a split flap found on a Northrop Grumman B-2. A split flap can comprise a top flap and a bottom flap. By rotating the top flap upwards and the bottom flap downwards, flow separation can be induced in the wake of the split flaps, resulting in a drag force acting on the split flaps. By modifying the extent of the separation of the trailing edges of the top and bottom of the split flaps, the magnitude of the drag force can be controlled. The separation can be increased to increase the drag force on the split flaps, or decreased to decrease the drag force on the split flaps. The drag force on a wing can also be increased by further extending a spoiler, such as a spoiler found on the wing of a conventional commercial transport, such as a Boeing 737. Similarly, the drag force on a wing can be decreased by retracting a spoiler, i.e. reducing the extension of a spoiler. Other control surfaces on the wings, such as ailerons, elevons, flaps, or slats can also be used to modify the component of the net aerodynamic force on a wing in a direction perpendicular to the z-axis of the body frame. The downwards deflection of an aileron can increase the lift and the associated lift induced drag of the associated section of the wing, and thus increase the drag force acting on the wing. In order to generate a positive yawing moment in one example, the drag force on the right wing 97 can be increased, and/or the drag force on the left wing 91 can be decreased in one mode of operation relative to a simplified nominal operating condition in which the drag on the left wing 91 and the right wing 97 are substantially identical. A set of simplified nominal operating conditions can comprise nominal PU assisted flight, nominal cruise, or nominal pre-cruise, or nominal climb, for example. A negative yawing moment can be generated by applying the same principles of differential drag on two different portions of a wing, such as a left portion and a right portion of a wing. The change in the drag force of a wing can change the component of the net aerodynamic force on a wing in a direction perpendicular to the z-axis of the body frame. This can contribute to a yawing moment about the z-axis of the body frame and about the center of mass of the aircraft, and contribute to yaw control of the aircraft.

In a nominal PU assisted flight mode, the magnitude of the aerodynamic torque on the PUs in one direction, such as the magnitude of the torque of PUs 2 and/or 44 can be changed relative to the magnitude of the torque of the PUs in another direction, such as the magnitude of the torque of PUs 16 and/or 30, as discussed in the context of yaw control during hover. The magnitude of the torque can be modified by changing the magnitude of the thrust of a PU, for example, where an increase in the thrust is typically associated with an increase in the torque. When the net magnitudes of the torques of the PUs in one direction exceeds the net magnitudes of the torques of the PUs in another direction, the PUs can contribute a net amount of torque to the aircraft. Depending on the orientation of the PUs and the associated torque vectors relative to the body frame, this net amount of torque can have a component parallel to the z-axis of the aircraft. Thus, the torque on the PUs can be employed to contribute a net amount of torque to the aircraft, and used to contribute to yaw control. As mentioned, other methods for yaw control discussed in the context of hovering flight can also be employed during PU assisted flight.

The yaw attitude can also be changed by changing the orientation of the PUs relative to the fuselage, such that the thrust of the PUs can be employed for yaw control using thrust vectoring, and such that the aerodynamic loads on the ducts of the PUs can be employed for yaw control. For instance, consider a scenario in which the PUs can be in a PU assisted flight configuration, in a pre-cruise configuration, or any configuration in between. The front PU 2 and/or rear PU 30 can be rotated in a positive or negative sense about a direction vector parallel to the axis of rotation about support shaft 10 or support shaft 38, respectively, and directed in the negative y-direction, such that the component of the thrust vector of PU 2 and/or PU 30 in the positive x-direction, or the direction perpendicular to the z-axis of the body frame, is decreased, i.e. less positive or more negative. Concurrently, or alternatively, front PU 16 and/or rear PU 44 can be rotated in a positive or negative sense about a direction vector parallel to the axis of rotation about support shaft 24 or support shaft 52 and directed in the positive y-direction, such that the component of the thrust vector of PU 16 and/or PU 44 in the positive x-direction, or the direction perpendicular to the z-axis of the body frame, is increased, i.e. more positive or less negative. Concurrently, or alternatively, in a configuration in which the net thrust vector of the rear PU assembly has a non-zero component perpendicular to the x-axis of the body frame, the rear PU assembly comprising PUs 30 and 44 can be rotated via the support strut mounting 58 in a positive or negative sense about the x-axis of the body frame, such that the net thrust vector of the rear PU assembly can have a larger, i.e. a less negative or more positive, component in a positive y-direction or a direction perpendicular to the z-axis of the body frame. The aforementioned set of configurations in which the net thrust vector of the rear PU assembly has a non-zero component perpendicular to the x-axis of the body frame can comprise a configuration between a cruise configuration and a pre-cruise configuration, but does not include a pre-cruise configuration, and does not include a cruise configuration, but can comprise a configuration between a hover configuration and a pre-cruise configuration, or comprise a PU assisted flight configuration, for example. Concurrently, or alternatively, in a configuration in which the support shafts 38 and 52 are not parallel to the xy-plane of the body frame, the rear PU 30 and/or rear PU 44 can be rotated in a positive or negative sense about the axis of rotation parallel to the support shafts 38 or 52, respectively, such that the thrust vector of the PU can have a larger, i.e. a less negative or more positive, component in a positive y-direction or a direction perpendicular to the z-axis of the body frame. The aforementioned set of configurations in which the support shafts 38 and 52 are not parallel to the xy-plane of the body frame can comprise any configuration between a cruise configuration and a pre-cruise configuration, without including a pre-cruise configuration, for example. The aforementioned set of configurations in which the support shafts 38 and 52 are not parallel to the xy-plane of the body frame can comprise any configuration in which the roll angle of the rear PU assembly is non-zero relative to the hover configuration. The aforementioned components of the thrust forces perpendicular to the z-axis of the body frame can lead to an imbalance in the yawing moments generated by the thrust vectors of all PUs, as well as the aerodynamic loads on the wing and fuselage, about the z-axis of the body frame and about the center of mass of the aircraft, which can lead to a net negative yawing moment about the z-axis of the body frame in the aforementioned examples. A positive yawing moment can be generated by applying the same principles. In this simplified example, the magnitudes of the thrust vectors of the PUs remain substantially unchanged during the change in the orientation of the PUs. In other modes of operation, the magnitudes of the thrust vectors of the PUs can be increased or decreased. As mentioned, other methods for yaw control discussed in the context of hovering flight can also be employed during PU assisted flight.

The aerodynamic loads on the ducts of the PUs can also be employed to contribute to the yaw control of the aircraft during PU assisted flight, pre-cruise, or cruise, for example. As mentioned, the ducts of the front PUs 2 and 16 can be employed in a similar manner as the canard control surfaces on the Eurofighter Typhoon jet aircraft. Changing the angle of attack of the ducts of the front PUs 2 and/or 16 relative to the local free stream flow during forward flight can modify the drag force acting on the PUs, where the drag force can comprise induced drag or viscous drag components. The angle of attack of the front PUs 2 and 16 can be modified by rotating them about their support shafts 10 or 24, for example. The angle of attack of the PUs can also be modified by changing the attitude of the fuselage and thus changing the orientation of the fuselage relative to the free stream flow. The angle of attack of the PUs can also be modified by changing the speed of the aircraft, for example. The change in the angle of attack of a front PUs 2 or 16 can change the magnitude and/or direction of the net aerodynamic force acting on the PUs 2 and 16, and can modify the component of the net aerodynamic force on a PU in a direction perpendicular to the z-axis of the body frame. For example, the component of the lift and/or drag force of a duct of a front PU in the negative x-direction, i.e. a direction perpendicular to the z-axis of the body frame, can increase due to an increase in the angle of attack of a PU relative to the local free stream flow of the PU relative to a nominal cruise or pre-cruise scenario. Since this force is offset relative to the center of mass of the aircraft, this force can be employed to contribute to a net yawing moment about the z-axis of the body frame. In effect, the ducts can be employed as annular wings, circular wings, or closed wings, and their lift and drag force can be modified by changing their angle of attack relative to the local free stream flow. The ducts of the rear PUs 30 and 44 in a pre-cruise configuration can be employed in a similar manner as the ducts of front PUs 2 and 16 described above. Thus, even in the case in which the front PUs are in a feathered configuration, i.e. producing a negligible amount of thrust, the front PUs can be employed to contribute to yaw control of the aircraft.

In a configuration in which the support shafts 38 and 52 are not parallel to the xy-plane of the body frame, the rear PU 30 and/or rear PU 44 can be rotated in a positive or negative sense about the axis of rotation parallel to the support shafts 38 or 52, respectively, such that the aerodynamic net force acting on rear PU 30 and/or rear PU 44 can have a non-zero component in a direction perpendicular to the z-axis of the body frame. Since this force is offset relative to the center of mass of the aircraft, this force can be employed to contribute to a net yawing moment about the z-axis of the body frame. The aforementioned set of configurations in which the support shafts 38 and 52 are not parallel to the xy-plane of the body frame can comprise any configuration between a cruise configuration and a pre-cruise configuration, without including a pre-cruise configuration, for example. The aforementioned set of configurations in which the support shafts 38 and 52 are not parallel to the xy-plane of the body frame can comprise any configuration in which the roll angle of the rear PU assembly is non-zero relative to the hover configuration. As mentioned, the ducts of the rear PUs 30 and 44 in a cruise configuration can be employed in a similar manner as the rudderons on an aircraft, i.e. used for yaw control and roll control. The ducts of the rear PUs 30 and 44 in a cruise configuration can be used for yaw control by being deflected or rotated in the same direction about support shafts 38 and 52 relative to a nominal cruise scenario, for example.

Yaw control can also be facilitated by changing the thrust magnitude acting on each PU during PU assisted flight, pre-cruise flight, cruising flight, or any configuration in between. As described in the context of pitch or roll control in a hover or PU assisted flight configuration, the thrust magnitude of PUs on opposite sides can be modified in order to generate a yawing moment. For example, in a nominal cruise configuration shown in FIGS. 4-6, the thrust of PU 16 in the positive x-direction can be reduced, i.e. made smaller or more negative, and/or the thrust magnitude of PU 2 can be increased. This can contribute to a net positive yawing moment about the z-axis of the body frame. Note that a negative thrust, or a thrust directed in a downstream direction, i.e. a thrust with a non-zero component in the negative x-direction, can be generated by operating a PU as a wind turbine, as described in the context of autorotation, for instance. A negative yawing moment can be generated by reducing the thrust magnitude of PU 2 and/or increasing the thrust magnitude of PU 16, for example. Similarly, in a PU assisted flight configuration, or in a pre-cruise configuration, the thrust magnitude of PU 44 can be reduced and/or the thrust magnitude of PU 30 can be increased. This can contribute to a net positive yawing moment about the z-axis of the body frame. A negative yawing moment can be generated by reducing the thrust magnitude of PU 30 and/or increasing the thrust magnitude of PU 44, for example. An increase or decrease of the thrust magnitude of the front and/or rear PUs can thus be employed to contribute to a net positive or negative yawing moment about the center of mass of the aircraft, and thus be used to facilitate yaw control, i.e. achieve a desired yaw angle.

Other modes of operation for changing the yaw angle of the aircraft in a cruise configuration, in a PU assisted flight configuration, or in a pre-cruise configuration, are known to those with ordinary skill in the art and can also be employed. For example, the left wing 91 can be extended to a different extent compared to the right wing 97. For instance, the left wing 91 can be in a cruise configuration shown in FIGS. 4-6, while the right wing is in a hover or storage configuration shown in FIGS. 1-3, or a configuration between a storage configuration and a cruise configuration. The center of pressure of the drag force on the left wing 91 can act over a longer moment arm, i.e. a larger distance relative to the center of mass, than the center of pressure of the drag force on the right wing 97. This can contribute to a negative yawing moment about the z-axis of the body frame and the center of mass. In some embodiments, the wing can be configured in a manner in which the control surfaces on the wings can be employed for yaw control. For example, the left outer wing section 92 can be rotated by ninety degrees downwards about joint 95, i.e. in a negative sense about a direction vector parallel to joint 95 and directed in the positive x-direction, relative to the cruise configuration shown in FIGS. 4-6, while the left middle section 93 remains in its cruise configuration. Similarly, the right outer wing section 98 can be rotated by ninety degrees downwards about joint 101, i.e. in a positive sense about a direction vector parallel to joint 101 and directed in the positive x-direction, relative to the cruise configuration shown in FIGS. 4-6. In this configuration, during forward flight, the ailerons mounted at the trailing edge of the left outer wing segment 92 and/or the ailerons mounted at the trailing edge of the right outer wing segment 98 can be used for yaw control. Since the left outer wing segment 92 or the right outer wing segment 98 are now substantially parallel to the z-axis of the body frame, the ailerons of these wing segments can be operated in a similar manner as the rudder of a conventional aircraft. For instance, the aileron on the left outer wing segment 92 and/or the right outer wing segment 98 can be rotated about their support mounts in the positive sense about the z-axis, which can increase the component of the net aerodynamic force on the left outer wing segment 92 and/or the right outer wing segment 98 in the positive y-direction, i.e. lead to a smaller component in the negative y-direction and/or a larger component in the positive y-direction, or a direction perpendicular to the z-axis of the body frame. Due to the wing sweep, this net aerodynamic force can be offset relative to the center of mass of the vehicle, and thus contribute to a net negative yawing moment about the z-axis of the body frame. A net negative yawing moment can be generated using similar principles. The yawing moments can be employed to contribute to yaw control. Note that in some such embodiments the joint axes of joints 95 and/or 101 can be substantially parallel to the x-axis, or substantially lie in the xz-plane of the body frame. In some embodiments a flywheel or an otherwise available rotational inertia, such as the rotational inertia of an engine, or the rotational inertia of an individual PU and its associated rotating components, can be employed to change the yaw angle of an aircraft. Gyroscopic effects, such as those associated with the angular momentum of the PUs or an engine or a flywheel, can also be employed for yaw control. A wide variety of such methods are known in the art. These and other methods for yaw control can also be applied to other modes of operation, such as climbing flight.

Note the similarity between the cruise configuration shown in FIG. 5 and the hover configuration shown in FIG. 3. Methods of roll and/or pitch control in a hover configuration can be employed for yaw and/or pitch control in cruise or pre-cruise. Methods for yaw control in hover can be employed for roll control in cruise or pre-cruise. Similar analogies also apply to PU assisted flight.

In some embodiments, the aircraft can be configured to be able to maintain altitude while only being powered by a single front PU, such as PU 2 or PU 16. For example, in one such scenario, the thrust of PUs 16, 30, and 44 can be zero, or substantially zero, and the thrust of PU 2 can be the value required to maintain altitude. Altitude can be maintained in several ways. For instance, the thrust of PU 2 can be employed to cancel the drag force acting on the vehicle during wing borne flight of substantially constant, or non-decreasing, altitude. In this configuration, the aerodynamic lift force on the wing is employed to cancel the majority, or at least a large portion, of the weight force acting on the vehicle, and the majority of the aerodynamic drag force acting on the vehicle can be cancelled by the thrust of PU 2. In some such embodiments, the flight or trajectory of the aircraft can also be in a straight line. Since the thrust vector of PU 2 in a cruise configuration has a non-zero component in the positive y-direction, there is a positive yawing moment produced by PU 2 about the center of mass of the vehicle and the z-axis of the body frame. This yawing moment can be cancelled by an opposite yawing moment generated by rotating the ducts of the rear PU assembly comprising PUs 30 and 44 relative to the local free stream flow such that the ducts of the rear PU assembly have a non-zero angle of attack relative to the local free stream flow. The resulting aerodynamic loads on the rear PU assembly can be configured to cancel the yawing moment due to the thrust of PU 2 and any other sources of yawing moment, such that there is a zero net yawing moment. Other methods, such as methods discussed in the context of yaw control, can also be employed to generate a negative yawing moment to at least partially cancel the positive yawing moment of PU 2 in a cruise configuration. Similarly, the aircraft can be trimmed such that there is a zero pitching and rolling moment. In the resulting constant altitude, straight cruising configuration powered by a single front PU, such as PU 2, the aircraft can have a non-zero sideslip angle. Another way in which altitude can be maintained or increased during wing borne flight with thrust from a single front PU, such as front PU 2, is in circular flight. At least a portion of the yaw moment generated by the thrust of PU 2 about the center of mass of the vehicle can be employed to rotate the vehicle about its yaw axis at a constant rate, where the desired rate of rotation can match the motion of the vehicle along its circular trajectory in level flight in a coordinated turn, for example. In some such modes of operation, the rear PU assembly can also be employed to set the magnitude of the net yawing moment to a desired value, where the net yawing moment comprises the positive yawing moment generated by the thrust of PU 2 about the center of mass of the vehicle. As described above, the orientation of the rear PU assembly relative to the aircraft and relative to the local free stream flow can be used to regulate the magnitude and direction of the net aerodynamic loads on the rear PU assembly, which can be configured to generate a desired net yawing moment. Another way in which altitude can be maintained or increased with thrust from a single front PU, such as front PU 2 or front PU 16, is in PU assisted flight. In this flight mode, a majority, or a substantial portion, of the weight force of the vehicle can be cancelled by the thrust of the front PU, such as PU 2. In some embodiments, the motion of the aircraft in this flight mode can be oscillatory.

In some embodiments, the aircraft can be configured to be able to maintain altitude while only being powered by a single rear PU, such as PU 30 or PU 44. For example, in one such scenario, the thrust of PUs 2, 16, and 44 can be zero, or substantially zero, and the thrust of PU 30 can be the value required to maintain altitude. Altitude can be maintained in several ways. For instance, the aircraft can be in a cruise configuration. The thrust of PU 30 can be employed to cancel the drag force acting on the vehicle during wing borne flight of substantially constant, or non-decreasing, altitude. In this configuration, the aerodynamic lift force on the wing is employed to cancel the majority, or at least a large portion, of the weight force acting on the vehicle, and the majority of the aerodynamic drag force acting on the vehicle can be cancelled by the thrust of PU 30. In some such embodiments, the flight or trajectory of the aircraft can also be in a straight line. Since the thrust vector of PU 30 in a cruise configuration has a non-zero component in the negative z-direction, there is a negative pitching moment produced by PU 30 about the center of mass of the vehicle. This pitching moment can be cancelled by an opposite pitching moment generated by rotating the ducts of the front PU 2 and/or PU 16 relative to the local free stream flow such that the ducts have a non-zero angle of attack relative to the local free stream flow. The resulting aerodynamic loads on the PU can be configured to cancel the pitching moment due to the thrust of PU 30 and any other sources of pitching moment, such that there is a zero net pitching moment. For instance, the aerodynamic loads on the front PUs can have a non-zero component in the negative z-direction. Other methods, such as methods discussed in the context of pitch control, can also be employed to generate a positive pitching moment to at least partially cancel the negative pitching moment of PU 30 in a cruise configuration. Similarly, the aircraft can be trimmed such that there is a zero yawing and rolling moment. A constant altitude, straight cruising configuration powered by a single rear PU, such as PU 30, can thus be facilitated.

In another example, the aircraft can be in a pre-cruise configuration. The thrust of PU 30 can be employed to cancel the drag force acting on the vehicle during wing borne flight of substantially constant, or non-decreasing, altitude. In this configuration, the aerodynamic lift force on the wing can also be employed to cancel the majority, or at least a large portion, of the weight force acting on the vehicle, and the majority of the aerodynamic drag force acting on the vehicle can be cancelled by the thrust of PU 30. In some such embodiments, the flight or trajectory of the aircraft can also be in a straight line. Since the thrust vector of PU 30 in a pre-cruise configuration has a non-zero component in the negative y-direction, there is a positive yawing moment produced by PU 30 about the center of mass of the vehicle. This yawing moment can be cancelled by an opposite yawing moment generated by modifying the drag on the wings via split flaps or spoilers, for example, as discussed in the context of yaw control. The yawing moment can alternatively or concurrently be cancelled by modifying the drag on the other PUs, such as PU 2. For example, PU 16 and 44 can be feathered to produce a small or negligible amount of drag, while PU 2 can be configured to decelerate the fluid. The deceleration can comprise the PU 2 being operated as a wind turbine in the local free stream flow, as described in the context of autorotation. The deceleration of fluid can also comprise the PU 2 being rotated to generate a non-zero angle of attack of the duct of PU 2 relative to the local free stream flow. The resulting aerodynamic forces on PU 2, which can comprise viscous drag forces as well as induced drag forces, along the negative x-direction can be combined to generate a negative yawing moment, for example. Other methods, such as methods discussed in the context of yaw control, can also be employed to generate a negative yawing moment. The negative yawing moment can be employed to at least partially cancel the positive yawing moment generated by the thrust of PU 30 in a pre-cruise configuration. Similarly, the aircraft can be trimmed such that there is a zero pitching and rolling moment. A constant altitude, straight cruising configuration powered by a single rear PU, such as PU 30, can thus be facilitated.

Another way in which altitude can be maintained or increased during wing borne flight with thrust from a single rear PU, such as rear PU 30, in a pre-cruise configuration, is in circular flight, as described above in the context of propulsion being provided by a single front PU. At least a portion of the yaw moment generated by the thrust of PU 30 about the center of mass of the vehicle can be employed to rotate the vehicle about its yaw axis at a constant rate, where the desired rate of rotation can match the motion of the vehicle along its circular trajectory in level flight in a coordinated turn, for example. Other methods, such as methods discussed in the context of yaw control, can also be employed to generate a desired net yawing moment and net rate of rotation in yaw for a horizontal circular flight in a coordinated turn of given radius.

Another way in which altitude can be maintained or increased with thrust from a single rear PU, such as rear PU 30 or rear PU 44, is in PU assisted flight. In this flight mode, a majority, or a substantial portion, of the weight force of the vehicle can be cancelled by the thrust of the rear PU, such as PU 30. In some embodiments, the motion of the aircraft in this flight mode can be oscillatory.

In some embodiments, the vehicle can be configured to be able to hover with only two PUs providing thrust, regardless of which two PUs are being used, to cancel the weight force on the vehicle. This increases the safety of the vehicle in the event of a failure of two PUs to provide sufficient thrust. The two PUs providing the thrust can comprise PU 2 and PU 44, or PU 16 and PU 30, or PU 2 and PU 16, or PU 30 and PU 44, or PU 2 and PU 30, or PU 16 and PU 44. The attitude control during hover, such as yaw, roll, and pitch control, can be facilitated using conventional control methods. For example, the vehicle control can employ the thrust magnitude of a PU, the thrust direction of a PU or the sign of the thrust of a PU, the aerodynamic torque acting on a rotor disc of a PU, the orientation of a PU relative to the aircraft, i.e. thrust and/or torque vectoring, and/or the orientation of a rear PU assembly, comprising PU 30 and 44 and support strut mounting 58, relative to the aircraft. For example, consider a scenario in which only a front PU and a rear PU, such as PU 2 and PU 44, have a non-zero thrust in hover, where the thrust of the other PUs is zero or negligible. Yaw control can be facilitated using the aerodynamic torque on the rotor discs, or changing the orientation of the PUs relative to the fuselage 121, i.e. via thrust vectoring, for example, as discussed in the context of yaw control with all four PUs operating nominally. Roll and pitch control can be facilitated by changing the thrust magnitude of one PU relative to another, and/or by changing the orientation of the PUs relative to the fuselage 121, i.e. via thrust vectoring. The control authority about the roll axis, i.e. about the x-axis of the body frame, can be increased by exploiting coupling between yaw control and pitch control in some cases. For example, to achieve a desired roll attitude from a nominal hover attitude, the vehicle can undergo a non-zero yaw angle rotation about the z-axis of the body frame, and subsequently, or concurrently, a non-zero pitch angle rotation about the y-axis of the body frame, and subsequently a non-zero yaw angle rotation about the z-axis of the body frame. As a result, the vehicle can experience a net non-zero roll angle rotation compared to the initial hover attitude. The control authority about the roll axis can concurrently, or alternatively, be increased by rotating PU 30 and/or PU 2 such that the thrust vector of the PU, and the associated aerodynamic torque vector, is not parallel to the z-axis of the body frame. As a result, the aerodynamic torque vectors of at least one PU can have a non-zero component parallel to the x-axis of the body frame, i.e. along the roll axis, and can be employed to contribute to a positive or negative rolling moment. By increasing or decreasing the magnitude of the thrust of a PU, the magnitude of the aerodynamic torque can be modified, which can modify the component of the torque vector in the positive or negative direction along the x-axis of the body frame, and thus be used to modify the net rolling moment on the aircraft and contribute to roll control. Other methods, such as methods discussed in the context of nominal yaw, pitch, and roll control, can also be employed to generate a desired net yawing, pitching, or rolling moment and a net rate of rotation in yaw, pitch, or roll in the aforementioned scenario in which only a front PU and a rear PU, such as PU 2 and PU 44, have a non-zero thrust in hover.

In another example, consider a scenario in which only a front PU and a rear PU, such as PU 30 and PU 2, have a non-zero thrust in hover, where the thrust of the other PUs is zero or negligible. In such a scenario, it can be advantageous for the rear PU assembly, comprising rear PUs 30 and 44, to be rotated by 180 degrees about the x-axis of the body frame relative to the hover configuration shown in FIGS. 1-3, and for the thrust of PU 30 to be reversed relative to the hover configuration. The thrust can be reversed by changing the pitch angle, and hence the angle of attack, of the rotor blades within PU 30, for example. In this configuration, the thrust of PU 2 and PU 30 has a non-zero component in the negative z-direction, i.e. in the direction opposite the direction of the acceleration due to gravity and the weight force on the aircraft in a hover scenario. Note that this scenario is similar to the aforementioned scenario in which only PU 44 and PU 2 have a non-zero thrust magnitude. The attitude control, i.e. the control of the roll, pitch, and yaw angles, can employ the same principles as outlined in the aforementioned scenario.

In another example, consider a scenario in which only both front PUs, PU 2 and PU 16, have a non-zero thrust in hover, where the thrust of the other PUs is zero or negligible. In this scenario, the vehicle can hover substantially vertically, such that the weight force is directed substantially in the negative x-direction of the body frame. The front PUs can be in a cruise configuration, i.e. with their thrust vectors being located substantially in the xy-plane of the body frame and directed in the positive x-direction, and with their thrust being configured to substantially cancel the weight force of the vehicle in the hover scenario. Yaw control can be facilitated by changing the magnitude of the thrust forces of the two front PUs relative to each other, or by rotating the two front PUs about their support shafts, such as support shafts 10 or 24. The rotation of the PUs relative to the fuselage, or the modification of the thrust magnitude of a PU can change the component of the thrust of a PU along the x-direction, or perpendicular to the z-axis of the body frame, which can modify or regulate the net yawing moment about the center of mass of the vehicle. Roll control can be facilitated by modifying the magnitude of the aerodynamic torque acting on PU 16 relative to PU 2, such that a net aerodynamic torque can be generated, and such that a net rolling moment can be produced. As mentioned, the aerodynamic torque of a PU can be modified by changing the thrust of a PU, for example. Roll control can also be facilitated by rotating the two front PUs about their support shafts, such as support shafts 10 or 24. The rotation of the PUs relative to the fuselage can change the component of the thrust of a PU along the positive or negative z-direction, or perpendicular to the x-axis of the body frame, which can modify or regulate the net rolling moment about the center of mass of the vehicle. For example, PU 2 can be rotated in a positive sense about a direction vector directed away from the fuselage and parallel to the axis of rotation, i.e. support shaft 10 in this embodiment, while PU 16 can be rotated in a positive sense about a direction vector directed away from the fuselage and parallel to the axis of rotation, i.e. support shaft 16 in this embodiment, where both rotations are relative to the configuration of the front PUs in the cruise configuration shown in FIGS. 4-6. The rotation can lead to a non-zero thrust component in a direction perpendicular to the x-axis of the aircraft, and lead to a net negative rolling moment, which can be employed for roll control. Pitch control can comprise rotating the two front PUs about their support shafts, such as support shafts 10 or 24. The rotation of the PUs relative to the fuselage can change the component of the thrust of a PU along the positive or negative z-direction, or perpendicular to the y-axis of the body frame, which can modify or regulate the net pitching moment about the center of mass of the vehicle. For example, PU 2 can be rotated in a positive sense about a direction vector directed away from the fuselage and parallel to the axis of rotation, i.e. support shaft 10 in this embodiment, while PU 16 can be rotated in a negative sense about a direction vector directed away from the fuselage and parallel to the axis of rotation, i.e. support shaft 16 in this embodiment, where both rotations are relative to the configuration of the front PUs in the cruise configuration shown in FIGS. 4-6. The rotation can lead to a non-zero thrust component in a direction perpendicular to the y-axis of the aircraft, and lead to a net negative pitching moment, which can be employed for pitch control. Alternatively, the vehicle can be oriented vertically with a nose down attitude, i.e. such that the weight force is directed substantially in the positive x-direction of the body frame, instead of a tail down attitude. The principles of attitude control in this case are similar to the case discussed above.

In another example, consider a scenario in which only both rear PUs, PU 30 and PU 44, have a non-zero thrust in hover, where the thrust of the other PUs is zero or negligible. In this scenario, the vehicle can hover substantially vertically, such that the weight force is directed substantially in the negative x-direction of the body frame. The principles of attitude control in this case are similar to the case discussed above in the context of two front PUs providing the majority of the thrust. Alternatively, the vehicle can be oriented vertically with a nose down attitude, i.e. such that the weight force is directed substantially in the positive x-direction of the body frame, instead of a tail down attitude. The principles of attitude control in this case are also similar to the case discussed above.

In some embodiments, the vehicle can be configured to be able to hover with only three PUs providing thrust, regardless of which PUs are being used, to generate thrust and cancel the weight force on the vehicle. This increases the safety of the vehicle in the event of a failure of one PU to provide sufficient thrust.

For example, consider the case in which PU 2, PU 16, and PU 44 have a non-zero thrust in hover, where the thrust of the other PUs is zero or negligible. Attitude control can employ the same principles outlined above in the context of only two PUs providing thrust, such as PU 2 and PU 44. In this case, PU 16 can be employed to assist in attitude control. To that end, it can be advantageous for PU 16, and the other three PUs, to be configured to be able to produce positive and negative thrust, i.e. thrust with a non-zero component in the negative or positive z-direction, respectively, while in the hover configuration shown in FIGS. 1-3. The thrust can be reversed by changing the pitch angle, and hence the angle of attack, of the rotor blades within PU 16, for example. A positive thrust of PU 16 can be employed to generate a negative rolling moment, for example, while a negative thrust of PU 16 can be employed to generate a positive rolling moment. A positive thrust of PU 16 can also be employed to generate a positive pitching moment, for example, while a reduced positive thrust, or a negative thrust of PU 16 can be employed to generate a negative pitching moment. Other methods, such as methods discussed in the context of nominal yaw, pitch, and roll control, can also be employed to generate a desired net yawing, pitching, or rolling moment and a net rate of rotation in yaw, pitch, or roll and facilitate attitude control.

The case in which two rear PUs and one front PU have a non-zero thrust in hover, where the thrust of the other PUs is zero or negligible, is similar to the aforementioned case, and will not be discussed in more detail.

Some example embodiments can also comprise a conventional tail assembly, or empennage, with separate tail surfaces such as a vertical stabilizer and a rudder, a horizontal stabilized and an elevator. Some embodiments can also comprise a V-tail, or a Y-tail, or an X-tail. In some embodiments the tail surfaces, such as the horizontal or vertical stabilizer or the two tail surfaces of the V-tail, can be mounted on the support strut mounting 58.

In some embodiments a wing can also comprise winglets. In some cases the winglets can be folded, similar to the winglets, or outer wing segments, on the Boeing 777X. The winglets can be employed for lateral stability. In some embodiments the winglets comprise control surfaces at the trailing edges. These control surfaces can be employed for yaw control while in a configuration in which the winglets are oriented at a non-zero angle relative to the remainder of the wing, where the axis of rotation is substantially parallel to the local free stream flow in cruise. The non-zero angle can be 90 degrees or 45 degrees, for example. Otherwise, or concurrently, the control surfaces at the trailing edges of the winglets can be employed as conventional ailerons for roll control.

Some example embodiments can also comprise conventional canard control surfaces. These canard control surfaces can be fixed, as is the case on the Piaggio P.180 Avanti. In some embodiments, the canard control surfaces can rotate, as is the case for the Eurofighter Typhoon. In some embodiments, the canard control surfaces can be mounted on the ducts of front PUs 2 and 16. The canard control surfaces can be rigidly mounted to the ducts of front PUs 2 and 16. In some such embodiment, the orientation of the canard control surfaces relative to the front PUs 2 and 16 can be configured to yield the desired angle of attack of the canard during cruising flight, i.e. the configuration shown in FIGS. 4-6. The canard control surfaces can be rotably mounted to the ducts of front PUs 2 and 16. In some such embodiments, the orientation of the canard control surfaces can be modified relative to the front PUs 2 and 16 such that the angle of attack of the canards can be modified relative to the local free stream flow during cruise, pre-cruise, PU assisted flight, or forward flight in general.

The vehicle 1 comprises a front landing gear 108 and a rear left landing gear 114 and a rear right landing gear. The front landing gear 108 comprises a left wheel 109, a right wheel 110, horizontal support strut 111, and a vertical support strut 112. The front landing gear can be rotated by an actuator about the support strut 112 about an axis parallel to the z-axis of the body frame in order to facilitate the steering of the aircraft while taxiing on the ground. The front landing gear is thus configured in a similar manner as the front landing gear of conventional commercial transports, such as the Boeing 737. In other embodiments, the front landing gear can swivel freely, i.e. without being actuated by a steering actuator, and steering can be accomplished by differential braking of the rear landing gear wheels. In other embodiments, the front landing gear can also comprise only one wheel. The rear landing gears comprise a support strut, such as support strut 116 or 119 and a wheel, such as wheel 115 or wheel 118. In other embodiments each rear landing gear can also comprise two wheels instead of one wheel. This can add redundancy and reduce the load on a single wheel, which can improve the safety of the aircraft during landings or during taxiing. In some embodiments the wheels of the rear landing gears can also be rotated about an axis parallel to the z-axis of the body frame. In other words, the rear landing gears can also be steered individually, similar to the rear wheel steering on some automobiles. This can improve the maneuverability of the aircraft while taxiing on the ground and while parking in constrained parking spots, such as a conventional automobile garage.

In some embodiments, at least one wheel of the front or rear landing gears are powered by a torque apparatus. The torque apparatus can comprise an electric motor mounted at the hub of a wheel, for example. In some embodiments, electric motors are mounted adjacent to, or within the hubs, of all four landing gear wheels. In some embodiments, only the front wheels, or only the rear wheels, are powered by electric motors. The torque apparatus can also comprise an electric motor mounted in the fuselage and a drive train configured to transfer the torque from the electric motor to the respective landing gear wheel. The drive train can comprise a chain and sprockets, similar to the drive train of a conventional motorcycle. The drive train can also comprise a drive shaft which passes through the support strut of the landing gear, or adjacent to the support strut of the landing gear, and provides torque to the wheels via a bevel gear. The torque apparatus can also comprise a different type of motor, such as a turboshaft engine or a reciprocating engine, which is employed to generate the torque to power the drive train. In some embodiments, at least one landing gear wheel is mechanically coupled to a main engine, such as a turboshaft engine, via a clutch. In this manner at least one landing gear wheel can be powered by a main engine during taxiing on the ground, and uncoupled from the main engine when the aircraft is in storage, when the aircraft is parked, or when the aircraft is no longer on the ground, such as in a hover configuration, a climb configuration, or a cruise configuration, or a configuration in which the respective landing gear is stored within the fuselage. In some embodiments, not a single landing gear wheel is propelled separately by a torque generating apparatus. In such embodiments the PUs, such as the front PUs 2 and 16, or the rear PUs 30 and 44, are employed to provide the thrust required to propel the aircraft while taxiing on the ground. The PUs can be rotated about their support shafts, such as support shaft 10, 24, 38, or 52 in a manner in which the net thrust vector of a PU also has a component in the positive or negative x-direction of the body frame of the aircraft. Thus the net thrust of a PU can be employed to provide a forward or backward force on the aircraft, which can propel it forwards or backwards while taxiing on the ground.

In other embodiments, the front landing gear can comprise two separate landing gear apparatuses, similar to the front landing gear of the Boeing B-52 or the Antonov An-225. These separate landing gear apparatuses can comprise two wheels each, as is the case in the aforementioned examples. In other embodiments, these separate landing gear apparatuses can comprise a single wheel each. The separate landing gear apparatuses can be individually steered, or rotated about an axis substantially parallel to the z-axis of the body frame. Employing two separate front landing gears instead of a single front landing gear can improve the lateral stability of the aircraft while taxiing on the ground.

In some such embodiments, a drive shaft passes from an engine or motor at the rear of the aircraft through the fuselage 121 along the bottom of the fuselage 121 to the front of the aircraft between the two front landing gears and their respective landing gear compartments to the front of the aircraft to power the two PUs located there, i.e. PUs 2 and 16. Such a drive shaft can comprise several constant velocity joints in order to allow the drive shaft to approximately follow the curvature of the bottom of the fuselage 121 between the rear of the fuselage and the front of the fuselage.

In some embodiments, the ride height of the fuselage, i.e. the smallest distance of separation between the fuselage 121 and the level ground 120, can be modified. For instance, the ride height can be reduced relative to the ride height shown in FIG. 1 by rotating the rear landing gears, such as rear landing gear 114, backwards by a desired amount, such that the rear landing gear wheels, such as rear landing gear wheel 115, are moved in the negative x-direction and the negative z-direction of the body frame. Concurrently, or alternatively, the front landing gear 108 can be rotated forwards by a desired amount, such that the front landing gear wheels, such as front landing gear wheel 109, are moved in the positive x-direction and the negative z-direction of the body frame. The ride height can also be reduced by shortening the support strut of the front landing gear, such as support strut 112, and/or shortening the support strut of the rear landing gear, such as support strut 116. The length of a support strut can be reduced by allowing one portion of a support strut to slide into another in telescoping fashion, for example. In some such ride height modifications, the rotating of the front landing gear 108 and the rear landing gears can be coordinated such that the fuselage remains substantially horizontal, i.e. such that the x-axis of the body frame remains within a plane parallel to the nominal ground plane 120. The reduction of the ride height can be employed to reduce the total height of the aircraft while taxiing on the ground. The total height is the maximum distance of separation between a portion of the aircraft 121 and the ground. Reducing the total height can be beneficial during parking of the aircraft, such as the parking of the aircraft in a conventional automobile parking garage or a conventional residential automobile garage.

The ride height of the aircraft can also be increased relative to the configuration shown in FIG. 1. The ride height can be increased by the aforementioned principles and methods, such as rotating the support shafts, such as support shafts 112 or 116, or changing the length of a support shaft, for example. The ride height can be increased to allow the aircraft to assume the cruise configuration shown in FIGS. 4-6 while located on the ground, for example. This can be useful for testing or maintenance of the rear PU assembly, for example.

The front landing gear apparatus 108 can comprise a shock strut. The rear landing gear apparatus, such as left rear landing gear apparatus 114, can also comprise a shock strut. In some embodiments, a landing gear apparatus can comprise a spring and dampener.

The front and rear landing gears can be retracted into the fuselage 121 in this embodiment 1. The front landing gear 108 can be rotated in a positive sense about a direction vector substantially parallel to the y-axis of the body frame and directed in the positive y-direction during retraction. The landing gear bay doors of the front and rear landing gears are not shown in the figures for clarity. In the stored configuration the front landing gear is located within the fuselage, as shown in FIGS. 4-6. In other embodiments, the front landing gear 108 can be rotated in a negative sense about a direction vector substantially parallel to the y-axis of the body frame and directed in the positive y-direction during retraction. In some embodiments, the front landing gear 108 can be located further forward, i.e. at a location in the positive x-direction relative to the location shown in FIG. 1. In some embodiments, the front landing gear 108 can be located further backwards, i.e. at a location in the negative x-direction relative to the location shown in FIG. 1. The rear left landing gear 114 can be rotated in a forward direction, i.e. with the rear wheel 115 moving in the positive x-direction, during the retraction into the fuselage. The rear right landing gear can be retracted in similar fashion. In the stored configuration the left and right rear landing gears are located within the fuselage, as shown in FIGS. 4-6. In other embodiments, the rear landing gear can be rotated in a backward direction, i.e. with the rear wheel 115 moving in the negative x-direction, during the retraction into the fuselage. In some embodiments, the rear landing gear can be located further forward, i.e. at a location in the positive x-direction relative to the location shown in FIG. 1. In some embodiments, the rear landing gear can be located further backward, i.e. at a location in the negative x-direction relative to the location shown in FIG. 1.

Aircraft 1 shown in the figures is configured to carry six passengers, as shown via the dashed outlines of passengers 64, 65, 66, 67, 68, and 69. In other embodiments the passengers can be located at different locations within the aircraft fuselage 121 or in different orientations or in different poses. The passenger locations, orientations, and poses shown in the figures are provided only as an example and a reference and are not intended to limit the scope of the invention. The outlines of the passenger seats are not shown for clarity. In some embodiments the seats can be reconfigured in a manner in which the passengers can lie down flat, as is the case for business or first class seats in conventional commercial transports. For example, in the front row, i.e. the row occupied by passengers 64 and 65, the lower leg rests of the seats can be rotated upwards and the back rests of the seats can be rotated downwards such that the passenger can assume a fully flat position when desired. In some embodiments the seats in the first row can also be translated in an upwards direction and a rearward to provide more space to the passengers in the second row when the seats in both the first and second row are in a fully flat position. Similarly, in the in the second row, i.e. the row occupied by passengers 66 and 67, the lower leg rests of the seats can be rotated upwards and the back rests of the seats can be rotated downwards such that the passenger can assume a fully flat position when desired. In some embodiments the upper leg rests of the seats in the second row can also be translated in a forward direction, together with the lower leg rests and back rests, in order to not enter into the space of the passengers in the third row when the passengers in the second row assume a fully flat position. In the third row, i.e. the row occupied by passengers 68 and 69, the upper leg rests can be translated downwards and forwards towards the front of the aircraft, and the lower leg rests can be rotated upwards and translated downwards and forwards, and the back rests can be rotated downwards and translated downwards and forwards. The seats in the third row can thus be reconfigured and partially placed below the seats in the second row in a fully flat configuration along the floor of the cabin, allowing passengers in the third row to also assume a fully flat position. In some embodiments the seats in the second row can also be translated in an upwards direction to provide more space to the passengers in the third row when in a fully flat position.

In some embodiments, a front seat, such as front seat 64 and/or 65, can be configured as a pilot's seat. The seat can comprise flight controls found on conventional aircraft, such as a joystick, a sidestick, or a yoke. The seat can also comprise access to flight instruments, such as flight instruments on a conventional aircraft. The seat can comprise access to any other features found in cockpit on a conventional aircraft, such a throttle or altitude control lever, trim wheels, flap controls, engine controls, or radios. The aircraft can be configured to employ a fly-by-wire controls. In some embodiments, the aircraft can also comprise mechanical controls, which can comprise hydraulic controls, push-pull tubes, and/or a system of cables and pulleys.

In some embodiments a seat, such as the rear left seat 68 or the rear right seat 69, can be replaced by a restroom or a toilet for long haul flights. The toilet can be configured to be able to be used in flight. In some embodiments, a seat can be replaced by a galley or kitchen. In some embodiments a seat can be replaced by a shower. In some embodiments at seat can be replaced by a storage area, where cargo can be stored. In some embodiments, cargo can also be stored in overhead compartments above the second row and the third row of seats.

Passengers in the first row can enter their seats by entering through one of the doors, sliding their seat backwards in the negative x-direction of the body frame along rails, and climbing onto their seat via a small ladder or a foot support, and sliding their seat forward again along the same rails. In other embodiments, passengers in the first row can fold the backrest of their seat backwards and downwards, climb onto the backrest via a small ladder or foot support, slide forward on their seat, and rotate the backrest upwards again. In some embodiments, passengers in the first row can enter their seat by climbing between the two front seats via a small ladder or foot support, moving between the two front seats, and sliding onto their respective seats. In other embodiments, passengers in the first row can enter their seat by rotating their seat about an axis parallel to the z-axis of the body frame, climbing onto their seat via a small ladder or a foot support, and rotating their seat back to its original position. A wide variety of other methods are available for passengers in the first row for reaching their seats.

In other embodiments other seating configurations can be employed. For example, the seats can be arranged such that the passengers in the second row face towards the rear of the aircraft while the passengers in the third row face towards the front of the aircraft as before, such that the passengers in the second and third row face each other. In other embodiments the seats can be arranged such that the passengers in the second row and the third row have their backs against the outside wall of the fuselage 121 and are facing inwards, with the two passengers in each row on opposing side walls of the fuselage facing each other.

In some embodiments, there can be three or four seats in the second row comprising seats 66 and 67. In some embodiments there can be three seats in the third row comprising seats 68 and 69. In some embodiments there can be three seats in the first row comprising seats 64 and 65. In some such embodiments, a portion of the seats can be children's seats, which can be smaller than adult seats.

In some embodiments, the length of the aircraft from tip 61 to tail 62 can be around 5.40 meters. In some embodiments, the nominal maximum height of the aircraft above the ground can be around 1.97 meters in a stored or hover configuration. In some embodiments, the width of the aircraft fuselage can be around 1.57 meters. In some embodiments, the maximum width of the aircraft in a storage or hover configuration can be around 2.10 meters. In other embodiments, the aircraft can have other dimensions. In other embodiments, the maximum vertical dimension of the fuselage can be around 1.97 meters. In some embodiments, the length of the aircraft from tip 61 to tail 62 can be around 2.7 meters, while the width of the fuselage can be around 0.79 meters, the maximum width of the aircraft in a stored configuration can be around 1.05 meters, and the nominal maximum height of the aircraft above ground can be around 1.01 meters. In effect, such embodiments can be considered to be a scaled down version of the embodiment shown in the figures. During the scaling process, the proportions and relative sizes of the components of the aircraft can remain substantially unchanged relative to the embodiment shown in the figures. In some such embodiments, the aircraft can comprise a single seat, i.e. be configured to carry at least one passenger. Concurrently or alternatively the aircraft can be configured to carry cargo. The passenger can be located inside the cabin of the aircraft, where the cabin comprises the space occupied by the six passengers in the larger embodiment shown in the figures. In some embodiments, the passenger can enter and exit the cabin through the opened main window 63, where the window can be rotated about a hinge at the front, the rear, or the left or right side. Egress and ingress through an opened canopy or main window is well known in the art of fighter aircraft and sailplanes, for example. In some such embodiments the main window 63 can be larger, i.e. occupy a larger portion of the fuselage, than is the case for the embodiment shown in the figures. In some embodiments, the length of the aircraft from tip 61 to tail 62 can be around 3.6 meters, while the width of the fuselage can be around 1.05 meters, the maximum width of the aircraft in a stored configuration can be around 1.40 meters, and the nominal maximum height of the aircraft above ground can be around 1.35 meters. In effect, such embodiments can be considered to be a scaled down version of the embodiment shown in the figures. During the scaling process, the proportions and relative sizes of the components of the aircraft can remain substantially unchanged relative to the embodiment shown in the figures. In some such embodiments, the aircraft can comprise a single seat, i.e. be configured to carry at least one passenger. Concurrently or alternatively the aircraft can be configured to carry cargo. In some embodiments, the aircraft can also comprise a toilet or restroom which can be configured to be able to be used in flight. In some such embodiments, the aircraft can comprise a two seats, i.e. be configured to carry at least two passengers. Concurrently or alternatively the aircraft can be configured to carry cargo. In some such embodiments, the aircraft can comprise a three, four, or five seats. Concurrently or alternatively the aircraft can be configured to carry cargo. In some embodiments, the length of the aircraft from tip 61 to tail 62 can be around 0.8 meters, while the width of the fuselage can be around 0.23 meters, the maximum width of the aircraft in a stored configuration can be around 0.31 meters, and the nominal maximum height of the aircraft above ground can be around 0.3 meters. The aircraft can be configured to carry cargo, such as commercial goods, or food, for example. The aircraft can also be configured to carry a useful payload, such as communications equipment and/or cameras, for example.

In other embodiments, the aircraft can have different proportions compared to the proportions of the aircraft shown in the figures. For example, the ratio of the width of the fuselage to the length of the fuselage or the ratio of the height of the fuselage to the length of the fuselage can be different for other embodiments compared to the embodiment shown in the figures. In other embodiments the geometry or shape of the fuselage can be different compared to the shape of the fuselage shown in the figures.

In this particular embodiment the vehicle comprises four doors: first door 76, a second door located opposite to the first door on the right side of the aircraft, a third door 80, and a fourth door located opposite to the third door on the right side of the aircraft. The second door can be considered to be a mirror image of the first door 76 in the xz-plane of the body frame in some embodiments. The fourth door can be considered to be a mirror image of the third door 80 in the xz-plane of the body frame in some embodiments.

In some embodiments there are only two doors, one on each side of the fuselage, such as first door 76 and the second door. In some embodiments there is only one door, such as door 76. In such embodiments passengers in the third row can enter into the cabin through such a door, pass through the gap or the aisle between seat 66 and seat 67, and access their seat, such as seat 68 or seat 69.

In the exemplary embodiment 1 shown in the figures, all four doors are split doors, with the top portion rotating upwards and outwards, and the bottom portion rotating downwards and outwards. The rotation in both cases is about an axis substantially parallel to the x-axis of the body frame of the aircraft, where the axes of rotation are located at the top and bottom edges of the door frame. Stairs on the inside of the bottom portion facilitate an easy ingress and egress of the passengers into and out of the cabin of the aircraft. The cross-section of the doors projected onto the ground when opened, i.e. the ground footprint of the doors when opened is reduced by the doors being split into a top and bottom portion. This can reduce the footprint of the entire vehicle during loading or unloading of the aircraft with cargo or passengers, and allow the aircraft to be stored or parked in a smaller confined space compared to aircraft with other configurations.

In some embodiments the doors can consist of a single rigid component instead of being split into a top and bottom portion. In some such embodiments the doors can rotate upwards and outwards, about an axis substantially parallel to the x-axis of the body frame and located at the top edge of the door frame. In some such embodiments the doors can rotate downwards and outwards, about an axis substantially parallel to the x-axis of the body frame and located at the bottom edge of the door frame. Stairs on the inside portion of the door facilitate an easy ingress and egress of the passengers into and out of the cabin of the aircraft when the door is opened. In some embodiments the front doors, i.e. the first and second doors, can be moved outwards and forwards during opening. In some embodiments the front doors, i.e. the first and second doors, can be moved outwards and rearwards during opening. In some embodiments the front doors, i.e. the first and second doors, can be moved outwards and upwards during opening. In some embodiments the rear doors, i.e. the third and fourth doors, can be moved outwards and rearwards during opening. Note that in this case there can be interference with the folded wings of the aircraft in some embodiments. In some embodiments the rear doors can also be moved outwards and forwards during opening. Note that in this case the rear doors can prevent the front doors from opening, or partially block the front entrances. In some embodiments the rear doors can be moved outwards and upwards during opening. Note that in this case there can be interference with the wings or wing roots of the aircraft in some embodiments. In some embodiments the front doors or the rear doors can rotate outwards about an axis substantially parallel to the z-axis of the body frame of the aircraft while opening, where the axis of rotation is located at a front or rear side edge of the doorframe. In such a configuration the doors are opened or closed in a similar manner as conventional car doors. This type of configuration also benefits from a small volumetric footprint of the opened or opening doors.

The vehicle 1 shown in the figures comprises a main window 63. In this embodiment the window is configured in a similar fashion as the bubble canopy of a conventional fighter aircraft, such as the F-16. In some embodiments, the main window 63 can also be opened by rotating about a hinge at the rear edge of the window, as is the case for several conventional fighter aircraft, or a hinge at the front edge of the window. In such embodiments, a ladder or footholds on the side of the fuselage and on the outside of the fuselage below the main window 63 allow the passengers in the front seats to ingress and egress into and out of the fuselage. Passengers in the front row can access their seats by using the ladder, or using the footholds, to climb up the outside of the fuselage and onto their seats.

In other embodiments, the main window 63 can be configured in a similar manner as conventional cockpit windows on a commercial transport, such as a Boeing 737. In some embodiments, the main window 63 can comprise several individual window panels which are supported by support structures. In some embodiments the window panels can be curved.

Each door also features a window, such as window 77. The fuselage also contains four windows, such as window 86. In some embodiments, there are more than four windows in the fuselage. In some embodiments, there are less than four windows in the fuselage. The windows are configured to provide the passengers with a wide field of view outside of the fuselage. In some embodiments, such as embodiments configured to transport cargo, there are no windows in the fuselage.

In this embodiment the fuselage can be pressurized in order to allow the aircraft to fly at high altitude. In other embodiments the fuselage need not be able to be pressurized. The aircraft can also comprise an air conditioning system, an environmental control system, and/or a life support system in some embodiments. In the depicted embodiment, the interior fuselage, or the cabin, is tall enough at the center, i.e. between the first and second row of seats, and between the two seats in the second row, to allow passengers of below average, average, and above average height to stand up straight. This can improve passenger comfort on long haul flights.

A cantilever wing 90 is mounted on the shoulder of the aircraft. In some embodiments the wing is a high wing. In some embodiments the wing is a parasol wing. In some embodiments the wing is mounted on the bottom or the belly of the aircraft in a low wing configuration.

The wing comprises a left wing 91 and a right wing 97 with a left wing tip 106 and a right wing tip 107, respectively. The left wing 91 comprises a left wing root 94, a left wing middle portion 93, and a left wing outer portion 92. The right wing 97 comprises a right wing root 100, a right wing middle portion 99, and a right wing outer portion 98. Each wing comprises two folding joints, such as left wing outside folding joint 95, left wing inside folding joint 96, right wing outside folding joint 101, right wing inside folding joint 102. The outer portion of a wing can be rotated about an axis along the length of a folding joint in a downward direction. For example, the right wing outer portion 98 can be rotated about an axis which lies in a plane parallel to the xy-plane of the body frame of the aircraft and which is parallel to a direction vector with a component in the positive y-direction and positive x-direction. The axis of rotation can be considered to be coincident with line 101 when viewed from the top, as indicated in FIG. 6. The rotation of the right outer wing portion 98 about the aforementioned direction vector is in a positive direction according to the right hand rule. The right outer wing portion 98 is thus rotated downwards and inwards about joint 101. The right outer wing portion 98 has reached its folded configuration as soon as it has rotated by approximately 180 degrees about this rotation axis, such that the right outer wing portion 98 is now parallel to, and close to, the middle portion 99. The left outer wing 92 can be rotated and folded in a similar manner about joint 95. The inner portion of a wing can be rotated about an axis along the length of a folding joint in a downward direction. For example, the right middle portion 99 can be rotated about an axis which lies in a plane parallel to the xy-plane of the body frame of the aircraft and which is parallel to a direction vector with a component in the positive y-direction and positive x-direction. The axis of rotation can be considered to be coincident with line 102 when viewed from the top, as indicated in FIG. 6. The rotation of the right middle wing portion 99 about the aforementioned direction vector is in a positive direction according to the right hand rule. The right outer middle portion 99 is thus rotated downwards and inwards about joint 102. The right outer middle wing portion 99 has reached its folded configuration as soon as it has rotated by approximately 90 degrees about this rotation axis, such that the trailing edge of the right middle wing portion 99 is now approximately vertical, perpendicular to the ground in this particular embodiment. The left middle wing 93 can be rotated and folded in a similar manner about joint 96. The folded configuration of the wings can correspond to a storage configuration, a hover configuration, or a ground taxiing configuration, for example. This configuration is shown in FIGS. 1-3. In a cruise configuration the wings are extended, as shown in FIGS. 4-6.

The folding of the wings can reduce the area enclosed in the outline of the aircraft projected onto the xy-plane of the body frame, or projected onto the ground. The folding of the wings can reduce the footprint of the aircraft, and reduce the lateral extent of the aircraft. This can allow the aircraft to be stored inside a conventional garage for automobiles, for example. This can also enable the aircraft to takeoff or land vertically or hover in confined spaces, such as forests, suburban driveways, or urban streets.

In a low wing configuration, the middle portion of the wing can be rotated upwards instead of downwards, and the outer portion of the wing can be rotated downwards onto the middle portion of the wing. In some such embodiments the outer portion of the wing can alternatively be rotated upwards onto the middle portion of the wing.

In some embodiments, the joints or axes about which an outer wing portion or middle wing portion can rotate can also be parallel to the x-axis of the body frame.

In the embodiment shown in the figures, the wing is swept backwards in order to reduce wave drag at transonic speeds. In some embodiments the wing can alternatively be swept forward. In some embodiments, the sweep angle of the wing can be modified in flight. For instance, the wing sweep can be zero, or close to zero, at speeds below around Mach 0.5 in order to maximize the wingspan and minimize the induced drag of the wing. At speeds above around Mach 0.5 the wing sweep can be increased to minimize the net drag on the wing. The optimum sweep angle at a given cruise speed is a function of the wave drag or the compressibility drag and the induced drag of the wing, as well as other parameters such as trim drag. In some embodiments the wing sweep can be zero, or substantially zero, and fixed, i.e. unable to be changed substantially in flight.

In some embodiments, the aircraft can be configured to fly at Mach 0.3. In some embodiments, the aircraft can be configured to fly at Mach 0.3. In some embodiments, the aircraft can be configured to fly at Mach 0.5. In some embodiments, the aircraft can be configured to fly at Mach 0.7. In some embodiments, the aircraft can be configured to fly at Mach 0.8. In some embodiments, the aircraft can be configured to fly at Mach 0.9. In some embodiments, the aircraft can be configured to fly at Mach 0.95. In some embodiments, the aircraft can be configured to fly at supersonic speeds above Mach 1.

In some embodiments, the wing can also have a dihedral angle. In some embodiments, the wing can also have an anhedral angle. In some embodiments, the angle of attack of the wing in cruise, and the orientation of the wing relative to the fuselage 121, can be different to the angle of attack and orientation of the wing relative to the fuselage 121 shown in the figures.

Each wing comprises ailerons, which are not shown for simplicity. The ailerons, or control surfaces, can be mounted at the trailing edges of the right outer wing portion 98 and the left outer wing portion 92. Ailerons, or control surfaces, can also or alternatively be mounted at the trailing edges of the right middle wing portion 99 and the left middle wing portion 93. In some embodiments, flaps can also be mounted at the trailing edges of the left and right middle portions, and/or the left and right outer portions. The flaps can be configured to reduce the stall speed and the landing speed of the aircraft when performing conventional landings on conventional runways. The exemplary embodiment shown in the figures is configured to be able to perform conventional fixed wing aircraft landings on conventional aircraft runways. In some such landings, the aircraft can be in a pre-cruise configuration, or in a PU assisted flight configuration. In some embodiments, the aircraft can also be in a cruise configuration during such conventional landings, provided the ride height of the aircraft has been adjusted such that the rear PU assembly does not contact the ground during the landing or subsequent rollout or taxiing on the ground. The flaps can also be employed to reduce the takeoff distance when performing conventional takeoffs from conventional runways. In some embodiments, split flaps can also be mounted at the trailing edges of the right outer wing portion 98 and the left outer wing portion 92. Split flaps can enhance the yaw control of the aircraft when employed in a similar manner as the split flaps on flying wings.

In some embodiments the wing 90 can also comprise slats mounted at the leading edges of the left and right middle portions, and/or the left and right outer portions of the wing.

The interface between the wing 90 and the fuselage 121 of the aircraft also comprises a wing root fairing. The wing root fairing is configured to reduce the interference drag of the wing and the fuselage and avoid flow separation or excessive vortex generation and shedding into the far wake at the interface between the wing root and the fuselage. The wing root fairing is not shown in the figures for simplicity.

The left and right wing comprise two segments which can rotate, namely the middle segment and the outer segment. In other embodiments, the left and right wing can comprise three segments which can rotate: a first segment, a second segment, and a third segment, where the third segment is located at the wing tip, where the second segment is located between the first and third segments, and where the first segment is located at the wing root. The length of each segment can be approximately equal to the height of the wing root above the ground, or the bottom of the fuselage, as is the case for the embodiment shown in the figures. An aircraft with three wing segments can therefore have a larger wing span and a smaller induced drag compared to an aircraft with only two wing segments per wing. In embodiments with three wing segments, the wing can be folded in one of several ways. For example, the third wing segment at the wing tip can be rotated by 180 degrees upwards, onto the second wing segment, where an upwards rotation of a third wing on the right side of the aircraft is a rotation in the negative direction according to the right hand rule about a direction vector parallel to the axis of rotation and pointing in the positive x-direction of the body frame. The second wing segment can be rotated by 180 degrees downwards, onto the first wing segment. Note that the first wing segment is still folded against the second wing segment during this nominal folding process. The first wing segment can subsequently be rotated by 90 degrees downwards, in similar fashion as the left or right middle wing of the embodiment in the figures. In other embodiments, the third wing segment can be rotated by 180 degrees downwards, the second wing segment can be rotated by 180 degrees upwards, and the first wing segment can be rotated by 90 degrees downwards. In other embodiments, the wing can comprise four segments: a first wing segment, a second wing segment, a third wing segment, and a fourth wing segment. The length of the first, third, and fourth wing segment can be approximately equal to the height of the wing root above the ground, or the bottom of the fuselage, as is the case for the embodiment shown in the figures. The length of the second wing segment can be approximately equal to the maximum thickness of the airfoil of the fourth wing segment. The folding process for such an embodiment can comprise a rotation of the fourth wing segment by 180 degrees downwards, a rotation of the third wing segment by 90 degrees downwards, a rotation of the second wing segment by 90 degrees downwards, and a rotation of the first wing segment by 90 degrees downwards. In some embodiments, a left or right wing comprises only a single rotating wing segment, such as wing segment 93 or wing segment 99. The single rotating wing segment can be configured and operated in a similar manner as wing segment 93 or wing segment 99 shown in the figures. Embodiments with only a single rotating wing segment for the left and right wing can be considered to be equivalent to the embodiment shown in the figures, where the outer wing segments 92 and 98 are not present. A smaller, shorter wing can reduce the net drag during cruise in some embodiments. For example, the geometry or shape of the wing can be optimized for a single operating condition, i.e. cruising flight. Given structural constraints, the optimal wing span can be the span of a wing with only a single rotating wing segment for some embodiments, for instance.

In other embodiments, the wing shape can be different to the shape shown in the figures. For example, the aspect ratio, taper ratio, and/or sweep can be different in other embodiments.

The wing location is dictated by stability considerations and a function of the location of the center of mass of the aircraft. In other embodiments the wing can therefore be located further forwards or further backwards compared to the location shown in the figures.

The airfoils along the span of the wing can be supercritical airfoils in some embodiments. In some embodiments the airfoils can be configured to favor laminar flow along at least a portion of the wing during at least a portion of nominal operation of the aircraft. The airfoil geometry, chamber, angle of attack, thickness, and/or chord can be different in other embodiments compared to the embodiment shown in the figures.

Some embodiments need not comprise a wing at all. In such embodiments, the aircraft can cruise in PU-assisted flight mode, where at least a portion of the weight of the aircraft is cancelled by the thrust or aerodynamic loads on the PUs, as well as any lift force acting on the fuselage. Such embodiments can benefit from a reduced weight and wetted area and associated drag compared to other embodiments with a wing.

The wing increases the safety of the aircraft by increasing the redundancy of lift producing systems. For example, in the event of a complete engine failure, the wing can provide at least a portion of the lift required to cancel the weight force of the aircraft, and allow the aircraft to glide. The wing can be operated to reduce or minimize the descent rate of the aircraft in this scenario, such that a controlled landing can be achieved, or controlled flight can be maintained until engine power can be restored. The aircraft can thus be operated in a similar manner as a conventional fixed wing aircraft in the event of an engine failure. Note that, in such cases, at least a portion of the lift force required to cancel the weight force of the aircraft can also be provided by the PUs in the form of a lift force acting on the ducts of the PUs. The axial thrust of the PUs in the upstream direction, and the power consumed by the PUs, is less than or equal to zero in the event of a complete engine failure. In some such scenarios, the rotor blades of the PUs can be feathered, or the PUs can be operated as wind turbines and configured to extract power from the fluid. The power extracted can be employed to slow the descent rate of the aircraft, in a manner similar to an autorotation of a helicopter. The power extracted can also be employed to power systems onboard the aircraft. The power extracted can also be employed to power systems onboard the aircraft. The power extracted can also be employed to aid in the restarting of an engine or PU onboard the aircraft. The power extracted can also be stored onboard the aircraft, and employed to power at least one PU for a limited duration of time, such as during landing. Similar modes of operation are also available in the event of a partial engine failure.

Embodiments of the invention which feature a separate wing, such as left wing 91 and the right wing 97, benefit from a reduced induced drag of the wing during nominal level cruise compared to embodiments which do not feature a separate wing and rely on the thrust of the PUs, and/or any lift force acting on the fuselage and the PUs, such as the ducts of the PUs, to cancel the weight force of the aircraft.

In some embodiments, the wing can be configured to allow the aircraft to perform conventional takeoffs and landings. In such embodiments, the size and shape of the wing is subject to stall speed constraints, which in turn are a function of the length of the runways from which conventional takeoffs and landings are intended to be performed, as well as other parameters, such as aircraft weight, available power, and propulsive efficiency. Typically, the ability to perform conventional takeoffs and landings necessitates a low stall speed compared to the cruise speed, which, due to a finite maximum attainable lift coefficient, requires the wing planform area to be comparatively large during conventional takeoffs and landings. A larger wing planform area is undesirable in cruise, at least in part due to the larger wing weight, wetted area, and associated drag. This cruise performance penalty can be mitigated in some embodiments of the invention by configuring the wing to be able to morph, i.e. change in size and shape, e.g. via flaps, slats, or slots, as mentioned.

In some embodiments the wing shape of an embodiment of the invention can be optimized for nominal cruise, which can significantly improve the cruise performance compared to other embodiments. For example, the wing can be configured to operate at a high lift coefficient during cruise, which can reduce the planform area of the wing. Embodiments of the invention configured to operate at a higher lift coefficient during nominal level cruise can benefit from a reduced wing planform area, which can reduce the weight and the wetted area of the wing, which can reduce the profile drag and induced drag of the aircraft during nominal cruise compared to a wing configured to operate at a lower lift coefficient during nominal cruise. Note that the profile drag includes the viscous drag acting on the wetted area of the wing.

In some such embodiments, a suitable wing lift coefficient during cruise can be one third of the maximum attainable lift coefficient during cruise. This allows the wing a margin of lift during cruise, which is necessary for maneuverability and stability and control. In some embodiments, the wing lift coefficient during cruise can be one quarter of the maximum attainable lift coefficient during cruise. In some embodiments, the wing lift coefficient during cruise can be one half of the maximum attainable lift coefficient during cruise. In some embodiments, the wing lift coefficient during cruise can be two thirds of the maximum attainable lift coefficient during cruise. In some embodiments, the wing lift coefficient during cruise can be three quarters of the maximum attainable lift coefficient during cruise. In some embodiments, the wing lift coefficient during cruise can be one ninth of the maximum attainable lift coefficient during cruise. In some embodiments, the wing can be configured to comprise, and operate with, lift coefficient enhancing features, such as flaps, slats, or slots during nominal, level cruise.

Note that an increased cruise performance of a wing configured to operate at a higher lift coefficient during nominal cruise is provided at the expense of a larger stall speed and the associated requirement for other sources of lift to cancel the weight force at lower flight speeds. Lower flight speeds comprise speeds below the nominal cruise speed, such as at speeds below the theoretical stall speed of a fully loaded wing, or at speeds at which the ratio of the theoretical lift coefficient of a fully loaded wing to the maximum attainable lift coefficient of the wing is too large to provide a sufficient margin for maneuverability or stability or controllability. At these lower flight speeds, the aircraft can be configured to operate in a PU assisted flight mode. As mentioned, in this flight mode, the lift force of the wing can be configured to be smaller in magnitude than the weight force of the aircraft. The lift force of the wing can be reduced to a value such that the ratio of the actual lift coefficient of the wing to the maximum attainable lift coefficient of the wing is sufficiently small to provide a sufficient margin for maneuverability or stability or controllability. The lift force of the wing can be modified by modifying the angle of attack of the wing relative to the local free stream flow, for example. In this PU assisted flight mode, the remaining lift force required to cancel the weight of the aircraft can be provided at least in part by the net thrust force of the propulsion units, which also provides the required forward thrust force on the aircraft. Note that any lift force acting on the fuselage and the PUs, such as the ducts of the PUs, can also be employed at least in part to cancel the weight of the aircraft and any other external vertical force components during nominal cruise.

For some embodiments of the invention configured to operate at a higher lift coefficient during cruise, the cruise performance of the embodiments can exceed the cruise performance of a comparable conventional fixed wing aircraft. In this comparison, the wing of the comparable fixed wing aircraft has an identical wingspan and identical maximum attainable lift coefficient. A comparable fixed wing aircraft employs the wing to generate a lift force equal and opposite to a large portion of the weight force over a larger range of flight speeds. This requirement is due to the limited length of runways and the limited ability of conventional aircraft to reach cruising speed before liftoff, or the ability to decelerate from cruising speed after touchdown on landing. The necessity to generate a lift force substantially equal and opposite to the weight force over a larger range of flight speeds can require a wing of a comparable fixed wing aircraft to have a larger planform area during nominal level cruise, as explained in more detail below. This is associated with an increased wetted area, weight, and profile drag during nominal cruise, and hence a reduced cruise performance of the comparable fixed wing aircraft compared to the aforementioned embodiment of the invention configured to operate at a higher lift coefficient during cruise.

Note that the comparison necessitates the wing of the comparable fixed wing aircraft to be identical in wingspan and maximum attainable lift coefficient, where attainability is determined over the range of possible cruise speeds of the comparable fixed wing aircraft. For the sake of comparison, the configuration of the wing of an embodiment of the invention and the configuration of the wing of a comparable fixed wing aircraft is substantially similar, where the configuration comprises the planform geometry, airfoil shape, chord distribution, angle of attack distribution, and other relevant parameters. In this comparison, the wings can be of substantially constant shape over time, or they can be able to morph, i.e. modify their shape as a function of time via retracting or extending flaps or slats.

In the case in which the wings are substantially constant in shape over time, consider the following simplified model. In this simplified model, the maximum lift coefficient of the wing of the fixed wing aircraft at a given cruising flight speed is equal to the overall maximum lift coefficient over a range of cruising flight speeds. The size of the wing on the comparable fixed wing aircraft is determined by the stall speed, which is lower than the nominal cruise speed. The size of the wing on the embodiment of the invention is also determined by the stall speed, which can be larger than the stall speed of the wing of the comparable fixed wing aircraft. For example, the stall speed of a wing of an example embodiment of the invention can be 71% of the nominal cruise speed, in order to allow for a lift margin for maneuverability and stability and control. In other words, the minimum maneuvering speed of the wing of an example embodiment of the invention can be equal to the nominal cruise speed. Due to the inability to operate in a PU assisted flight mode, and due to takeoff and landing performance limitations, the stall speed of a comparable fixed wing aircraft can be 14% of the nominal cruise speed in this example, and the minimum maneuvering speed can be 20% of the nominal cruise speed. Note that the wing of an embodiment of the invention in this example does not need to generate a lift force which cancels a large portion of the weight force over a large range of cruising speeds, which allows the wing stall speed to be larger. Also note that, for both the example embodiment of the invention and the comparable fixed wing aircraft, at the stall speed, the wing is configured to operate at the maximum attainable lift coefficient. The stall speed, or, by extension, the minimum maneuvering speed, therefore determines the planform area of the wing for both the example embodiment of the invention and the comparable fixed wing aircraft in this simplified model. The comparable fixed wing aircraft in this scenario requires a larger wing planform area in order to facilitate a smaller stall speed. In other words, wings of some embodiments of the invention can feature a reduced planform area compared to comparable wings of comparable fixed wing aircraft.

In the case in which the wings are able to morph, consider the following example. The wing of the example embodiment of the invention can be in a configuration of maximum suitable attainable lift coefficient during nominal cruise, e.g. with slats, flaps, or slots present or extended in a multi-element airfoil configuration, where suitability requires that maneuverability and controllability can be maintained. This configuration maximizes the maximum attainable lift coefficient and minimizes the required maximum planform area of the wing, and minimizes the size and weight of the wing. For example, the stall speed of the wing of an example embodiment of the invention can be 71% of the nominal cruise speed, in order to allow for a lift margin for maneuverability and stability and control. In other words, the minimum maneuvering speed of the wing of an example embodiment of the invention can be equal to the nominal cruise speed. In other words, the maximum suitable attainable lift coefficient can be one half of the maximum attainable lift coefficient during nominal cruise. The aforementioned maneuvering lift coefficient, the maneuvering configuration, and the minimum maneuvering speed determine the planform area of the wing for the example embodiment of the invention for a given nominal cruise speed.

The wing of the comparable fixed wing aircraft is typically configured such that, at the stall speed, the wing would operate at the maximum lift coefficient and the maximum planform area, i.e. with slats and/or flaps extended. The stall speed of the wing of the comparable fixed wing aircraft can be 14% of the nominal cruise speed in this configuration, for example, and the minimum maneuvering speed can be 20% of the nominal cruise speed. This configuration minimizes the required maximum planform area of the wing, and minimizes the size and weight of the wing. Consequently, at the larger, nominal cruise speed, the wing of the comparable fixed wing aircraft can be afforded to operate at a reduced lift coefficient and/or reduced wing planform area. Reducing the wing planform area during nominal cruise is desirable, because this can reduce the wetted area and associated profile drag of the wing. Reducing the wing planform area typically also reduces the maximum lift coefficient of the wing due to the retraction of slats or flaps.

In this comparison, therefore, during nominal level cruise, the comparable fixed wing aircraft operates at a lower maximum lift coefficient (with flaps and/or slats at least partially retracted) than the embodiment of the invention, which is operating at the maximum suitable attainable lift coefficient (with flaps and/or slats extended). For example, the stall speed of the wing of the comparable fixed wing aircraft can be 35% of the nominal cruise speed in this new nominal cruise configuration, which is still smaller than the stall speed (at 71% of the nominal cruise speed) of the wing of the example embodiment of the invention, for example. Similarly, the minimum maneuvering speed can be 49% of the nominal cruise speed for the wing of the comparable fixed wing aircraft in this nominal cruise configuration. Compared to the embodiment of the invention in question, therefore, the wing of the comparable fixed wing aircraft is in a configuration with a larger planform area and lower stall speed. This explains why, in the above comparison, the wing of the comparable fixed wing aircraft has a larger wetted area during nominal level cruise, which is associated with an increased weight and profile drag during nominal level cruise, and hence a reduced cruise performance compared to the aforementioned embodiment of the invention configured to operate at a higher lift coefficient during cruise.

The cross-section of the fuselage when viewed in the positive x-direction of the body frame can be elliptical in some embodiments. The cross-section of the fuselage when viewed in the positive x-direction of the body frame can be circular in some embodiments. The cross-section of the fuselage when viewed in the positive x-direction of the body frame can be elliptical at some locations along the fuselage and circular at other locations along the fuselage in some embodiments. The cross-section of the fuselage when viewed in the positive x-direction of the body frame can be rectangular, square, or polygonal in some embodiments. In some such embodiments, the corners or edges of the polygonal cross-section can be rounded or comprise round or smooth chamfers. The rounded edges of a polygonal cross-section can reduce the drag on the fuselage due to flow separation. In some embodiments the fuselage can comprise flat sections or planar surfaces.

In some embodiments the fuselage can be encased by a duct which is configured to reduce the wave drag of the fuselage and duct assembly during transonic or supersonic flight, as described by U.S. Provisional patent application 62/749,109 filed on 22 Oct. 2018, or U.S. Provisional patent application 62/751,623 filed on 28 Oct. 2018.

In some embodiments there are ducts which surround the fuselage 121. The ducts can encompass the fuselage circumferentially in a direction which is substantially perpendicular to the local free stream flow and substantially parallel to the local outside surface of the fuselage 121. These annular ducts can be configured to decelerate the flow at the surface of the fuselage. In other words, the lift force one these annular ducts can be directed in a radially outward direction. In some embodiments a single annular duct surrounds the fuselage. In other embodiments a plurality of annular ducts surround the fuselage, where the ducts can be located at different locations along the length of the fuselage. This can reduce the viscous drag of the fuselage, as described in U.S. Provisional patent application 62/685,295 filed on Jun. 15 2018. These ducts can also be configured delay or avoid flow separation at the rear of the fuselage and reduce the associated pressure drag.

In some embodiments a first thrust apparatus can be located upstream of the fuselage 121, and a second thrust apparatus can be located downstream of the first thrust apparatus. The first thrust apparatus can be configured to decelerate the flow adjacent to the fuselage 121 and generate a thrust force on the aircraft which is directed in the downstream direction. The first thrust apparatus can be configured to extract energy from the fluid. The second thrust apparatus can be configured to accelerate the flow and generate a thrust force on the aircraft which is directed in an upstream direction. The first and second thrust apparatuses can be employed to reduce the viscous drag on the fuselage, as described in U.S. Provisional patent application 62/685,295 filed on Jun. 15 2018 and in U.S. Provisional patent application 62/714,778 filed on Aug. 6 2018.

The fuselage, wings, and PUs can be constructed of any suitable materials, such as metals such as aluminium, titanium, or steel. Other materials, such as composite materials, such as fiberglass, carbon fiber, or Kevlar composites can also be employed.

The aircraft 1 comprises a power unit 85. In the embodiment shown, the power unit 85 comprises batteries, such as Lithium-Ion or Lithium-Sulfur battery. In some embodiments, batteries can also be stored at other locations within the aircraft, such as in the wings, or in the region between the interior cabin walls and the fuselage outside walls. The power unit also comprises a power control module, which is employed to transfer the power from the batteries to the electric motors. The delivery of power from the battery to the electric motors can be facilitated in a similar manner as in conventional electric automobiles. Each PU comprises an electric motor, such as a brushless DC motor, or an AC induction motor. The electric motors are mounted on the drive shafts of the ducts of the PUs, such as drive shaft 9, 23, 37, or 51. The electric motors are not shown in the figures for simplicity.

In some embodiments, the power unit 85 can comprise a battery, an engine, and an electric generator. The engine can be a turboshaft engine, or an engine comprising reciprocating pistons, for example. The engine can be a device which is configured to convert thermal energy contained within the environment into shaft work. The engine can comprise a turbine, and/or a converging diverging nozzle, for example. The engine can also be an internal combustion engine configured to burn fuel such as petrol or kerosene and produce shaft work. The engine can be a conventional, fuel burning turboshaft or an internal combustion engine used in conventional automobiles. The engine can be a device which is configured to produce shaft work. The drive shaft of the engine can be mechanically coupled to the electric generator. The mechanical coupling can comprise a drive shaft in some embodiments. The mechanical coupling can also comprise a mechanical or electrical clutch in some embodiments. The mechanical coupling can comprise a gear box configured to change the rate of rotation of the drive shaft from the engine relative to the rate of rotation of the drive shaft of the electric generator. The electric generator can be configured to be able to charge the battery, and/or deliver electrical power to the electric motors located within the PUs. In other words, the PUs can be powered in a series hybrid configuration in some embodiments. The mode of operation of a series hybrid aircraft is similar to the mode of operation of a series hybrid automobile.

In some embodiments, an engine, such as a turboshaft engine or a reciprocating piston engine, can be mechanically coupled to the drive shafts of the individual PUs, such as drive shaft 9, 23, 37, or 51, in a direct drive configuration. As in the aforementioned series hybrid case, the engine can comprise a conventional fuel burning engine, such as a conventional turboshaft or a conventional internal combustion engine with reciprocating pistons found in conventional automobiles or piston aircraft. The engine can be a device which is configured to convert thermal energy contained within the environment into shaft work. The engine can comprise a turbine, and/or a converging diverging nozzle, for example. The engine can be a device which is configured to produce shaft work. In some embodiments, the engine in a direct drive configuration is an electric motor powered by a battery or other electricity storage device. The aforementioned mechanical coupling between the engine and the PUs can comprise a drive shaft in some embodiments. The mechanical coupling can also comprise a clutch in some embodiments. In some embodiments the mechanical coupling can comprise one clutch for each PU, where each clutch is configured to be able to mechanically couple or uncouple the drive shaft of each individual PU from the engine. In some embodiments, the mechanical coupling can comprise two mechanical clutches, where each clutch is configured to be able to mechanically couple or uncouple the drive shaft of two PUs, such as PU 2 and 16, or PU 30 and 44, or PU 2 and 30, or PU 2 and 44, or PU 16 and 30, or PU 16 and 44, from the engine. The mechanical coupling can comprise a gear box configured to change the rate of rotation of the drive shaft from the engine relative to the rate of rotation of the drive shaft of the PU. The mechanical coupling can also comprise a drive shaft which is configured to transfer the power from the engine in the power unit 85 at the rear of the aircraft to the two PUs at the front of the aircraft. In some embodiments, the drive shaft can be arranged to pass along the inside of the fuselage 121 along the bottom of the fuselage 121, and below the interior cabin containing the passengers. In order to account for the curvature of the fuselage the drive shaft can comprise several constant velocity joints. The joints can transfer power between two drive shafts which are not parallel. A wide variety of such joints are known in the art of mechanical engineering. The mechanical coupling between the engine and the drive shafts of the PUs can also comprise drive shafts which transmit power through the interior of the support shaft of each PU, such as support shafts 10, 24, 38, and 52. The power from these drive shafts can be transferred to the drive shafts of the PUs, such as drive shafts 9, 23, 37, or 51, via an appropriate gear, such as a straight bevel gear, a helical bevel gear, or screw bevel gear, worm gear, or screw gears. The benefit of a direct drive configuration is the increased volumetric power density. In such configurations there need not be an electric motor located within each duct. This can increase or maximize the mass flow rate of air through the duct, or reduce the total size of a PU. This can also increase the maximum amount of power per unit volume of a PU, or increase the maximum power of a PU of a given size. This is due to the finite maximum volumetric power density of electric motors. A larger maximum power per PU can increase the performance of the aircraft. It can increase the top speed of the aircraft and increase the thrust margin during takeoff, landing, or hover operations, and increase the maximum rate of climb.

In some embodiments comprising a direct drive configuration, the drive shaft of the engine can also be mechanically coupled to an electric motor, which can also be operated as an electric generator. In other words, the electric motor can be configured to power the same drive shaft as the engine, and the same drive shaft which delivers power to each of the four PUs. The electric motor can be powered by an energy storage unit, and can be employed to charge or recharge the energy storage unit. The energy storage unit can comprise a battery, a capacitor, or an inductor, for example. In some embodiments, the engine is connected to the drive shaft to which the electric motor is connected via a clutch which can mechanically uncouple the engine from the drive shaft. The uncoupling of the engine can be desirable in the event of an engine failure, for example. The electric motor can be configured to power the drive shaft in the event of an engine failure or in the event of the engine being uncoupled from the drive shaft, or provide additional power to the drive shaft already powered by the engine in the event in which a large amount of power is required, such as during hover, takeoff, landing, or climbing flight. Thus the PUs can be powered in a parallel hybrid configuration in some embodiments. The mode of operation of a parallel hybrid aircraft is similar to the mode of operation of a parallel hybrid automobile. The parallel hybrid drive train can benefit from an additional level of safety and redundancy, because the drive train to be powered electrically or by an engine, instead of just electrically, as is the case for a series hybrid drive train. A failure of all of the electric motors driving the drive shaft in a series hybrid configuration can result in a failure of the drive train, while a failure of all of the electric motors driving the drive shaft in a parallel hybrid configuration may only require the increase in the power output of an engine coupled to the drive shaft.

In some embodiments comprising an engine, such as embodiments in which the power unit 85 is configured in a series hybrid configuration, a direct drive configuration, or a parallel hybrid configuration, the power unit 85 can comprise more than one engine. This can increase the redundancy within the power unit 85 and increase the safety of the aircraft in the event of a failure of at least one engine. For example, a power unit 85 can comprise two engines. A power unit 85 can also comprise three or four engines. A power unit 85 can comprise a plurality of engines. In some embodiments, each engine can be separately coupled and uncoupled from the main drive shaft powering the four PUs by a mechanical or electrical clutch in the parallel hybrid configuration or in a direct drive configuration. In some embodiments, each engine can be coupled to a separate electric generator in a series hybrid configuration.

In the case in which the power unit 85 comprises an engine which requires an exhaust, the exhaust can be ducted through the center of the annular support strut mounting 58 and exhausted into the atmosphere or the environment at the tail 62 of the aircraft. The exhaust can be the hot exhaust gases from a conventional turboshaft engine, or a conventional aircraft or automobile piston engine, which burns fuel, for example. The exhaust can also be the cold exhaust gases from an engine configured to convert thermal energy in the air or the environment into useful work, where the useful work can be used to generate induced power associated with the acceleration of fluid and the production of thrust, or where the useful work can be used to generate electricity to charge a battery or energy storage apparatuses, or power the electronics of the aircraft, or provide electrical power to the PUs. The exhaust can also be the exhaust from an engine configured to convert energy in the quantum vacuum into useful work, such as induced power associated with the production of thrust or the power associated with the generation of electricity.

In some embodiments, the exhaust of the engine can be employed to generate additional thrust. The air exiting the exhaust can be moving at a faster speed than the air entering a corresponding inlet, for instance. The acceleration of the air between the inlet and the exhaust can be employed to generate additional thrust, where the thrust can have a non-zero component in the positive x-direction of the body frame.

In some embodiments, the exhaust from the engine, or plurality of engines, can be redirected. For instance, the exhaust can be directed downwards in order to provide additional lift during hover or PU assisted flight or to assist in pitch control. The exhaust can also be directed sideways or upwards to assist in yaw or pitch control, for example. The redirection can be carried out or assisted by guide vanes, as is the case for the Hawker Siddeley P.1127, for example. The redirection can be performed or assisted by control surfaces, as is the case for the Lockheed F-22. The redirection can also be performed or assisted by a change in the orientation of the exhaust duct or exhaust nozzle, as is the case for the Yak-141 or the Lockheed F-35. In some embodiments, the aircraft need not comprise separate rear PUs, such as rear PUs 30 and 44, but can generate thrust and lift via a turbofan engine located in power unit 85, where the exhaust flow, which comprises the core flow and bypass flow of the turbofan engine, can be redirected using the aforementioned thrust vectoring techniques, or other techniques known in the art. For instance, the rear thrust assembly can be configured in a similar manner as the rear thrust assembly of the Lockheed F-35, which comprises at least one turbofan engine and a nozzle which can be rotated downwards, i.e. about the pitch axis of the aircraft, and from side to side, i.e. about the roll axis of the aircraft. The redirection of the exhaust flow can be employed to cancel at least a portion of the weight force during hover, and at least a portion of the drag force during forward flight or cruise. The redirection of the exhaust flow can also be employed for pitch, roll, and yaw control. The aforementioned turbofan engine can comprise an upstream thrust apparatus configured to generate thrust in an upstream direction in the bypass flow, and a downstream thrust apparatus configured to generate thrust in a downstream direction in the bypass flow and downstream of said upstream thrust apparatus during some modes of operation, such as operation at free stream flow speeds below around Mach 0.5. As mentioned, this can increase the mass flow rate of the bypass flow and reduce the induced drag of the turbofan engine. Note that thrust vectoring via exhaust flow redirection can also be employed for other engine types, such as turbojet engines or subsonic or supersonic ramjet engines.

In the case in which the power unit 85 comprises an engine which requires an inlet, the inlet can be located on the side of fuselage 121. For example, an inlet can be located on the top of the fuselage, as is the case for conventional formula 1 vehicles. In another example, and inlet can be located on the bottom of the fuselage, as is the case for the Eurofighter Typhoon. In another example, the inlet can be located on the right side of the fuselage, and/or the left side of the fuselage, as is the case for the F-35. The inlet can be configured to supply air to the engine. The air can be employed to facilitate the chemical reaction associated with the combustion of fuel within the engine, for example. The air can also be employed to provide thermal energy, which can be converted into useful work within the engine, where the useful work can be used to generate induced power associated with the acceleration of fluid and the production of thrust, or where the useful work can be used to generate electricity to charge a battery or energy storage apparatuses, or power the electronics of the aircraft, or provide electrical power to the PUs. The inlet can also be configured to direct virtual particles in the quantum vacuum to the engine, such that the energy in the quantum vacuum can be converted into useful work, such as induced power associated with the production of thrust or the power associated with the production of electricity.

In some such embodiments, each PU comprises an engine configured to drive the drive shaft of the PU, such as drive shafts 9, 23, 37, or 51. The engine driving the drive shafts can comprise a conventional fuel burning engine, such as a conventional turboshaft or a conventional internal combustion engine with reciprocating pistons found in conventional automobiles or piston aircraft. In some embodiments, fuel can be carried in the wings. In some embodiments, fuel can also be carried in volume 85. The engine in each PU can also be a device which is configured to convert thermal energy contained within the environment into shaft work. In some such embodiments, the volume 85 can be occupied by cargo or by additional passengers and their seats. The engine can comprise a turbine, and/or a converging diverging nozzle, for example. The engine be an unconventional turboshaft or reciprocating piston engine, for example. The engine can be a device which is configured to produce shaft work. In some embodiments the engine can be mechanically coupled to the drive shaft of the PU, such as drive shafts 9, 23, 37, or 51, by a clutch. In some embodiments the engine can be can be mechanically coupled to the drive shaft of the PU via a gear box configured to change the rate of rotation of the drive shaft from the engine relative to the rate of rotation of the drive shaft of the PU.

In some embodiments, each PU comprises an engine configured to generate thrust. The engine can be a device which is configured to convert thermal energy contained within the environment into thrust, for example. In some such embodiments, the volume 85 can be occupied by cargo or by additional passengers and their seats. The engine can be any device which is configured to generate thrust. The engine can be a subsonic and/or supersonic ramjet, for example. The engine can be a conventional or unconventional turbofan engine, or a turbojet engine, for example. In some embodiments, fuel can be carried in the wings. In some embodiments, fuel can also be carried in volume 85. In some embodiments, a PU need not comprise any rotor discs, or drive shafts, or a propeller. In some embodiments, a PU can comprise an apparatus configured to generate thrust by interacting with the quantum vacuum. The nominal direction of thrust can be substantially in the same direction of thrust of a PU in the embodiment shown in the figures, and the magnitude of the thrust can be regulated in some such embodiments.

In some embodiments, the aircraft can be equipped with an aircraft parachute. The parachute can be deployed, i.e. pulled out of its storage compartment and the canopy extended, via rockets or ballistics, for example. The parachute can be configured to decelerate the aircraft in forward flight, and reduce the terminal velocity of the aircraft in vertically descending flight to an acceptable or safe value. Such methods are well known in the field of general aviation.

In some embodiments, the aircraft can be equipped with parachutes for each individual passenger. The parachutes can be configured to allow the passengers to exit the aircraft in any feasible flight mode, such as cruise, climb, descent, or hover, and subsequently deploy their parachute to decelerate to a safe landing at a sufficiently reduced terminal velocity.

In some embodiments, the aircraft can be equipped with ejection seats. For instance, the two seats in the front row, i.e. seats 64 and 65 can be ejection seats, which, in an emergency, can eject the passengers through the opening of the main window 63 after the main window 63 itself has been ballistically removed. In some embodiments, portions of the fuselage can be ballistically removed in order to allow an ejection seat to transport a passenger and parachute out of the cabin and out of the aircraft in an emergency.

In some such embodiments, the aircraft can be remotely operated by a qualified pilot. In some embodiments, the aircraft can be configured to operate completely autonomously throughout the entire range of operating conditions, such as taxiing on the ground, taking off, climbing, cruising, descending, or landing. In some such embodiments, the aircraft need not comprise a conventional cockpit, but can be controlled at a high level via a touchscreen interface. The aircraft can comprise at least three independent flight computers to ensure safe autonomous flight. The flight control computers can be configured to control the actuators which actuate the DOF of the aircraft and ensure the aircraft follows a desired trajectory. The flight control computers can be employed to process and fuse sensor data to establish the current state of the vehicle.

The vehicle can be equipped with a wide variety of sensors. For example, cameras, LIDAR, radar, or ultrasound can be used to detect obstacles in the proximity of the aircraft. An inertial measurement unit, which can comprise an accelerometer, a gyroscope or magnetometer, amongst other sensors, can be employed to determine the attitude of the aircraft. A pitot tube can be employed to measure the free stream flow speed, and a barometer can be employed to measure the altitude, for example.

There are several ways in which the various degrees of freedom, or DOF, can be actuated. Some DOF can be actuated hydraulically, for example. The joints 95, 96, 102, or 101 can be actuated by a triple or quadruple redundant hydraulic system, for example. Some DOF can also, or alternatively, be actuated electrically. For example, an electric motor can be employed to actuate the ailerons or flaps, or the orientation of the PUs relative to the fuselage. In some such embodiments, a mechanical clutch or a brake can be employed to lock a DOF in place, such that the electric motor does not need to apply a torque and consume power while there is zero motion of the associated DOF. Some DOF can be actuated by an electric-hydraulic actuator, i.e. an actuator comprising an electric actuator, such as a linear electric motor, or a rotary electric motor, configured to power or actuate a hydraulic actuator, which in turn is configured to power or actuate the DOF.

In some embodiments the leading edges of the ducts, as well as the leading edges of the wings, can be fitted with anti-icing apparatuses, such as heated metal surfaces, which can be employed to prevent the build-up of ice at the leading edges. This can avoid the shape of the airfoils from being modified by the build-up of ice to the detriment of the aerodynamic performance of the aircraft, and avoid or mitigate any weight increase due to the build-up of ice on the aircraft.

### Aspects of the Invention

The invention is further defined by the following aspects.

Aspect 1. A fluid interaction system, or FIS, comprising: a fuselage with a long axis connecting the front end of the fuselage with the rear end of the fuselage, and with a first short axis perpendicular to the long axis, and with a second short axis perpendicular to the long axis and the first short axis; a propulsion system, wherein the propulsion system comprises at least one propulsion unit, wherein the at least one propulsion unit is mechanically coupled to the fuselage via a mechanical coupling, wherein the at least one propulsion unit can be configured to generate a net thrust, wherein the net thrust can be configured to have a non-zero component in the positive or negative direction along the long axis of the fuselage in a first configuration, wherein the net thrust can be configured to have a non-zero component in the positive or negative direction perpendicular to the long axis of the fuselage in a second configuration; wherein the mechanical coupling is configured to allow relative motion between the fuselage and the propulsion unit.

Aspect 2. The FIS of aspect 1, wherein the propulsion system comprises at least two propulsion units.

Aspect 3. The FIS of aspect 1, wherein the propulsion system comprises at least three propulsion units.

Aspect 4. The FIS of aspect 1, wherein the propulsion system comprises at least four propulsion units.

Aspect 5. The FIS of aspect 1, wherein the relative motion comprises a rotation about a rotation axis.

Aspect 6. The FIS of aspect 5, wherein the rotation axis has a non-zero component along a short axis of the fuselage.

Aspect 7. The FIS of aspect 6, wherein the short axis is the pitch axis of the fuselage.

Aspect 8. The FIS of aspect 6, wherein the short axis is the yaw axis of the fuselage.

Aspect 9. The FIS of aspect 5, wherein the rotation axis has a non-zero component along the long axis of the fuselage.

Aspect 10. The FIS of aspect 5, wherein the rotation is a rotation of 90 degrees.

Aspect 11. The FIS of aspect 5, wherein the rotation is a rotation of 180 degrees.

Aspect 12. The FIS of aspect 5, wherein the rotation is a rotation of 360 degrees.

Aspect 13. The FIS of aspect 5, wherein the rotation is a rotation of more than 5 degrees.

Aspect 14. The FIS of aspect 5, wherein the rotation is a rotation of more than 60 degrees.

Aspect 15. The FIS of aspect 5, wherein the rotation is a rotation of more than 90 degrees.

Aspect 16. The FIS of aspect 5, wherein the rotation is a rotation of more than 120 degrees.

Aspect 17. The FIS of aspect 1, wherein the relative motion comprises a translation.

Aspect 18. The FIS of aspect 1, wherein the mechanical coupling comprises a support shaft or a support strut coupled to the propulsion unit via a first mechanical coupling and coupled to the fuselage via a second mechanical coupling.

Aspect 19. The FIS of aspect 18, wherein the first mechanical coupling comprises a rotable coupling.

Aspect 20. The FIS of aspect 19, wherein the second mechanical coupling comprises a rigid coupling.

Aspect 21. The FIS of aspect 18, wherein the second mechanical coupling comprises a rotable coupling.

Aspect 22. The FIS of aspect 21, wherein the first mechanical coupling comprises a rigid coupling.

Aspect 23. The FIS of aspect 18, wherein the second mechanical coupling is coupled to the fuselage at the rear of the fuselage, or at the trailing edge of the fuselage, or at the trailing point of the fuselage, or at the sharp end of the fuselage.

Aspect 24. The FIS of aspect 23, wherein the second mechanical coupling is coupled to the fuselage at the long axis of the fuselage in a view perpendicular to the long axis of the fuselage.

Aspect 25. The FIS of aspect 23, wherein the second mechanical coupling is coupled to the fuselage below the long axis of the fuselage or below the centerline of the fuselage in a view perpendicular to the long axis of the fuselage and in a view in which the vertical direction is perpendicular to the long axis of the fuselage.

Aspect 26. The FIS of aspect 23, wherein the second mechanical coupling is coupled to the fuselage above the long axis of the fuselage or above the centerline of the fuselage in a view perpendicular to the long axis of the fuselage and in a view in which the vertical direction is perpendicular to the long axis of the fuselage.

Aspect 27. The FIS of aspect 18, wherein the second mechanical coupling is coupled to the fuselage at the front of the fuselage, or at the leading edge of the fuselage, or at the leading point of the fuselage, or at the blunt end of the fuselage.

Aspect 28. The FIS of aspect 27, wherein the second mechanical coupling is coupled to the fuselage at the long axis of the fuselage in a view perpendicular to the long axis of the fuselage.

Aspect 29. The FIS of aspect 27, wherein the second mechanical coupling is coupled to the fuselage below the long axis of the fuselage or below the centerline of the fuselage in a view perpendicular to the long axis of the fuselage and in a view in which the vertical direction is perpendicular to the long axis of the fuselage.

Aspect 30. The FIS of aspect 27, wherein the second mechanical coupling is coupled to the fuselage above the long axis of the fuselage or above the centerline of the fuselage in a view perpendicular to the long axis of the fuselage and in a view in which the vertical direction is perpendicular to the long axis of the fuselage.

Aspect 31. The FIS of aspect 18, wherein the second mechanical coupling comprises a support strut mounting coupled to the support shaft or the support strut via a third mechanical coupling and coupled to the fuselage via a fourth mechanical coupling.

Aspect 32. The FIS of aspect 31, wherein the third mechanical coupling comprises a rotable coupling configured to allow rotation of the support strut about a rotation axis relative to the support strut mounting.

Aspect 34. The FIS of aspect 32, wherein the rotation axis has a non-zero component along a short axis of the fuselage.

Aspect 35. The FIS of aspect 34, wherein the short axis is the pitch axis of the fuselage.

Aspect 36. The FIS of aspect 34, wherein the short axis is the yaw axis of the fuselage.

Aspect 37. The FIS of aspect 32, wherein the rotation axis has a non-zero component along the long axis of the fuselage.

Aspect 38. The FIS of aspect 32, wherein the rotation is a rotation of 90 degrees.

Aspect 39. The FIS of aspect 32, wherein the rotation is a rotation of 180 degrees.

Aspect 40. The FIS of aspect 32, wherein the rotation is a rotation of 360 degrees.

Aspect 41. The FIS of aspect 32, wherein the rotation is a rotation of more than 5 degrees.

Aspect 42. The FIS of aspect 32, wherein the rotation is a rotation of more than 60 degrees.

Aspect 43. The FIS of aspect 32, wherein the rotation is a rotation of more than 90 degrees.

Aspect 44. The FIS of aspect 32, wherein the rotation is a rotation of more than 120 degrees.

Aspect 45. The FIS of aspect 31, wherein the fourth mechanical coupling comprises a rotable coupling configured to allow rotation of the support strut mounting about a rotation axis relative to the fuselage.

Aspect 46. The FIS of aspect 45, wherein the rotation axis has a non-zero component along a short axis of the fuselage.

Aspect 47. The FIS of aspect 46, wherein the short axis is the pitch axis of the fuselage.

Aspect 48. The FIS of aspect 46, wherein the short axis is the yaw axis of the fuselage.

Aspect 49. The FIS of aspect 45, wherein the rotation axis has a non-zero component along the long axis of the fuselage.

Aspect 50. The FIS of aspect 45, wherein the rotation is a rotation of 90 degrees.

Aspect 51. The FIS of aspect 45, wherein the rotation is a rotation of 180 degrees.

Aspect 52. The FIS of aspect 45, wherein the rotation is a rotation of 360 degrees.

Aspect 53. The FIS of aspect 45, wherein the rotation is a rotation of more than 5 degrees.

Aspect 54. The FIS of aspect 45, wherein the rotation is a rotation of more than 60 degrees.

Aspect 55. The FIS of aspect 45, wherein the rotation is a rotation of more than 90 degrees.

Aspect 56. The FIS of aspect 45, wherein the rotation is a rotation of more than 120 degrees.

Aspect 57. The FIS of aspect 1, wherein the mechanical coupling comprises a drive shaft configured to deliver power to or from the propulsion unit.

Aspect 58. The FIS of aspect 1, wherein the propulsion unit comprises at least one intentional momentum shedding apparatus (IMSA).

Aspect 59. The FIS of aspect 58, wherein the IMSA comprises a propeller with propeller blades mechanically coupled to a drive shaft via a rotor hub.

Aspect 60. The FIS of aspect 59, wherein the mechanical coupling of the propeller blades comprises a rotable coupling with an axis of rotation, wherein the axis of rotation has a non-zero radial component, or a component along the length of the propeller blades, such that the pitch angle of the propeller blades relative to the rotor hub can be modified.

Aspect 61. The FIS of aspect 58, wherein the IMSA comprises a rotor disc with rotor blades mechanically coupled to a drive shaft via a rotor hub.

Aspect 62. The FIS of aspect 61, wherein the mechanical coupling of the rotor blades comprises a rotable coupling with an axis of rotation, wherein the axis of rotation has a non-zero radial component, or a component along the length of the rotor blades, such that the pitch angle of the rotor blades relative to the rotor hub can be modified.

Aspect 63. The FIS of aspect 58, wherein the IMSA comprises a stator disc with stator blades mechanically coupled to the propulsion unit via a stator hub.

Aspect 64. The FIS of aspect 63, wherein the mechanical coupling of the stator blades comprises a rotable coupling with an axis of rotation, wherein the axis of rotation has a non-zero radial component, or a component along the length of the stator blades, such that the pitch angle of the stator blades relative to the stator hub.

Aspect 65. The FIS of aspect 58, wherein a propulsion unit comprises a duct or shroud which encloses the IMSA.

Aspect 66. The FIS of aspect 58, wherein the duct encloses a rotor disc, or propeller actuator disc.

Aspect 67. The FIS of aspect 1, wherein a propulsion unit comprises first drive shaft configured to deliver mechanical power to a first rotor, a first compressor, or a first propeller.

Aspect 68. The FIS of aspect 67, wherein the first drive shaft is also configured to deliver mechanical power to a second rotor, a second turbine, or a second propeller.

Aspect 69. The FIS of aspect 67, wherein the propulsion unit also comprises a second drive shaft configured to deliver power to first drive shaft, where second drive shaft can be configured to deliver power to the propulsion unit from the fuselage.

Aspect 70. The FIS of aspect 1, wherein the propulsion unit comprises a transmission, mechanical or electrical clutch, a gearbox, or an electric motor.

Aspect 80. The FIS of aspect 1, wherein at least one propulsion unit can be stored inside the fuselage during at least one mode of operation.

Aspect 81. The FIS of aspect 80, wherein the mode of operation comprises cruising flight.

Aspect 82. The FIS of aspect 80, wherein the mode of operation comprises climbing flight or descent.

Aspect 83. The FIS of aspect 80, wherein the mode of operation comprises storage or transport.

Aspect 84. The FIS of aspect 80, wherein the propulsion unit is stored at the front of the fuselage inside a fairing.

Aspect 85. The FIS of aspect 80, wherein the propulsion unit is stored at the rear of the fuselage inside a fairing.

Aspect 86. The FIS of aspect 80, wherein the storage comprises a rotation about an axis of rotation.

Aspect 87. The FIS of aspect 86, wherein the axis of rotation has a non-zero component along the long axis of the fuselage.

Aspect 88. The FIS of aspect 86, wherein the axis of rotation has a non-zero component along a short axis of the fuselage.

Aspect 89. The FIS of aspect 88, wherein the short axis is the pitch axis of the fuselage.

Aspect 90. The FIS of aspect 88, wherein the short axis is the yaw axis of the fuselage.

Aspect 91. The FIS of aspect 1, wherein a propulsion unit comprises a rocket engine.

Aspect 92. The FIS of aspect 1, wherein a propulsion unit comprises a ramjet engine.

Aspect 93. The FIS of aspect 1, wherein a propulsion unit comprises a turbojet engine.

Aspect 94. The FIS of aspect 1, wherein a propulsion unit comprises a turbofan engine.

Aspect 95. The FIS of aspect 1, wherein a propulsion unit comprises a turboprop engine.

Aspect 96. The FIS of aspect 1, wherein a propulsion unit comprises a piston engine or a reciprocating engine, or an electric motor.

Aspect 97. The FIS of aspect 1, wherein a propulsion unit comprises an apparatus with microscopic features configured to interact with air, or the quantum vacuum.

Aspect 98. The FIS of aspect 1, wherein a propulsion unit comprises a body force generating apparatus.

Aspect 99. The FIS of aspect 1, wherein energy is delivered to the bulk flow of a fluid in the process of generating thrust on the propulsion unit.

Aspect 100. The FIS of aspect 99, wherein the energy is provided by an electrical battery.

Aspect 101. The FIS of aspect 99, wherein the energy is provided by a chemical fuel, such as kerosene.

Aspect 102. The FIS of aspect 99, wherein the energy is provided by the thermal energy in the air or the atmosphere.

Aspect 103. The FIS of aspect 99, wherein the energy is provided by the zero point energy or the thermal energy in the quantum vacuum.

Aspect 104. The FIS of aspect 99, wherein the energy is provided by a separate engine located outside of the propulsion unit.

Aspect 105. The FIS of aspect 104, wherein the separate engine comprises a rocket engine.

Aspect 106. The FIS of aspect 104, wherein the separate engine comprises a ramjet engine.

Aspect 107. The FIS of aspect 104, wherein the separate engine comprises a turbojet engine.

Aspect 108. The FIS of aspect 104, wherein the separate engine comprises a turbofan engine.

Aspect 109. The FIS of aspect 104, wherein the separate engine comprises a turboshaft engine.

Aspect 110. The FIS of aspect 104, wherein the separate engine comprises an electric motor.

Aspect 111. The FIS of aspect 104, wherein the separate engine comprises an apparatus with microscopic features configured to interact with air, or the quantum vacuum.

Aspect 112. The FIS of aspect 104, wherein the separate engine comprises a body force generating apparatus.

Aspect 113. The FIS of aspect 104, wherein energy is delivered to the propulsion unit via a drive shaft.

Aspect 114. The FIS of aspect 113, wherein the separate engine is mechanically coupled to the drive shaft in a parallel hybrid configuration, and wherein an electrical motor and generator is mechanically coupled to the drive shaft.

Aspect 115. The FIS of aspect 104, wherein energy is delivered to the propulsion unit via an electrical wire.

Aspect 116. The FIS of aspect 115, wherein the separate engine is electrically coupled to the electrical wire via an electrical generator in a series hybrid configuration, and wherein a battery and a power control unit is also electrically coupled to the electrical wire.

Aspect 117. The FIS of aspect 104, wherein energy is delivered to the propulsion unit via a fuel line, or a fuel pipe, or a fuel duct.

Aspect 118. The FIS of aspect 104, wherein energy is delivered to the propulsion unit via a hydraulic pipe.

Aspect 119. The FIS of aspect 1, wherein the FIS comprises at least one wing.

Aspect 120. The FIS of aspect 119, wherein the wing can be located on the left or right side of the fuselage in a view direction parallel to the long axis and directed from the rear to the front of the fuselage.

Aspect 121. The FIS of aspect 119, wherein a wing can be configured to be folded or wherein the wing can be configured to be morphed.

Aspect 122. The FIS of aspect 121, wherein the wing comprises a root segment and a first segment coupled to the root segment via a first mechanical coupling.

Aspect 123. The FIS of aspect 122, wherein the wing comprises a second segment coupled to the first segment via a second mechanical coupling.

Aspect 124. The FIS of aspect 123, wherein the wing comprises a third segment coupled to the second segment via a third mechanical coupling.

Aspect 125. The FIS of aspect 122, wherein the first mechanical coupling comprises a rotation of positive or negative 90 degrees.

Aspect 126. The FIS of aspect 123, wherein the second mechanical coupling comprises a rotation of positive or negative 90 degrees.

Aspect 127. The FIS of aspect 123, wherein the second mechanical coupling comprises a rotation of positive or negative 180 degrees.

Aspect 128. The FIS of aspect 124, wherein the third mechanical coupling comprises a rotation of positive or negative 90 degrees.

Aspect 129. The FIS of aspect 124, wherein the third mechanical coupling comprises a rotation of positive or negative 180 degrees.

Aspect 130. The FIS of aspect 121, wherein the wing comprises at least one mechanical coupling between a first wing segment and a second wing segment, where the coupling is configured to allow relative motion between the first and second wing segment.

Aspect 131. The FIS of aspect 130, wherein the relative motion comprises a rotation about a rotation axis.

Aspect 132. The FIS of aspect 131, wherein the rotation axis has a non-zero component along a short axis of the fuselage.

Aspect 133. The FIS of aspect 132, wherein the short axis is the pitch axis of the fuselage.

Aspect 134. The FIS of aspect 132, wherein the short axis is the yaw axis of the fuselage.

Aspect 135. The FIS of aspect 131, wherein the rotation axis has a non-zero component along the long axis of the fuselage.

Aspect 136. The FIS of aspect 131, wherein the rotation is a rotation of 90 degrees.

Aspect 137. The FIS of aspect 131, wherein the rotation is a rotation of 180 degrees.

Aspect 138. The FIS of aspect 131, wherein the rotation is a rotation of 120 degrees.

Aspect 139. The FIS of aspect 131, wherein the rotation is a rotation of more than 5 degrees.

Aspect 140. The FIS of aspect 131, wherein the rotation is a rotation of more than 60 degrees.

Aspect 141. The FIS of aspect 131, wherein the rotation is a rotation of more than 90 degrees.

Aspect 142. The FIS of aspect 131, wherein the rotation is a rotation of more than 120 degrees.

Aspect 143. The FIS of aspect 130, wherein the relative motion comprises a translation.

Aspect 144. The FIS of aspect 119, wherein the wing is mounted to the fuselage at or near the top of the fuselage in a view direction perpendicular to the long axis of the fuselage and in a view in which the vertical direction is perpendicular to the long axis of the fuselage.

Aspect 145. The FIS of aspect 119, wherein the wing is mounted to the fuselage at or near the bottom of the fuselage in a view direction perpendicular to the long axis of the fuselage and in a view in which the vertical direction is perpendicular to the long axis of the fuselage.

Aspect 146. The FIS of aspect 119, wherein the wing is a low wing, mounted to the fuselage at or new the center of the fuselage in a view direction perpendicular to the long axis of the fuselage and in a view in which the vertical direction is perpendicular to the long axis of the fuselage.

Aspect 147. The FIS of aspect 119, wherein the wing comprises a wing sweep.

Aspect 148. The FIS of aspect 147, wherein the wing is swept forwards.

Aspect 149. The FIS of aspect 147, wherein the wing is swept backwards.

Aspect 140. The FIS of aspect 119, wherein the wing comprises flaps at the leading edge or trailing edge.

Aspect 141. The FIS of aspect 119, wherein the wing comprises slats or slots.

Aspect 142. The FIS of aspect 119, wherein the wing comprises a supercritical airfoil.

Aspect 143. The FIS of aspect 119, wherein the wing comprises a laminar airfoil.

Aspect 144. The FIS of aspect 119, wherein the wing comprises dihedral or anhedral.

Aspect 145. The FIS of aspect 119, wherein the wing comprises ailerons, elevons, or flaperons.

Aspect 146. The FIS of aspect 119, wherein the wing comprises batteries, fuel, or payload.

Aspect 147. The FIS of aspect 119, wherein the wing comprises

Aspect 148. The FIS of aspect 1, wherein the FIS comprises at least one vertical stabilizer or rudder.

Aspect 149. The FIS of aspect 1, wherein the FIS comprises at least one horizontal stabilizer or elevator.

Aspect 150. The FIS of aspect 1, wherein the horizontal stabilizer or elevator comprises a canard wing.

Aspect 151. The FIS of aspect 1, wherein the fuselage comprises a nose at the front end, wherein the tip of the nose forms a point, which is located on the long axis.

Aspect 152. The FIS of aspect 1, wherein the fuselage comprises a nose at the front end, wherein the tip of the nose forms an edge, wherein one point on the edge is located on the long axis.

Aspect 153. The FIS of aspect 152, wherein the edge of the nose is perpendicular to the long axis.

Aspect 154. The FIS of aspect 153, wherein the edge of the nose is parallel to the vertical direction in a case in which the vertical direction is perpendicular to the long axis.

Aspect 155. The FIS of aspect 153, wherein the edge of the nose is perpendicular to the vertical direction in a case in which the vertical direction is perpendicular to the long axis.

Aspect 156. The FIS of aspect 1, wherein the fuselage comprises a trailing point at the rear end, wherein the trailing point is located on the long axis.

Aspect 157. The FIS of aspect 1, wherein the fuselage comprises a trailing edge at the rear end, wherein one point on the edge is located on the long axis.

Aspect 158. The FIS of aspect 152, wherein the trailing edge is perpendicular to the long axis.

Aspect 159. The FIS of aspect 153, wherein the trailing edge is parallel to the vertical direction in a case in which the vertical direction is perpendicular to the long axis.

Aspect 160. The FIS of aspect 153, wherein the trailing edge is perpendicular to the vertical direction in a case in which the vertical direction is perpendicular to the long axis.

Aspect 156. The FIS of aspect 1, wherein the fuselage cross-section is in the shape of an airfoil in a viewing direction perpendicular to the long axis, such as the shape of a laminar airfoil.

Aspect 157. The FIS of aspect 1, wherein the fuselage cross-section is in the shape of a teardrop in a viewing direction perpendicular to the long axis.

Aspect 158. The FIS of aspect 1, wherein the fuselage cross-section is in the shape of a rectangle in a viewing direction perpendicular to the long axis.

Aspect 159. The FIS of aspect 1, wherein the fuselage cross-section is in the shape of a rectangle in a viewing direction perpendicular to the long axis, wherein the top and bottom sides of the rectangle are in the shape of the top surface and the bottom surface of an airfoil, respectively, wherein the top and bottom sides are located in directions perpendicular to the long axis.

Aspect 160. The FIS of aspect 1, wherein the fuselage cross-section is circular in a viewing direction parallel to the long axis.

Aspect 161. The FIS of aspect 1, wherein the fuselage cross-section is in the shape of an ellipse in a viewing direction parallel to the long axis.

Aspect 162. The FIS of aspect 1, wherein the fuselage cross-section is in the shape of a rectangle in a viewing direction parallel to the long axis.

Aspect 163. The FIS of aspect 1, wherein the fuselage cross-section is in the shape of a rectangle in a viewing direction parallel to the long axis, wherein the top and bottom sides of the rectangle are in the shape of the top surface and the bottom surface of an airfoil, respectively, wherein the top and bottom sides are located in directions perpendicular to the long axis.

Aspect 164. The FIS of aspect 1, wherein the fuselage cross-section is in the shape of a square in a viewing direction parallel to the long axis.

Aspect 165. The FIS of aspect 1, wherein the fuselage cross-section is in the shape of a rectangle with rounded corners in a viewing direction parallel to the long axis.

Aspect 166. The FIS of aspect 1, wherein the fuselage is pressurized.

Aspect 167. The FIS of aspect 1, wherein the fuselage is configured to carry passengers.

Aspect 168. The FIS of aspect 1, wherein the FIS is configured to operate as an aircraft.

Aspect 169. The FIS of aspect 1, wherein the FIS is configured to operate as a VTOL aircraft.

Aspect 170. The FIS of aspect 1, wherein the fuselage comprises landing gear, windows, doors, flight computers, seats, or an environmental control system.

Aspect 1A. The FIS of aspect 1, wherein the propulsion unit comprises: An upstream intentional momentum shedding apparatus (IMSA) configured to impart a first induced velocity to a local free stream flow during a nominal operation requirement, the upstream IMSA being associated with a streamtube; at least a downstream IMSA, at least a portion of the downstream IMSA being located in a downstream portion of the streamtube, with the downstream IMSA being configured to impart a second induced velocity to the local free stream flow within at least a portion of the streamtube, wherein the second induced velocity at the location of the downstream IMSA has a component in a direction opposite to the direction of the first induced velocity at the location of the downstream IMSA.

Aspect 2A. The FIS of aspect 1A, wherein the upstream IMSA comprises a first thrust apparatus or upstream thrust apparatus configured to generate a first thrust, and wherein the downstream IMSA comprises a second thrust apparatus or a downstream thrust apparatus configured to generate a second thrust, wherein the thrust of the downstream IMSA is calculated over at least a portion of an area of overlap between the streamtube of the upstream IMSA and a second streamtube of the downstream IMSA.

Aspect 3A. The FIS of aspect 1A, wherein the upstream IMSA is configured to generate a first thrust, and the downstream IMSA is configured to produce the second thrust with a vector component parallel to, and aligned with, the direction of an induced velocity vector of the upstream IMSA at the location of the downstream IMSA in the streamtube.

Aspect 4A. The FIS of aspect 1A, wherein the nominal operation requirement is for providing a net thrust, wherein the net thrust is equal to a first thrust vector of the upstream IMSA added to a second thrust vector of the downstream IMSA.

Aspect 5A. The FIS of aspect 1A, wherein an induced power associated with the production of the net thrust is reduced compared to a scenario in which the downstream IMSA has a negligible effect on the fluid flow, wherein the induced power can be positive or negative

Aspect 6A. The FIS of aspect 1A, wherein at least a portion of one of the upstream IMSA or downstream IMSA extracts power from a non-zero local free stream flow within the streamtube.

Aspect 7A. The FIS of aspect 1A, wherein the upstream IMSA or downstream IMSA comprise an open rotor, a ducted rotor, or a translating or rotating wing or foil.

Aspect 8A. The FIS of aspect 7A, wherein the pitch angle of the rotor blades relative to the rotor hub of the propeller can be modified.

Aspect 9A. The FIS of aspect 7A, wherein the upstream IMSA, and the downstream IMSA are encompassed by a duct.

Aspect 10A. The FIS of aspect 1A, wherein the first or second induced velocity has a non-zero component perpendicular to the local free stream flow at upstream IMSA or downstream IMSA, respectively.

Aspect 11A. The FIS of aspect 1A, wherein the first or second induced velocity has a non-zero component parallel to the local free stream flow at the upstream IMSA or downstream IMSA, respectively.

Aspect 12A. The FIS of aspect 11A, wherein the first induced velocity has a non-zero component in the direction opposite the local free stream flow direction at the upstream IMSA.

Aspect 12B. The FIS of aspect 11A, wherein the first induced velocity has a non-zero component in the same direction as the local free stream flow direction at the upstream IMSA.

Aspect 13A. The FIS of aspect 1A, wherein the power is transferred between the upstream and the downstream IMSA by a power transfer apparatus.

Aspect 14A. The FIS of aspect 13A, wherein the power is transferred mechanically.

Aspect 15A. The FIS of aspect 14A, wherein the power transfer apparatus comprises a drive shaft, gear train, and/or clutch

Aspect 16A. The FIS of aspect 13A, wherein the power is transferred electrically.

Aspect 17A. The FIS of aspect 16A, wherein the downstream IMSA drives an electric generator, the electric power of which is delivered to an electric motor coupled to the upstream IMSA, or wherein the upstream IMSA drives an electric generator, the electric power of which is delivered to an electric motor coupled to the downstream IMSA.

Aspect 18A. The FIS of aspect 13A, wherein power is delivered from the downstream IMSA to the upstream IMSA.

Aspect 19A. The FIS of aspect 1A, wherein the downstream thrust apparatus is configured to extract power from the fluid.

Aspect 20A. The FIS of aspect 19A, wherein the power extracted from the fluid by the downstream IMSA is larger in magnitude than the power delivered to the fluid by the upstream IMSA.

Aspect 21A. The FIS of aspect 19A, wherein the power extracted from the fluid by the downstream IMSA is smaller in magnitude than the power delivered to the fluid by the upstream IMSA.

Aspect 22A. The FIS of aspect 1A, wherein the upstream thrust apparatus is configured to extract power from the fluid.

Aspect 23A. The FIS of aspect 22A, wherein the power extracted from the fluid by the upstream IMSA is larger in magnitude than the power delivered to the fluid by the downstream IMSA.

Aspect 24A. The FIS of aspect 22A, wherein the power extracted from the fluid by the upstream IMSA is smaller in magnitude than the power delivered to the fluid by the downstream IMSA.

Aspect 25A. The FIS of aspect 1A, wherein the upstream thrust apparatus is configured to intentionally both extract power from the fluid and deliver power to the fluid, and the downstream thrust apparatus is configured to intentionally both extract power from the fluid and deliver power to the fluid during nominal operations.

Aspect 26A. The FIS of aspect 1A, wherein the first induced velocity is directed in a downstream direction, and the second induced velocity is directed in an upstream direction, wherein the power extracted from the fluid by the downstream IMSA is larger in magnitude than the power delivered to the fluid by the upstream IMSA.

Aspect 27A. The FIS of aspect 1A, wherein the mass flow rate of fluid in the streamtube for a given net thrust is modified compared to a scenario in which the downstream IMSA has a negligible effect on the fluid flow, wherein the modification can be an increase or a decrease in the mass flow rate.

Aspect 171. A method of interacting with a fluid, the method comprising providing any one of the fluid interaction systems of aspects 1 to 171, and aspects 1A to 27A.

Aspect 172. The method of aspect 171, the method comprising operating any one of the fluid interaction systems of aspects 1 to 171, and aspects 1A to 27A.

Aspect 173. The method of aspect 171, the method comprising operating a propulsion unit to generate a net thrust, rotating a propulsion unit with an actuator relative to the fuselage, directing the thrust of the propulsion unit in the desired direction, regulating the net thrust of the propulsion unit to match a desired thrust.

Aspect 174. A method of interacting with a fluid, the method comprising: providing a fuselage with a long axis connecting the front end of the fuselage with the rear end of the fuselage, and with a first short axis perpendicular to the long axis, and with a second short axis perpendicular to the long axis and the first short axis; providing a propulsion system, wherein the propulsion system comprises at least one propulsion unit, wherein the at least one propulsion unit can be configured to generate a net thrust, wherein the at least one propulsion unit is mechanically coupled to the fuselage via a mechanical coupling; wherein the mechanical coupling is configured to allow relative motion between the fuselage and the propulsion unit; wherein the relative motion comprises a rotation about a rotation axis, wherein the rotation axis has a non-zero component along a short axis of the fuselage; configuring the mechanical coupling and regulating the net thrust of the propulsion system to a desired magnitude and direction, wherein the desired magnitude and direction can have a non-zero component in the positive or negative direction perpendicular and parallel to the long axis of the fuselage.

Unless specified or clear from context, the term “or” is equivalent to “and/or” throughout this paper.

The embodiments and methods described in this paper are only meant to exemplify and illustrate the principles of the invention. This invention can be carried out in several different ways and is not limited to the examples, embodiments, arrangements, configurations, or methods of operation described in this paper or depicted in the drawings. This also applies to cases where just one embodiments is described or depicted. Those skilled in the art will be able to devise numerous alternative examples, embodiments, arrangements, configurations, or methods of operation, that, while not shown or described herein, embody the principles of the invention and thus are within its spirit and scope.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A fluid interaction system, or FIS, comprising:
a fuselage with a long axis connecting the front end of the fuselage with the rear end of the fuselage, and with a first short axis perpendicular to the long axis, and with a second short axis perpendicular to the long axis and the first short axis;
a propulsion system, wherein the propulsion system comprises at least one propulsion unit, wherein the at least one propulsion unit can be configured to generate a net thrust, wherein the at least one propulsion unit is mechanically coupled to the fuselage via a mechanical coupling;
wherein the mechanical coupling is configured to allow relative motion between the fuselage and the propulsion unit;
wherein the relative motion comprises a rotation about a rotation axis, wherein the rotation axis has a non-zero component along a short axis of the fuselage;
wherein the net thrust can be configured to have a non-zero component in the positive or negative direction along the long axis of the fuselage in a first configuration of the mechanical coupling; and
wherein the net thrust can be configured to have a non-zero component in the positive or negative direction perpendicular to the long axis of the fuselage in a second configuration of the mechanical coupling.

2. The FIS of claim 1, wherein the propulsion system comprises at least two propulsion units.

3. The FIS of claim 1, wherein the first short axis is the pitch axis of the fuselage and the second short axis is the yaw axis of the fuselage.

4. The FIS of claim 1, wherein the mechanical coupling comprises a support shaft or a support strut coupled to the propulsion unit via a first mechanical coupling and coupled to the fuselage via a second mechanical coupling.

5. The FIS of claim 4, wherein the second mechanical coupling is coupled to the fuselage at the rear of the fuselage.

6. The FIS of claim 5, wherein the second mechanical coupling is coupled to the fuselage at the long axis of the fuselage in a view perpendicular to the long axis of the fuselage.

7. The FIS of claim 5, wherein the second mechanical coupling is coupled to the fuselage below the long axis of the fuselage in a view perpendicular to the long axis of the fuselage and in a view in which the vertical direction is perpendicular to the long axis of the fuselage.

8. The FIS of claim 5, wherein the second mechanical coupling is coupled to the fuselage above the long axis of the fuselage in a view perpendicular to the long axis of the fuselage and in a view in which the vertical direction is perpendicular to the long axis of the fuselage.

9. The FIS of claim 4, wherein the second mechanical coupling is coupled to the fuselage at the front of the fuselage.

10. The FIS of claim 9, wherein the second mechanical coupling is coupled to the fuselage at the long axis of the fuselage in a view perpendicular to the long axis of the fuselage.

11. The FIS of claim 9, wherein the second mechanical coupling is coupled to the fuselage below the long axis of the fuselage in a view perpendicular to the long axis of the fuselage and in a view in which the vertical direction is perpendicular to the long axis of the fuselage.

12. The FIS of claim 9, wherein the second mechanical coupling is coupled to the fuselage above the long axis of the fuselage in a view perpendicular to the long axis of the fuselage and in a view in which the vertical direction is perpendicular to the long axis of the fuselage.

13. The FIS of claim 4, wherein the second mechanical coupling comprises a support strut mounting coupled to the support shaft or the support strut via a third mechanical coupling and coupled to the fuselage via a fourth mechanical coupling.

14. The FIS of claim 13, wherein the third mechanical coupling comprises a rotable coupling configured to allow rotation of the support strut about a rotation axis relative to the support strut mounting.

15. The FIS of claim 14, wherein the rotation axis has a non-zero component along a short axis of the fuselage.

16. The FIS of claim 13, wherein the fourth mechanical coupling comprises a rotable coupling configured to allow rotation of the support strut mounting about a rotation axis relative to the fuselage.

17. The FIS of claim 16, wherein the rotation axis has a non-zero component along the long axis of the fuselage.

18. The FIS of claim 1, wherein the propulsion unit comprises at least one intentional momentum shedding apparatus (IMSA).

19. The FIS of claim 18, wherein a propulsion unit comprises a duct or shroud which encloses the IMSA.

20. The FIS of claim 1, wherein a propulsion unit comprises a ramjet engine, a turbojet engine, a turbofan engine, a turboprop engine, a piston engine or a reciprocating engine, or an electric motor.

21. The FIS of claim 1, wherein energy is delivered to the bulk flow of a fluid in the process of generating thrust on the propulsion unit.

22. The FIS of claim 21, wherein the energy is provided by an electrical battery, a fuel.

23. The FIS of claim 21, wherein the energy is provided by the thermal energy in the atmosphere, or by the zero point energy, or by the thermal energy in the quantum vacuum.

24. The FIS of claim 21, wherein the energy is provided by a separate engine located outside of the propulsion unit.

25. The FIS of claim 18, wherein the IMSA comprises a rotor disc with rotor blades mechanically coupled to a drive shaft via a rotor hub.

26. The FIS of claim 25, wherein the mechanical coupling of the rotor blades comprises a rotable coupling with an axis of rotation, wherein the axis of rotation has a non-zero radial component, or a component along the length of the rotor blades, such that the pitch angle of the rotor blades relative to the rotor hub can be modified.

27. The FIS of claim 18, wherein the IMSA comprises a stator disc with stator blades mechanically coupled to the propulsion unit via a stator hub.

28. The FIS of claim 27, wherein the mechanical coupling of the stator blades comprises a rotable coupling with an axis of rotation, wherein the axis of rotation has a non-zero radial component, or a component along the length of the stator blades, such that the pitch angle of the stator blades relative to the stator hub.

29. The FIS of claim 1, wherein the propulsion unit comprises: An upstream intentional momentum shedding apparatus (IMSA) configured to impart a first induced velocity to a local free stream flow during a nominal operation requirement, the upstream IMSA being associated with a streamtube; at least a downstream IMSA, at least a portion of the downstream IMSA being located in a downstream portion of the streamtube, with the downstream IMSA being configured to impart a second induced velocity to the local free stream flow within at least a portion of the streamtube, wherein the second induced velocity at the location of the downstream IMSA has a component in a direction opposite to the direction of the first induced velocity at the location of the downstream IMSA.

30. The FIS of claim 29, wherein the upstream IMSA is configured to generate a first thrust, and the downstream IMSA is configured to produce the second thrust with a vector component parallel to, and aligned with, the direction of an induced velocity vector of the upstream IMSA at the location of the downstream IMSA in the streamtube.

31. The FIS of claim 29, wherein at least a portion of one of the upstream IMSA or downstream IMSA extracts power from a non-zero local free stream flow within the streamtube.

32. The FIS of claim 29, wherein the upstream IMSA or downstream IMSA comprise an open rotor, a ducted rotor, or a translating or rotating wing or foil.

33. The FIS of claim 32, wherein the pitch angle of the rotor blades relative to the rotor hub of the propeller can be modified.

34. The FIS of claim 29, wherein the upstream IMSA, and the downstream IMSA are encompassed by a duct.

35. The FIS of claim 29, wherein the downstream IMSA is configured to extract power from the fluid, and wherein the power extracted from the fluid by the downstream IMSA is smaller in magnitude than the power delivered to the fluid by the upstream IMSA.

36. The FIS of claim 29, wherein the downstream IMSA is configured to extract power from the fluid, and wherein the power extracted from the fluid by the downstream IMSA is larger in magnitude than the power delivered to the fluid by the upstream IMSA.

37. The FIS of claim 1, wherein the FIS comprises at least one wing.

38. The FIS of claim 37, wherein the wing comprises at least one mechanical coupling between a first wing segment and a second wing segment, where the coupling is configured to allow relative motion between the first and second wing segment.

39. The FIS of claim 38, wherein the relative motion comprises a rotation about a rotation axis.

40. The FIS of claim 39, wherein the rotation axis has a non-zero component along the long axis of the fuselage.

41. The FIS of claim 1, wherein the fuselage is configured to carry passengers.

42. The FIS of claim 1, wherein the fuselage cross-section is in the shape of an airfoil in a viewing direction perpendicular to the long axis.

43. A method of interacting with a fluid, the method comprising:
providing a fuselage with a long axis connecting the front end of the fuselage with the rear end of the fuselage, and with a first short axis perpendicular to the long axis, and with a second short axis perpendicular to the long axis and the first short axis;
providing a propulsion system, wherein the propulsion system comprises at least one propulsion unit, wherein the at least one propulsion unit can be configured to generate a net thrust, wherein the at least one propulsion unit is mechanically coupled to the fuselage via a mechanical coupling;
wherein the mechanical coupling is configured to allow relative motion between the fuselage and the propulsion unit;
wherein the relative motion comprises a rotation about a rotation axis, wherein the rotation axis has a non-zero component along a short axis of the fuselage;
configuring the mechanical coupling and regulating the net thrust of the propulsion system to a desired magnitude and direction, wherein the desired magnitude and direction can have a non-zero component in the positive or negative direction perpendicular and parallel to the long axis of the fuselage.
